(19) United States
(12) Patent Application Publication
(10) Pub. No.: US 2026/0326501 A1
(43) Pub. Date: Oct. 22, 2026

(54) SYSTEM AND METHOD FOR MONITORING AND CONTROLLING AIR QUALITY IN AN ENCLOSED SPACE

(71) Applicant: BREATHESAFE PTY LTD, Queensland (AU)

(72) Inventors: Gordon DAO, Queensland (AU); Nicholas Liam JOHNSTONE, Queensland (AU); Sebastiaan Brecht VANOEVEREN, Queensland (AU); Tommi Bell PERKINS, Queensland (AU)

(21) Appl. No.: 19/105,573

(22) PCT Filed: Aug. 22, 2023
(86) PCT No.: PCT/AU2023/050799

§ 371 Date: Feb. 21, 2025

(30) Foreign Application Priority Data
Aug. 22, 2022 (AU) 2022902399

(51) Int. Cl. B60H 1/00; B60H 3/06

(52) U.S. Cl. CPC B60H 1/00849; B60H 1/008; B60H 3/0641; B60H 2003/0691

(57) ABSTRACT

System for monitoring and controlling air quality in an enclosed space(S) comprising a controller (11), sensors (12) to monitor environmental parameters inside the enclosed space (S), airflow distribution balancer (14) to receive external airflow from outside the enclosed space and internal airflow from inside the enclosed space, an airflow generator (16) to generate the external airflow, wherein the controller (11) and sensors (12) are in operative communication. The controller (11) is configured to receive input signals from the sensors (12) and the controller (11) is configured to generate output signals, in response to the input signals, that are sent to the airflow distribution balancer (14) and/or airflow generator (16) to control the operation of the airflow distribution balancer (14) and/or airflow generator (16), respectively, by adjusting the volume of external air and/or internal air that is delivered to the enclosed space(S) to thereby control one or more environmental parameters relating to air quality inside the enclosed space(S).

Throughout this specification, unless the context requires otherwise, the word “comprise” and variations such as “comprises”, “comprising” and “comprised” are to be understood to imply the presence of a stated integer or group of integers but not the exclusion of any other integer or group of integers.

Throughout this specification, unless the context requires otherwise, the word “include” and variations such as “includes”, “including” and “included” are to be understood to imply the presence of a stated integer or group of integers but not the exclusion of any other integer or group of integers.

The headings and subheadings in this specification are provided for convenience to assist the reader, and they are not to be interpreted so as to narrow or limit the scope of the disclosure in the description, claims, abstract or drawings.

### FIELD

The present invention relates to a system and method for monitoring and controlling air quality in an enclosed space. In particular, the present invention monitors and controls one or more environmental parameters relating to air quality inside the enclosed space by controlling airflow to the enclosed space to thereby control the air quality in the enclosed space.

The enclosed space may be, for example, a cabin or cabinet. Examples of environmental parameters in the enclosed space that may be controlled include dust contaminant levels and levels of undesirable gas/es such as, for example, carbon dioxide, hydrogen sulfide and/or sulphur dioxide (CO₂, H₂S and/or SO₂).

In addition, the present invention relates to an airflow distribution balancer. The airflow distribution balancer may be used in the system of the present invention, i.e. the system for monitoring and controlling air quality in an enclosed space.

### BACKGROUND

Any discussion of background art, any reference to a document and any reference to information that is known or is well known, which is contained in this specification, is provided only for the purpose of facilitating an understanding of the background art to the present invention, and is not itself an acknowledgement or admission that any of that material forms part of the common general knowledge in Australia or any other country as at the priority date of the application in relation to which this specification has been filed.

It is a common requirement for HVAC systems to strive to control air circulation in the enclosed space for which they are intended to be used. Existing arrangements may, for example, employ various valve designs, systems configurations and control systems and consider the level of either pressure, CO₂ (carbon dioxide) or dust in the enclosed space and control the operation of components in response to such a level. However, existing systems are designed to cater to the specific application for which the particular system is intended. Such systems are not necessarily intended to be able to be integrated into an existing HVAC system, as an after-market accessory, in addition to the OEM (original equipment manufacturer) system.

### SUMMARY

In accordance with one aspect of the present invention, there is provided a system for monitoring and controlling air quality in an enclosed space.

In accordance with another aspect of the present invention, there is provided an airflow distribution balancer. This airflow distribution balancer may be a component of the system for monitoring and controlling air quality in an enclosed space.

Accordingly, and in accordance with one aspect of the present invention, there is provided a system for monitoring and controlling air quality in an enclosed space comprising
a controller
one or more sensors to monitor one or more environmental parameters inside the enclosed space,
at least one airflow distribution balancer to receive a first airflow of external air from outside the enclosed space and to receive a second airflow of internal air from inside the enclosed space,
an airflow generator to generate at least the first airflow of external air,
wherein the controller and the one or more sensors are in operative communication such that, in use, the controller is configured to receive one or more input signals from one or more sensors and the controller is configured to generate one or more output signals, in response to the one or more input signals, that are sent to at least one of the airflow distribution balancer and the airflow generator to control the operation of at least one of the airflow distribution balancer and the airflow generator, respectively, by adjusting at least one of the volume of external air and the volume of internal air that is delivered to the enclosed space to thereby control one or more environmental parameters relating to air quality inside the enclosed space.

In one or more embodiments, the airflow distribution balancer comprises at least one inlet, for air to enter the airflow distribution balancer as inlet airflow, and an outlet for air to exit the airflow distribution balancer as outlet airflow.

The airflow distribution balancer described herein comprises a chamber to receive air that enters the airflow distribution balancer via the at least one inlet.

In one or more embodiments, the airflow distribution balancer comprises at least one door movable to a selected position such that the at least one inlet is fully closed when the at least one door is at a first position, fully open when the at least one door is at a second position, and partly open and partly closed when the at least one door is at an intermediate position between the first position and the second position. In use, air is not able to flow through the at least one inlet when the at least one door is at the first position such that the at least one inlet is fully closed, and air is able to flow through the at least one inlet into the chamber and exit from the outlet when the at least one door is at the second position or at an intermediate position such that the at least one inlet is fully open or at least partly open, respectively.

In one or more embodiments, the airflow distribution balancer further comprises at least one motor, wherein the at least one door and the at least one motor are operatively connected such that the at least one motor is operatable to move the at least one door.

In one or more embodiments, the at least one motor is operable to move the at least one door in response to signals received from the controller.

In one or more embodiments, the airflow distribution balancer comprises a first inlet, a second inlet and an outlet. The first inlet and the second inlet each receive inlet airflow. The first inlet receives the first airflow of external air from outside the enclosed space and the second inlet receives the second airflow of internal air from within the enclosed space. The outlet airflow exits the airflow distribution balancer from the outlet.

In one or more embodiments, the first inlet and the second inlet are provided with a respective said door movable to a selected position as herein before described.

In one or more embodiments, the airflow distribution balancer comprises first and second motors, wherein the respective doors and the first and second motors are operatively connected such that the first and second motors are operatable to move a respective door.

In one or more embodiments, the system comprises a first airflow distribution balancer to receive the first airflow of external air and a second airflow distribution balancer to receive the second airflow of internal air.

In one or more embodiments, the system further comprises a first bypass valve to allow a portion of air, from the enclosed space, to return to the enclosed space instead of entering the second airflow.

In one or more embodiments, the system further comprises a first filter to filter the air before the portion of air is returned to the enclosed space via the first bypass valve.

In one or more embodiments, the system further comprises a second bypass valve to direct a portion of the air in the outlet airflow into the enclosed space.

In one or more embodiments, the system further comprises a second filter to filter the air before directing the portion of air into the enclosed space via the second bypass valve.

The airflow generator is located such that it is able to draw air from at least outside the enclosed space and direct the air into the enclosed space.

In one or more embodiments, the airflow generator is located outside the enclosed space. In one or more other embodiments, the airflow generator is located inside the enclosed space.

Air that passes through the airflow generator is directed into the enclosed space. The system further comprises ducts for passage of the airflows through the system.

In one or more embodiments, the airflow generator comprises an air pressuriser. In one or more other embodiments, the airflow generator comprises a blower. Depending upon the particular implementation of the system, the airflow generator may be in the form of an air pressuriser or a blower. In one or more embodiments, the blower is provided as a high capacity blower.

The one or more sensors may include one or more of the following sensors: at least one pressure sensor to sense the pressure inside and outside the enclosed space (i.e. differential pressure sensing) or inside the enclosed space; at least one dust sensor to sense the presence of dirt or dust particles in the enclosed space; at least one CO₂ sensor to sense the presence of CO₂ in the enclosed space; at least one airflow sensor to sense the flow of air; and/or at least one gas sensor.

In one or more embodiments of the system, the one or more sensors include at least one pressure sensor.

The at least one gas sensor comprises one or more gas sensors to sense the presence of gases such as, for example, hydrogen sulfide (H₂S), sulphur dioxide (SO₂) and/or refrigerant gas, e.g. R-1234YF.

The system may further comprise an air precleaner to preclean the air received from outside the enclosed space prior to the air entering the at least one inlet of the airflow distribution balancer.

In one or more embodiments, the system further comprises at least one particulates filter to filter particulate material from at least the first airflow of external air.

In one or more embodiments, the at least one particulates filter is provided as a separate filter.

In one or more embodiments, the at least one particulates filter is provided in the air pressuriser.

In one or more embodiments, the system further comprises at least one activated carbon filter to filter undesirable gases from at least the first airflow and/or the outlet airflow. In one or more embodiments, at least one particulates filter is provided upstream of the activated carbon filter.

In accordance with another aspect of the present invention, there is provided an airflow distribution balancer comprising
a casing having at least a first inlet and an outlet,
a chamber inside the casing,
at least one door movable to a selected position such that the at least one inlet is fully closed when the at least one door is at a first position, fully open when the at least one door is at a second position, and partly open and partly closed when the at least one door is at an intermediate position between the first position and the second position,
wherein, in use, air is not able to flow through the at least one inlet when the at least one door is at the first position such that the at least one inlet is fully closed, and air is able to flow through the at least one inlet into the chamber and exit from the outlet when the at least one door is at the second position or at an intermediate position such that the at least one inlet is fully open or at least partly open, respectively.

In one or more embodiments, the airflow distribution balancer further comprises at least one motor, wherein the at least one door and the at least one motor are operatively connected such that the at least one motor is operatable to move the at least one door.

In one or more embodiments, the airflow distribution balancer comprises a first inlet, a second inlet and an outlet.

In one or more embodiments, the first inlet and the second inlet are provided with a respective said door movable to a selected position as herein before described.

In one or more embodiments, the airflow distribution balancer comprises first and second motors, wherein the respective doors and the first and second motors are operatively connected such that the first and second motors are operatable to move a respective door.

In accordance with another aspect of the present invention, there is provided a method for monitoring and controlling air quality in an enclosed space comprising
monitoring one or more environmental parameters inside the enclosed space,
generating at least a first airflow of external air, from outside the enclosed space, by an airflow generator,
receiving the first airflow of external air and a second airflow of internal air, from inside the enclosed space, at at least one airflow distribution balancer,
delivering air from the at least one airflow distribution balancer in an outlet airflow to the enclosed space,
generating one or more input signals indicative of the one or more environmental parameters inside the enclosed space,
generating one or more output signals in response to the one or more input signals,
sending the one or more output signals to at least one of the airflow distribution balancer and the airflow generator to control the operation of at least one of the airflow distribution balancer and the airflow generator by adjusting at least one of the volume of external air and the volume of internal air that is delivered to the enclosed space to thereby control one or more environmental parameters relating to air quality inside the enclosed space.

In one or more embodiments of the method as herein before described, receiving the first airflow of external air and a second airflow of internal air, from inside the enclosed space, at at least one airflow distribution balancer comprises receiving the first airflow of external air and the second airflow of internal air at a single airflow distribution balancer.

In one or more embodiments of the method as herein before described, receiving the first airflow of external air and a second airflow of internal air, from inside the enclosed space, at at least one airflow distribution balancer comprises receiving the first airflow of external air at a first airflow distribution balancer and receiving the second airflow of internal air at a second airflow distribution balancer.

In one or more embodiments of the method as herein before described, the method further comprises returning a portion of air, from the enclosed space, to the enclosed space via a first bypass valve instead of allowing the portion of air to enter the second airflow.

In one or more embodiments of the method as herein before described, the method further comprises filtering the air before returning the portion of air to the enclosed space via the first bypass valve.

In one or more embodiments of the method as herein before described, the method further comprises directing a portion of the air in the outlet airflow into the enclosed space via a second bypass valve.

In one or more embodiments of the method as herein before described, the method further comprises filtering the air before directing the portion of air into the enclosed space via the second bypass valve.

The “external air” that is received from outside the enclosed space is also referred to herein as “fresh air”. The “internal air” that is received from within the enclosed space is also referred to herein as “recirculated air”. The “first airflow” of external air that is received from outside the enclosed space is also referred to herein as the “fresh airflow”. The “second airflow” of internal air that is received from inside the enclosed space is also referred to herein as the “recirculated airflow”. The inlet airflow to the airflow distribution balancer comprises the first airflow and/or the second airflow.

Dirt or dust particles are also referred to herein as particulates or particulate material. Similarly, a dust sensor/s is/are also referred to herein as a particulates sensor/s.

### BRIEF DESCRIPTION OF DRAWINGS

The present invention will now be described, by way of example only, with reference to the accompanying drawings, in which:

FIG. 1A is a schematic diagram of a first embodiment of a system for monitoring and controlling air quality in an enclosed space, installed in a vehicle, in accordance with one aspect of the present invention;

FIG. 1B is a schematic diagram showing the inclusion of additional separate filters in the system shown in FIG. 1A;

FIG. 2 is a perspective view of the interior of the cabin of the vehicle in which the system, shown in FIG. 1A, is installed;

FIG. 3A is a rear view of the cabin shown in FIG. 2;

FIG. 3B is a cross-sectional view through a portion of the shell wall of the vehicle cabin shown in FIG. 3A, showing an embodiment of a differential pressure sensor of the system shown in FIG. 1A;

FIG. 4 is a schematic diagram of a second embodiment of a system for monitoring and controlling air quality in an enclosed space, in accordance with one aspect of the present invention;

FIG. 5 is a schematic diagram of a third embodiment of a system for monitoring and controlling air quality in an enclosed space, in accordance with one aspect of the present invention;

FIG. 6 is a schematic diagram of a fourth embodiment of a system for monitoring and controlling air quality in an enclosed space, in accordance with one aspect of the present invention;

FIG. 7 is a schematic diagram of a fifth embodiment of a system for monitoring and controlling air quality in an enclosed space, in accordance with one aspect of the present invention;

FIG. 8 is a schematic diagram of a sixth embodiment of a system for monitoring and controlling air quality in an enclosed space, in accordance with one aspect of the present invention;

FIG. 9 is a schematic diagram of a seventh embodiment of a system for monitoring and controlling air quality in an enclosed space, in accordance with one aspect of the present invention;

FIG. 10 is a first cutaway view of the air return unit of the HVAC system for use with the system of the third to seventh embodiments depicted in FIGS. 5 to 9;

FIG. 11 is second cutaway view of the air return unit shown in FIG. 10;

FIG. 12 is a first perspective view of a first embodiment of an airflow distribution balancer for use in the systems shown in FIGS. 1A to 11 in accordance with another aspect of the present invention;

FIG. 13 is a second perspective view of the airflow distribution balancer shown in FIG. 12;

FIG. 14 is a first internal view of the airflow distribution balancer shown in FIG. 12, with part of the casing of the airflow distribution balancer removed;

FIG. 15 is a second internal of the airflow distribution balancer shown in FIG. 12, with part of the casing of the airflow distribution balancer removed;

FIG. 16 is a third internal of the airflow distribution balancer shown in FIG. 12, with part of the casing of the airflow distribution balancer removed;

FIG. 17 is perspective view of the lower portion of the airflow distribution balancer, shown in FIG. 12, showing the motor assembly and motor housing;

FIG. 18 is a perspective of the motor assembly and closure door of the airflow distribution balancer shown in FIG. 12;

FIG. 19 is an exploded view of the motor assembly and closure door shown in FIG. 18;

FIG. 20 is a perspective view of a second embodiment of an airflow distribution balancer for use in the embodiments of the system shown in FIGS. 1A to 11 in accordance with another aspect of the present invention;

FIG. 21 is a first perspective view of a third embodiment of an airflow distribution balancer for use in the embodiments of the system shown in FIGS. 1A to 11 in accordance with another aspect of the present invention;

FIG. 22 is a first internal view of the airflow distribution balancer shown in FIG. 21, with part of the casing of the airflow distribution balancer removed;

FIG. 23 is a second internal view of the airflow distribution balancer shown in FIG. 21, with part of the casing of the airflow distribution balancer removed;

FIG. 24 is an exploded view of the of the airflow distribution balancer shown in FIG. 22, with the motor assemblies and motor housings separated from the casing of the airflow distribution balancer;

FIGS. 25A, 25B and 25C are flow diagrams of control system operational processes, namely: “normal system operation” (FIG. 25A); “calibrate function operation” (FIG. 25B); “air quality operation check operation” (FIG. 25C); and: “scrub mode operation” (FIG. 25D);

FIG. 26 is a flow diagram of the control system operational processes for the “cost function operation”;

FIG. 27 is a schematic diagram of an eighth embodiment of a system for monitoring and controlling air quality in an enclosed space, in accordance with one aspect of the present invention;

FIG. 28 is a perspective view of the upper rear portion of the cabin of the vehicle in which the system, shown in FIGS. 27, is installed;

FIG. 29 is a first cut-away perspective view showing the interior of the cabin of the vehicle in which the system, shown in FIGS. 27, is installed;

FIG. 30 is a second cut-away perspective view showing the interior of the cabin of the vehicle in which the system, shown in FIGS. 27, is installed;

FIG. 31 is third cut-away perspective view showing the interior of the cabin of the vehicle in which the system, shown in FIGS. 27, is installed;

FIG. 32 is a perspective view of a fifth embodiment of an airflow distribution balancer for use in the embodiments of the system shown in FIGS. 27 to 31 in accordance with another aspect of the present invention;

FIG. 33 is a cut-away perspective view of an alternative embodiment of an air return unit, for the third to eighth embodiments of system, showing an alternative embodiment of the filter;

FIG. 34 is an exploded perspective view of the air return unit shown in FIG. 33;

FIG. 35 is a schematic diagram of a ninth embodiment of a system for monitoring and controlling air quality in an enclosed space, in accordance with one aspect of the present invention;

FIG. 36 is a first view showing the airflow paths through components of the system shown in FIG. 35 when the bypass valve is closed;

FIG. 37 is a second view showing the airflow paths through components of the system shown in FIG. 35 when the bypass valve is open;

FIG. 38 is a schematic diagram of a tenth embodiment of a system for monitoring and controlling air quality in an enclosed space, in accordance with one aspect of the present invention;

FIG. 39 is a first view showing the airflow paths through components of the system shown in FIG. 38 when the bypass valve is closed; and

FIG. 40 is a second view showing the airflow paths through components of the system shown in FIG. 38 when the bypass valve is open.

### DESCRIPTION OF EMBODIMENTS

The same reference numerals are used to denote the same or equivalent parts and features in the embodiments described herein. Parts and features that are described with reference to one or more embodiments are not again described with reference to the other embodiments described herein. It is to be understood that the description of such parts and features and their use and operation with reference to such one or more embodiment/s also applies to the other embodiment/s.

### System and Installation Overview

The embodiments described herein include embodiments of a system and a method for monitoring and controlling air quality in an enclosed space.

The enclosed space (in which the air quality is monitored and controlled) may be a cabin or cabinet. The cabin, for example, may be the cabin of a vehicle. One or more operators of the vehicle may occupy the cabin when the vehicle is in use and/or equipment may be located in the cabin. The cabinet, for example, may be a cabinet containing equipment (e.g. electronics equipment). However, the enclosed space may be a building (including a demountable building) or a room occupied by personnel and/or in which equipment is located.

The system may be provided to monitor and control air quality in an enclosed space as a retrofitted installation. Alternatively, the system may be provided in an enclosed space at the time of manufacture of the enclosed space or product having the enclosed space, for example, a vehicle. In a further alternative, the system may be provided in an enclosed space as an upgrade of an existing system in the enclosed space.

In the embodiments described and illustrated, the enclosed space S is the inside of the cabin C of a vehicle. The vehicle and the cabin C do not form part of the present invention. The vehicle is typically a heavy equipment vehicle as used, for example, on mining sites and construction sites. However, the system and the method for monitoring and controlling air quality in an enclosed space are not limited to use with a vehicle. The system and the method may be used in any suitable enclosed space in which it is desired to monitor and control air quality in the enclosed space in accordance with the present invention. Such suitable enclosed spaces, for example, include buildings (including demountable building), rooms and cabinets housing sensitive electrical or electronics components, e.g. servers. Furthermore, the system and the method may be used as a safeguard for the health and safety of operators in an enclosed space, and protection of equipment in an enclosed space, or both.

One or more environmental parameters that are related to the air quality in the enclosed space S are monitored. Examples of the one or more environmental parameters that are related to the air quality in the enclosed space S that may be monitored include: pressure; dust levels; CO₂ levels; levels of undesirable gases (e.g. SO₂, H₂S and/or refrigerant gas, e.g. R-1234YF); and, airflow. (Refrigerant gas may be hazardous. Consequently, if refrigerant gas is detected in the enclosed space S, this may indicate a leak in the air conditioning system of the vehicle and appropriate investigation and remedial action can be undertaken.) The pressure that is monitored is the air pressure in the enclosed space S. However, the pressure may be the air pressure inside the enclosed space and the air pressure outside the enclosed space. Measuring both the pressure inside the enclosed space S and the pressure outside the enclosed space S enables a differential pressure to be calculated. The differential pressure is the difference between the inside pressure and the outside pressure (i.e. inside pressure−outside pressure=differential pressure). It is desirable to maintain a positive differential pressure inside the enclosed space S (i.e. the inside pressure is greater than the outside pressure).

The cabin C has a shell H that encloses the enclosed space S. The shell H is typically made from metal and glass. The shell H sealingly, i.e. in a sealing manner, encloses the enclosed space S to reduce the ability of outside contaminants in the outside air to enter the enclosed space S, i.e. to isolate the enclosed space S from the external environment outside the cabin C. This includes providing seals at any openings and entry points, such as doors and windows, to thereby seal (as much as practically possible) the enclosed space S from the external environment. A seat (not shown) may be provided in the enclosed space S of the vehicle for the operator of the vehicle.

The cabin C includes operational and electrical equipment for the operation and control of the vehicle. This equipment typically includes an HVAC (heating, ventilation and air conditioning) system.

An OEM system, i.e. an OEM computer, may be included as part of this equipment. This equipment may include a VMS (vehicle monitoring system).

The HVAC system has an air outlet unit U and an air return unit N. Air is expelled from the air outlet unit U into the enclosed space S. Air from the enclosed space S enters the air return unit N to be recirculated. The air outlet unit U is provided with a suitable blower (not visible in the drawings) to expel the air into the enclosed space S. In some embodiments, the air return unit N is provided with a suitable blower B (e.g. the embodiments shown in FIGS. 10 and 11) to draw air from the enclosed space S into the air return unit N. A filter T is provided at the air return unit N. The filter T may be provided at the air intake I of the air return unit N. To provide enhanced filtering, a fine particulates filter may be used as the filter T. The filter T, for example, may comprise a HEPA filter, a ULPA filter, an EPA filter or other filter that is capable of filtering fine particulates.

The embodiments described herein of a system and a method for monitoring and controlling air quality in an enclosed space monitor and control the air quality by monitoring and controlling airflow to the enclosed space, thereby providing a system and method for monitoring and controlling airflow to an enclosed space. The airflow that is monitored and controlled is a first (or fresh) airflow and a second (or recirculated) airflow. As further described herein, embodiments of the system and method comprise a controller in operative communication or operatively connected with one or more sensors and other components of the system and method. The controller receives input signals from the one or more sensors and generates and sends output signals to other components of the system to adjust and control the operation of the other components.

### System—First Embodiment

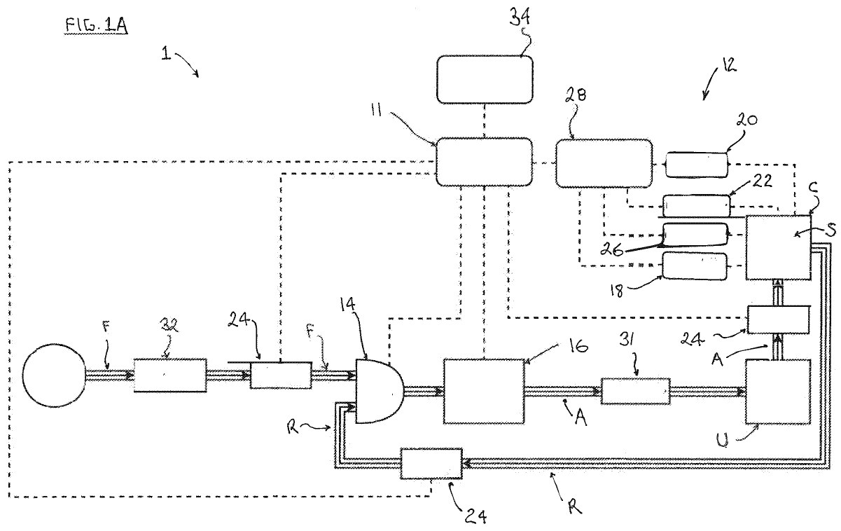

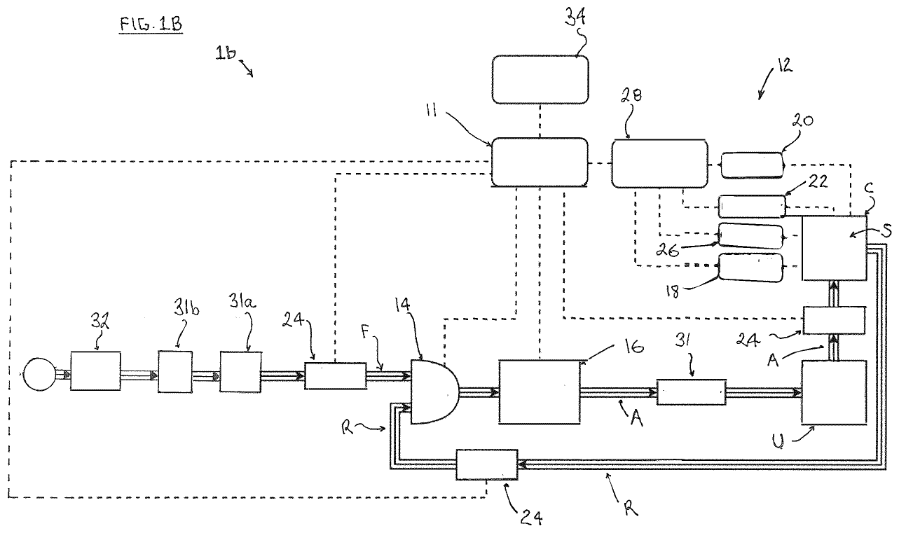

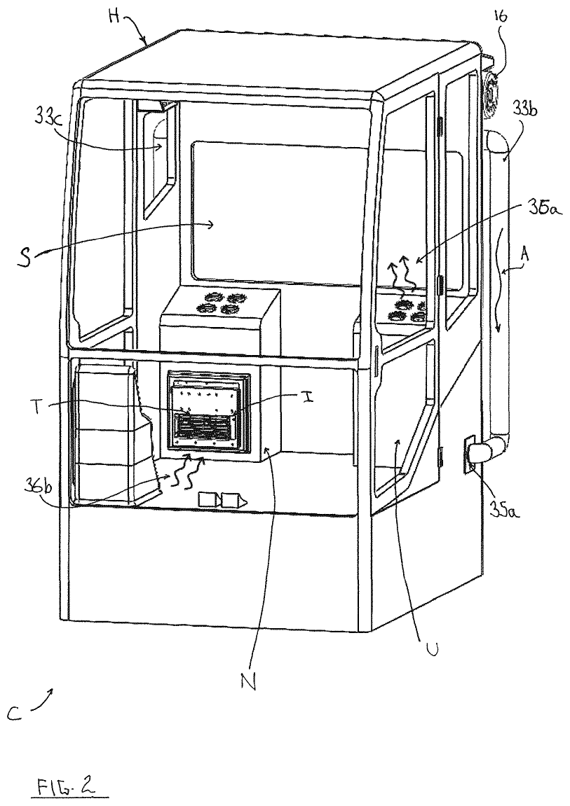

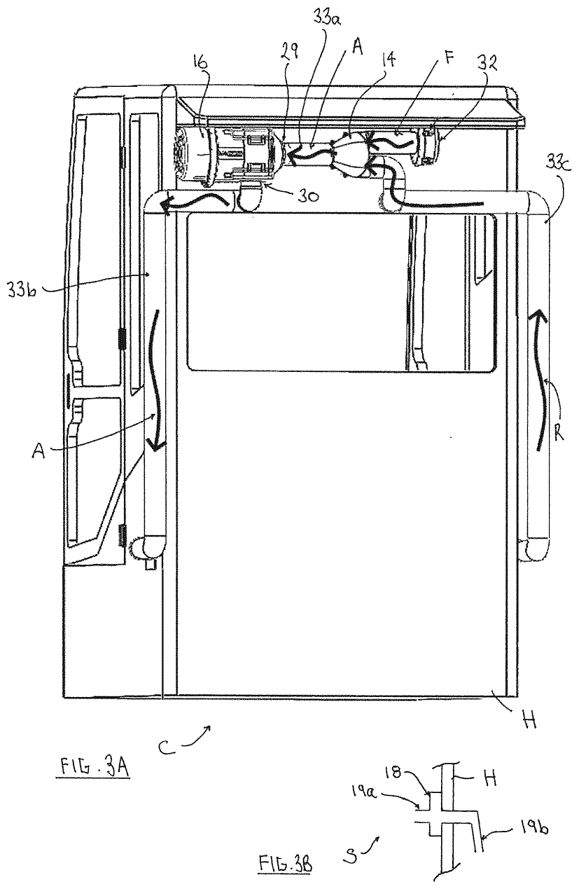

FIG. 1A is a schematic diagram showing first embodiment of a system 1 for monitoring and controlling air quality in an enclosed space S installed in a vehicle having a cabin C. The cabin C is shown in FIGS. 2 and 3. The cabin C encloses a space, which forms the enclosed space S.

The system 1 comprises a controller 11, one or more sensors 12, an airflow distribution balancer 14 and an airflow generator 16. The one or more sensors 12 are able to monitor one or more environmental parameters inside the enclosed space S. The one or more environmental parameters that are monitored are indicative of the air quality in the enclosed space S. The controller 11 and the one or more sensors 12 are in operative communication such that the controller 11 is able to receive one or more input signals from the one or more sensors 12. This is represented in FIG. 1A by the broken lines extending between the controller 11 and the sensors 12. (Broken lines extending between the controller 11 and other components also signify operative communication between the controller 11 and those other components.) In response to the one or more input signals that the controller 11 receives from the one or more sensors 12, the controller 11 is able to generate one or more output signals that are sent to the airflow distribution balancer 14 and/or the airflow generator 16 to control the operation of the airflow distribution balancer 14 and/or the airflow generator 16. This is represented in FIG. 1A by the broken lines extending between the controller 11 and the airflow distribution balancer 14 and the airflow generator 16.

The one or more sensors 12 include at least one pressure sensor 18. The pressure sensor 18 may be a pressure sensor that senses the pressure inside and outside the enclosed space S or inside the enclosed space S.

The airflow distribution balancer 14 is able to receive a first airflow. The first airflow comprises external air. The external air is air from outside the enclosed space S. Typically, the external air is ambient air outside the cabin C of the vehicle. The first airflow is a fresh airflow path and is also referred to herein as the “fresh airflow”. The external air is also referred to herein as “fresh air”. Fresh air flows in the fresh airflow to the airflow distribution balancer 14. In the drawings, the fresh airflow is indicated by arrow F.

The airflow distribution balancer 14 is able to receive a second airflow. The second airflow comprises internal air. The internal air is air from inside the enclosed space S. The second airflow is a recirculated airflow path and is also referred to herein as the “recirculated airflow”. The internal air is also referred to herein as the “recirculated air”. Recirculated air flows in the recirculated airflow to the airflow distribution balancer 14. In the drawings, the recirculated airflow is indicated by arrow R.

The airflow distribution balancer 14 is able to adjust how much fresh air and recirculated air is admitted into the airflow distribution balancer 14, as will be further herein described. In use of the system 1, fresh air and recirculated air admitted into the airflow distribution balancer 14 exit the airflow distribution balancer 14 as a single airflow (i.e. an outlet airflow). The airflow distribution balancer 14 thereby balances the volumes of fresh air and recirculated air that are admitted to the airflow distribution balancer 14 and exit the airflow distribution balancer 14 as a single airflow to be distributed, downstream of the airflow distribution balancer 14, to the enclosed space S as will be further described herein. In the drawings, the single airflow (i.e. the outlet airflow) is indicated by arrow A.

The airflow generator 16 is able to the generate the fresh airflow F. The airflow generator 16 is able to generate the recirculated airflow R. The airflow generator 16 is located downstream of the airflow distribution balancer 14.

### Controller

The controller 11 may comprise a single board computer supplemented with an add-on circuit board that interfaces with the sensors 12, the airflow distribution balancer 14, the airflow generator 16 and any other components as required.

### Sensors

The one or more sensors 12 include one or more of the following sensors: at least one pressure sensor 18 to sense the pressure inside and outside the enclosed space S or inside the enclosed space S; at least one dust sensor 20 to sense the presence of dust particles in the enclosed space S; at least one CO₂ sensor 22 to sense the presence of CO₂ in the enclosed space S; at least one airflow sensor 24 to sense the flow of air; and/or one or more gas sensors 26 to sense the presence of other gases. The dust sensor/s 20, CO₂ sensor/s 22 and gas sensor/s 26 are able to sense the presence of dust particles, CO₂ and other gases by sensing concentrations of dust particles, CO₂ and other gases, respectively, above respective minimum threshold concentrations.

The controller 11 is in operative communication with each of the pressure sensor/s 18, dust sensor/s 20, CO₂ sensor/s 22, airflow sensor/s 24 and gas sensor/s 26 such that the controller 11 is able to receive one or more input signals from the pressure sensor/s 18, dust sensor/s 20, CO₂ sensor/s 22, airflow sensor/s 24 and gas sensor/s 26.

One or more pressure sensors 18 are provided to sense the pressure inside and outside the enclosed space S or inside the enclosed space S.

Dust sensors 20 may be referred to by other terms, e.g. particulate mass sensors, PM sensors. One or more dust sensors 20 are provided to sense the concentration of dirt and dust particles in the enclosed space S. However, one or more dust sensors 20 may also be provided outside the enclosed space S, i.e. external dust sensors 20. Such external dust sensors 20 allow a protection factor to be determined by the controller 11. For example, in terms of the protection factor that is provided in relation to dust levels, the protection factor may be calculated by dividing the inside dust concentration (sensed by dust sensor/s 20 inside the enclosed space S) into the outside dust concentration (sensed by dust sensor/s 20 outside the enclosed space S). For example, if the internal dust sensor/s 20 indicate that the dust concentration in the enclosed space S is 10 parts per m³ and the external dust sensor/s 20 indicate that the dust concentration outside the enclosed space S is 10,000 parts per m³, the protection factor is calculated by dividing the inside count into the outside count, namely 10,000÷10=1,000, yielding a protection factor of 1,000.

One or more CO₂ sensors 22 are provided to sense the concentration of CO₂ in the enclosed space S.

The airflow sensors 24 sense the airflow at the respective locations at which they are provided. In the installation of the system 1 shown in FIG. 1A, airflow sensors 24 are provided at various locations. A first airflow sensor 24 is located before (i.e. upstream of) the airflow distribution balancer 14 to sense the airflow in the fresh airflow F. A second airflow sensor 24 is located before (i.e. upstream of) the airflow distribution balancer 14 and after (i.e. downstream of) the enclosed space S to sense the airflow in the recirculated airflow R. A third airflow sensor 24 is located near the air outlet unit U of the HVAC system to sense the airflow of the single airflow A into the enclosed space S.

The airflow sensors 24 may be mass airflow sensors that senses the amount of airflow.

One or more gas sensors 26 are provided to sense the concentration of gases in the enclosed space S. These are gases other than CO₂ that may be undesirable to be present in the enclosed space S. Such other gases include, for example, hydrogen sulfide (H₂S), sulphur dioxide (SO₂) and/or refrigerant gas, e.g. R-1234YF.

At least some of the sensors 12 may be mounted in one or more sensor pods 28. For example, in FIG. 1A the pressure sensor 18, dust sensor 20, CO₂ sensor 22 and gas sensor 26 are shown as mounted in the sensor pod 28.

### Airflow Distribution Balancer—First Embodiment

FIGS. 12 to 19 show a first embodiment of an airflow distribution balancer 14.

The airflow distribution balancer 14 comprises a casing 40 having a first inlet 42, a second inlet 44, at least one outlet 46 and at least one door 48.

The first and second inlets 42 and 44 are of substantially the same size.

The casing 40 has a first end 50 and a second end 51. The first and second inlets 42 and 44 are located at the first end 50 of the casing 40. The at least one outlet 46 is located at the second end 51 of the casing 40. The casing 40 encloses a chamber 52. The first and second inlets 42 and 44 are in fluid communication with the chamber 52. The door 48 is located inside the chamber 52. The door 48 is positioned adjacent to the first and second inlets 42 and 44.

The casing 40 comprises two parts 40a and 40b. In FIGS. 12 to 16, the casing part 40a is uppermost and the casing part 40b is lowermost. The two casing parts 40a and 40b may be connected together by bolts (not shown) passing through respective lugs 54a and 54b of the casing parts 40a and 40b. In FIGS. 14, 15 and 16, the airflow distribution balancer 14 is shown with the casing part 40a removed to show an internal view of the airflow distribution balancer 14.

The at least one door 48 is movable to a selected position. In a first position of the door 48, the door 48 closes the first inlet 42. In the first position of the door 48, the door 48 does not close the second inlet 44. In a second position of the door 48, the door 48 closes the second inlet 44. In the second position of the door 48, the door 48 does not close the first inlet 42.

In the first position of the door 48, the first inlet 42 is closed and the second inlet 44 is open. The door 48 is shown in the first position in FIGS. 13 and 14. FIGS. 13 and 14 show that in the first position, the door 48 completely occludes the first inlet 42 (such that the first inlet 42 is fully closed) and that the door 48 does not occlude the second inlet 44 (such that the second inlet 44 is fully open). In the second position of the door 48, the first inlet 42 is closed and the second inlet 44 is open. The door 48 is shown in the second position in FIGS. 12 and 15. FIGS. 12 and 15 show that in the second position, the door 48 completely occludes the second inlet 44 (such that the second inlet 44 is fully closed) and that the door 48 does not occlude any part of the first inlet 42 (such that the first inlet 42 is fully open).

Since the first and second inlets 42 and 44 are of substantially the same size, the cross sectional area of the first inlet 42 is the same as the cross sectional area of the second inlet 44 when it is fully open.

The door 48 is movable between the first position second position to a selected position. The selected position may be the first position, the second position or an intermediate position between the first position and second position. FIG. 16 shows the door 48 in an intermediate position between the first position and the second position. In intermediate positions of the door 48, the first inlet 42 and the second inlet 44 are partly open and partly closed. In the intermediate position of the door 48 shown in FIG. 16, the first inlet 42 and the second inlet 44 are partly open and partly closed to the same extent; that is, the size of the opening of the first inlet 42 and the size of the opening of the second inlet 44 are equal. Similarly, in the intermediate position of the door 48 shown in FIG. 16, the size of the closures of the first and second inlets 42 and 44 are equal.

In other intermediate positions of the door 48 (i.e. intermediate positions other than the intermediate position shown in FIG. 16), one of the first inlet 42 and the second inlet 44 is open to a greater extent, whilst the other is closed to a greater extent. The extent of opening or closure of the first and second inlets 42 and 44 is determined by the relative position of the door 48. The closer the door 48 is to the first position, the greater will be the extent of opening of the second inlet 44; in addition, the greater will be the extent of closure of the first inlet 42. Conversely, the closer the door 48 is to the second position, the greater will be the extent of opening of the first inlet 42; in addition, the greater will be the extent of closure of the second inlet 44. Thus, moving the door 48 to increase the opening of the first inlet 42 will proportionally further close the opening at the second inlet 44; moving the door 48 to decrease the opening the opening at the first inlet 42 (i.e. to further close the opening at the first inlet 42) will proportionally increase the opening at the second inlet 44.

The door 48 comprises a plate 56. The plate 56 has a first face 58 and a second face. The second face is opposed to the first face 58. Consequently, the second face is not visible in the drawings. The first face 58 faces the first and second inlets 42 and 44. The second face of the plate 56 faces the chamber 52 inside the casing 40. The door 48 further comprises a first end plate 60 and a second end plate 62. The first and second end plates 60 and 62 are provided at respective ends of the first plate 56. The first and second end plates 60 and 62 extend from the respective ends of the first plate 56 into the chamber 52.

The plate 56 is contoured to match the contour of the inside surface of the casing 40 surrounding the first and second inlets 42 and 44 at the first end 50 of the casing 40. This contour matching minimises the gap between the plate 56 and the inside surface of the casing 40 as the cases moves between its first and second positions.

The first and second end plates 60 and 62 are contoured to match the inside surface of the respective sides of the casing 40 adjacent to the first and second inlets 42 and 44. These contour matchings minimise the gaps between the first and second end plates 60 and 62 and the inside surface of the casing 40 when the door 48 is at its first and second positions, respectively.

One or more arms 66 extend from the door 48. The one or more arms 66 extend from the plate 56 of the door 48. The one or more arms 66 extend to a rod 68. The one or more arms 66 connect the door 48 with the rod 68. A portion of the rod 68 is received in a sleeve 69. The sleeve 69 is provided with a bore 69a. The bore 69a extends axially through the sleeve 69. A portion of the rod 68 is received in the bore 69a. The portion of the rod 68 is received in the bore 69a via a first end of the bore 69a. The rod 68 is fastened to the sleeve 69; for example, the rod 68 may be fastened to the sleeve 69 by a screw passing through an aperture in the sleeve 69 and tightly abutting against the rod 68. The rod 68 and sleeve 69 are fastened such that they are not movable relative to one another.

The airflow distribution balancer 14 further comprises a motor 70. The door 48 and the motor 70 are operatively connected such that the motor 70 is operable to move the door 48. The motor 70 is operable to move the door 48 to a selected position. The selected position may be the first position, the second position and any intermediate position between the first position and the second position.

The motor 70 is located in a housing 72. The motor 70 is best seen in FIGS. 18 and 19. The housing 72 is best seen in FIG. 17. The housing 72 is attached to the casing 40. The housing 72 is attached to the casing part 40b. The housing 72 is exterior of the chamber 52. The motor 70 has a rotatable shaft 74. Operation of the motor 7 causes the shaft 74 to rotate. A portion of the shaft 74 is received in the bore 69a in the sleeve 69. The portion of the shaft 74 is received in the bore 69a via a second end of the bore 69a. The shaft 74 is fastened to the sleeve 69; for example, the shaft 74 may be fastened to the sleeve 69 by a screw passing through an aperture in the sleeve 69 and tightly abutting against the shaft 74. The shaft 74 and sleeve 69 are fastened such that they are not movable relative to one another. Thus, both the rod 68 and the shaft 74 are fastened to the sleeve 69. The sleeve 69 is able to move in a rotational manner with the shaft 74. The rod 68 is able to move in a rotational manner with the shaft 74. The motor 70 is operable to rotate the shaft 74 such that the door 48 may be moved between the first and second positions whereby it may be positioned at a selected position from the first position to the second position and any intermediate position therebetween. In particular, the shaft 74 is rotatable in an oscillating manner. The oscillating rotation of the shaft 74 is a to and from rotation, i.e. rotation in a first direction and then then rotation in the opposite direction, through a limited angle of arc. The limited angle of arc corresponds to the first and second positions of the door 48. Thus, the shaft 74 does not rotate through 360°.

The casing 40 is provided with first and second tubular portions 76 at the first end 50 of the casing 40. The first and second tubular portions 76 form the first and second inlets 42 and 44. The tubular portions 76 are of substantially the same size. Since the first and second tubular portions 76 are of substantially the same size, the tubular portions 76 have substantially the same cross sectional area.

In the first position of the door 48, the door 48 completely occludes the first inlet 42 since the plate 56 completely occludes the first inlet 42. In the second position of the door 48, the door 48 completely occludes the second inlet 44 since the plate 56 completely occludes the second inlet 44. When the door 48 is in an intermediate position (i.e. at a position in between, but not at, the first and second positions of the door 48), each of the first and second inlets 42 and 44 is partly open and partly closed. In such intermediate positions of the door 48, the plate 56 partly occludes each of the first and second inlets 42 and 44. The extent to which the plate 56 occludes the first and second inlets 42 and 44 is determined by the relative position of the door 48 as herein before described with reference to the extent of opening or closure of the first and second inlets 42 and 44.

The airflow distribution balancer 14 may be used in the system 1 shown in FIG. 1A.

The fresh airflow F may be received at the first inlet 42 of the airflow distribution balancer 14; the recirculated airflow R may be received at the second inlet 44 of the air flow distribution balancer 14. However, the first and second inlets 42 and 44 may receive either of the two airflows F and R. Thus, the roles of the first and second inlets 42 and 44 may be reversed such that recirculated airflow R is received at the first inlet 42 and the fresh airflow F is received at the second inlet 44.

The door 48 may be used to adjust the amount, or volume, of fresh air and recirculated air admitted into the airflow distribution balancer 14. In that regard, the position of the door 48 affects the amount, or volume, of fresh air and recirculated air admitted into the airflow distribution balancer 14. Moving the door 48 in the direction away from the first position to an intermediate position closer to the second position increases the size of the opening at the first inlet 42 and reduces the size of the opening at the second inlet 44. Assuming that there is no change in the speed of the fresh airflow F or the recirculated airflow R, this will result in a greater volume of fresh air and a reduced volume of recirculated air being able to enter the airflow distribution balancer 14 into the chamber 52. Conversely, moving the door 48 in the direction away from the second position to an intermediate position closer to the first position increases the size of the opening at the second inlet 44 and reduces the size of the opening at the first inlet 42. Assuming that there is no change in the speed of the fresh airflow F and the recirculated airflow R, this will result in a greater volume of recirculated air and a reduced volume of fresh air being able to enter the airflow distribution balancer 14 into the chamber 52.

When the door 48 is in the first position, the first inlet 42 (for the fresh airflow F) is fully closed and the second inlet 44 (for the recirculated airflow R) is fully open. When the door 48 is in the first position, only recirculated air is able to enter the airflow distribution balancer 14 into the chamber 52 (through the fully open second inlet 44) and exit from the outlet 46.

When the door 48 is in the second position, the first inlet 42 (for the fresh airflow F) is fully open and the second inlet 44 (for the recirculated airflow R) is fully closed. When the door 48 is in the second position, only fresh air is able to enter the airflow distribution balancer 14 into the chamber 52 (through the fully open first inlet 42) and exit from the outlet 46.

When the door 48 is at an intermediate position (i.e. between the first position and the second position), both the first inlet 42 (for the fresh airflow F) and the second inlet 44 (for the recirculated airflow R) are partly open (and partly closed). When the door 48 is at an intermediate position, both fresh air and recirculated air are able to enter the airflow distribution balancer 14 into chamber 52 (through the partly open first and second inlets 42 and 44).

The fresh air and recirculated air mix in the chamber 52 and exit from the outlet 46 as the single airflow A (i.e. the outlet airflow). Thus, the single airflow A is a combined airflow comprised of the air in the fresh airflow F and the air in the recirculated airflow R that enter the airflow distribution balancer 14. The relative sizes of the part openings of the first and second inlets 42 and 44 affect the volumes of the fresh air and recirculated air that are able to enter the airflow distribution balancer 14 into the chamber 52, as herein before described.

Thus, the door 48 can be moved to a selected position to adjust the airflow ratio of the fresh airflow F and recirculated airflow R.

### Airflow Distribution Balancer—Second Embodiment

FIG. 20 shows a second embodiment of an airflow distribution balancer 14a. The airflow distribution balancer 14a of the second embodiment is similar to the airflow distribution balancer 14 of the first embodiment, except that the first and second inlets 42a and 44a of the airflow distribution balancer 14a are of different sizes. Thus, the respective cross sectional areas of the first and second inlets 42a and 44a are different.

In particular, in the embodiment shown in FIG. 20, the second inlet 44a is larger than the first inlet 42a, i.e. the first inlet 42a is smaller than the second inlet 44a. Since the second inlet 44a is larger than the first inlet 42a, the cross sectional area of the second inlet 44a is the larger cross sectional area of the first inlet 42a. The tubular portion 76aa at the second inlet 44a is larger than the tubular portion 76a at the first inlet 42a. Thus, the cross sectional area of the tubular portion 76aa is the larger cross sectional area of the tubular portion 76a.

Consequently, a larger volume of air may be admitted into the chamber 52 via the second inlet 44a and tubular portion 76aa than via the first inlet 42a and the tubular portion 76a.

The airflow distribution balancer 14a may be used in the system 1 shown in FIG. 1A.

If the fresh airflow F is received at the first inlet 42a and the recirculated airflow R is received at the second inlet 44a, since the second inlet 44a is larger than the first inlet 42a, the airflow of the recirculated airflow R into the airflow distribution balancer 14a is increased relative to the airflow of the fresh airflow F. This allows for increased flow of recirculated air into the airflow distribution balancer 14a whilst maintaining a desired level of flow of fresh air into the airflow distribution balancer 14a. Consequently, in contrast to the airflow distribution balancer 14 of the first embodiment, movement of the door 48 disproportionately varies the amount, or volume, of fresh air and recirculated air that enter the airflow distribution balancer 14a into the chamber 52.

In FIG. 20, the second inlet 44a is shown as being larger than the first inlet 42a. However, as an alternative, the first inlet 42a may be larger than the second inlet 44a. The relative sizes of the first and second inlets 42a and 44a may be proportionally related. For example, the second inlet 44a may have a cross sectional area twice as large as the cross sectional area of the first inlet 42a. In such an arrangement, the amount or volume of recirculated air that would be able to flow into the airflow distribution balancer 14 would be double the amount or volume of fresh air that would be able to flow into the airflow distribution balancer 14. Other ratios could be achieved by suitably adjusting the relative cross sectional sizes of the first and second inlets 42a and 44a.

In addition, as in the airflow distribution balancer 14 of the first embodiment, either of the first and second inlets 42a and 44a of the airflow distribution balancer 14a may receive either of the two airflows F and R. Thus, if it was desired to increase the airflow of the fresh airflow F into the airflow distribution balancer 14a relative to the airflow of the recirculated airflow R, the fresh airflow stream F would be directed to whichever of the first and second inlets 42a and 44a is larger and the recirculated airflow R is directed to the other inlet.

In other respects, the airflow distribution balancer 14a of the second embodiment, and its use in the system 1 shown in FIG. 1A, is similar to the airflow distribution balancer 14 of the first embodiment.

### Airflow Distribution Balancer—Third Embodiment

FIGS. 21 to 24 show a third embodiment of an airflow distribution balancer 14b.

The airflow distribution balancer 14b of the third embodiment is similar to the airflow distribution balancer 14 of the first embodiment, except that the airflow distribution balancer 14b is provided with two doors 48b and two motors 70. Each door 48b is associated with a respective inlet 42. Each motor 70 is located in a respective housing 72b. The doors 48b of the airflow distribution balancer 14b of the third embodiment are different from the door 48 of the airflow distribution balancer 48 of the first embodiment.

Each door 48b is movable to a selected position. In a first position of a door 48b, the door 48b closes its respective inlet 42 or 44. In a second position of each door 48b, the door 48b closes its respective inlet 42 or 44.

A respective door 48b is provided for the first inlet 42 and the second inlet 44. In the first position of the door 48b at the first inlet 42, the door 48b closes the first inlet 42 (i.e. the first inlet 42 is closed). In the second position of the door 48b at the first inlet 42, the door 48b does not close the first inlet 42 (i.e. the first inlet 42 is open). In the first position of the door 48b at the second inlet 44, the door 48b closes the second inlet 44 (i.e. the second inlet 44 is closed). In the second position of the door 48b at the second inlet 44, the door 48b does not close the second inlet 44 (i.e. the second inlet 44 is open).

In FIG. 21, both doors 48b (at the first and second inlets 42 and 44) are shown at their respective first positions. FIG. 21 shows that in the respective first positions of the doors 48b, the doors 48b completely occlude the respective first and second inlets 42 and 44 (such that the first and second inlets 42 and 44 are fully closed). In FIG. 22, both doors 48b are shown at their respective second positions. FIG. 22 shows that in the respective second positions of the doors 48b, the doors 48b do not occlude the respective first and second inlets 42 and 44 (such that the first and second inlets 42 and 44 are fully open). In FIG. 23, the door 48b at the first inlet 42 is shown at the first position (i.e. closed) and the door 48b at the second inlet 44 is shown at the second position (i.e. open).

Each door 48b is movable between a first position and a second position to a selected position. The selected position may be the first position, the second position or an intermediate position between the first position and second position. Each door 48b is operatively connected to a respective motor 70 such that a motor 70 is operable to move a respective door 48b. A respective motor 70 is operable to move a respective door 48b to a selected position. Each door 48b is movable independently of the other door 48b by a respective motor 70.

Each door 48b is movable to an intermediate position between the first position and the second position. In intermediate positions of a door 48b, the corresponding first inlet 42 or second inlet 44 is partly open and partly closed.

In intermediate positions of a door 48b, the extent of opening or closure of the corresponding first inlet 42 or second inlet 44 is determined by the relative position of the door 48b. Thus, the closer a door 48b is to the first position, the greater will be the extent of closure of the corresponding first inlet 42 or second inlet 44. Conversely, the closer a door 48b is to the second position, the greater will be the extent of opening of the corresponding first inlet 42 or second inlet 44.

Each door 48b comprises a plate 56b. The plate 56b has a first face 58b and a second face. The second face is opposed to the first face 58b. Consequently, the second face is not visible in the drawings. When a door 48b closes the corresponding first inlet 42 or second inlet 44, the first face 58b of the plate 56b faces the corresponding first inlet 42 or second inlet 44, and the second face of the plate 56b faces the chamber 52 inside the casing 40.

Each door 48b is provided with a bore 78 therethrough. The bore 78 is located centrally in each door 48b. The bore 78 is located along a diametral line of each door 48b. The shaft 74 of a motor 70 is received in the bore 78 of a respective door 48b. The doors 48b do not rotate relative to their respective shafts 74. The doors 48b rotate with their respective shafts 74.

The motor 70 is operable to rotate the shaft 74 such that each door 48b may be moved between the first and second positions whereby it may be positioned at a selected position from the first position to the second position and any intermediate position therebetween. For example, each door 48b may be movable in an oscillating manner. Moving the doors 48b in an oscillating manner is achieved by the shaft 74 moving in an oscillating rotational manner. The oscillating rotation of the shaft 74 may be a to-and-fro rotation, i.e. rotation in a first direction and then rotation in the opposite direction, through a limited angle of arc. The limited angle of arc corresponds to the first and second positions of the doors 48b. The limited angle of arc may be 90°.

The housings 72b are attached to the casing 40. The housings 72b are attached to the casing part 40b. The housings 72b are attached to a respective tubular portion 76. The doors 48b are located in respective portions 76.

In an alternative embodiment (not shown in the drawings), the motors 70 may be provided in a single housing instead of in the two separate respective housings 72b. In such an embodiment, the single housing is attached to the casing 40. The single housing is attached to the casing part 40b. The single housing attached to the tubular portions 76.

The airflow distribution balancer 14b may be used in the system 1 shown in FIG. 1A.

The use and operation of the airflow distribution balancer 14b of the third embodiment is similar to the use and operation of the airflow distribution balancer 14 of the first embodiment, except that each door 48b is independently movable under operation of a respective motor 70.

Thus, the fresh airflow F may be received at the first inlet 42 of the airflow distribution balancer 14b; the recirculated airflow R may be received at the second inlet 44 of the air flow distribution balancer 14b. Alternatively, the recirculated airflow R is received at the first inlet 42 and the fresh airflow F is received at the second inlet 44.

The doors 48b may be used to independently adjust the amount, or volume, of fresh air and recirculated air admitted into the airflow distribution balancer 14b. In that regard, the positions of the doors 48b affect the amount, or volume, of fresh air and recirculated air admitted into the airflow distribution balancer 14b. Moving a door 48b in the direction away from the first position to an intermediate position closer to the second position increases the size of the opening at the corresponding inlet (i.e. the first inlet 42 or the second inlet 44). Assuming that there is no change in the speed of the airflow (i.e. the fresh airflow F or the recirculated airflow R) that is directed to that inlet, the increased size of the opening at the corresponding inlet will result in a greater volume of air (i.e. fresh air or recirculated air, depending upon which airflow is connected to that inlet) being able to enter the chamber 52. Conversely, moving a door 48b in the direction away from the second position to an intermediate position closer to the first position decreases the size of the opening at the corresponding inlet. Assuming that there is no change in the speed of the airflow that is directed to that inlet, the decreased size of the opening at the corresponding inlet will result in a lesser volume of air (i.e. fresh air or recirculated air, depending upon which airflow is connected to that inlet) being able to enter the chamber 52.

Assuming that the first inlet 42 receives the fresh airflow F and the second inlet 44 receives the recirculated airflow R, when the door 48b at the first inlet 42 is in the first position, the first inlet 42 is fully closed. Conversely, when the door 48b at the first inlet 42 is in the second position, the first inlet 42 is fully open; this allows the maximum flow of the fresh airflow F through the first inlet 42 into the chamber 52 in the airflow distribution balancer 14b. Similarly, when the door 48b at the second inlet 44 is in the first position, the second inlet 44 is fully closed. Conversely, when the door 48b at the second inlet 44 is in the second position, the second inlet is fully open; this allows the maximum flow of the recirculated airflow R through the second inlet 44 into the chamber 52 in the airflow distribution balancer 14b.

When the door 48b at the first inlet 42 (for the fresh airflow F) is at an intermediate position, the flow of the fresh airflow F into the chamber 52 in the airflow distribution balancer 14b (through the partly open first inlet 42) is less than the maximum flow when the door 48b is at the second position. Similarly, when the door 48b at the second inlet 44 (for the recirculated airflow R) is at an intermediate position, the flow of the recirculated airflow R into the chamber 52 in the airflow distribution balancer 14b (through the partly open second inlet 44) is less than the maximum flow when the door 48b is at the second position.

The fresh air and recirculated air mix in the chamber 52 and exit from the outlet 46 as the single air stream A. The relative sizes of the openings of the first and second inlets 42 and 44 affect the volumes of the fresh air and recirculated air that are able to enter the airflow distribution balancer 14 into the chamber 52, as herein before described.

Thus, each of the doors 48b can be moved to a selected position to adjust the flows of the fresh airflow F and recirculated airflow R through the first and second inlets 42 and 44, respectively, into the chamber 52 of the airflow distribution balancer 14b.

Since the doors 48b are movable independently of each other, greater control is provided over the amount or volume of fresh air and recirculated that is able to flow into the chamber 52 in the airflow distribution balancer 14b than is possible with the airflow distribution balancers that use only a single door 48. Thus, two separate and independently movable doors (with one for each inlet 42/44) to respectively control the fresh airflow F and the recirculated airflow R allows the fresh airflow F and the recirculated airflow R to be independently controlled.

In other respects, the airflow distribution balancer 14b of the third embodiment, and its use in the system 1 shown in FIG. 1A, is similar to the airflow distribution balancer 14 of the first embodiment.

### Airflow Distribution Balancer—Fourth Embodiment

In a fourth embodiment of the airflow distribution balancer (not shown in drawings), the airflow distribution balancer is provided with two doors 48b and two motors 70 (similar to the airflow distribution balancer 14b of the third embodiment) and has first and second inlets 42a and 44a of different sizes (similar to the airflow distribution balancer 14a of the second embodiment).

In other respects, the airflow distribution balancer of the fourth embodiment, and its use in the system 1 shown in FIG. 1A, is similar to the airflow distribution balancers 14, 14a and 14b of the first, second and third embodiments.

### Airflow Generator—First Embodiment

The airflow generator 16 in the system 1, shown in FIG. 1A, is provided in the form of an air pressuriser 16. Air pressurisers are known in the art.

The (airflow generator 16 in the form of the) air pressuriser 16 generates the fresh airflow F. The (airflow generator 16 in the form of the) air pressuriser 16 generates the recirculated airflow R.

The air pressuriser 16 comprises an inlet 29 for air to be drawn into the air pressuriser 16 and an outlet 30 for air to exit the air pressuriser 16. An airflow path from the inlet 29 to the outlet 30 is provided inside the air pressuriser 16. The air pressuriser 16 further comprises a motor and a fan or impeller (or a similar device) in the flow path inside the air pressuriser 16. The fan or impeller is driven by the motor. The motor is located inside the air pressuriser 16. The motor drives the fan or impeller which generates the fresh airflow F and the recirculated airflow R. Thereby, the fresh airflow F and the recirculated airflow R flow to and through the airflow distribution balancer 14 and the air pressuriser 16 and exit the airflow distribution balancer 14 as a single airflow A.

Some air pressurisers may further comprise a filter. In the present embodiment of the system 1, the air pressuriser 16 does not have a filter. However, air that enters the air pressuriser 16 from the fresh airflow F will typically contain dirt and dust particles that are present in the ambient environment in which the vehicle, in which the system 1 is installed, is operated. For such environments, the system 1 is further provided with one or more filters to filter the dirt and dust particles from the fresh airflow F before that air is delivered into the enclosed space S, as is further described herein. In the event that the system 1 is to be operated in an environment in which dirt and dust particles are not present, a filter may be omitted from the system 1, i.e. a pressuriser without a filter may be used and no separate filter is required. However, it would usually be expected that the system 1 is to be operated in an environment in which dirt and dust particles are present and consequently the system 1 would be provided with a filter. In any event, as a precaution, the system 1 typically would be provided with a filter regardless of the environment in which the system 1 is to be operated. As herein before described, some air pressurisers may comprise a filter. An embodiment of a system (2) which has an air pressuriser (16a) that is provided with a filter (31) to filter dirt and dust particles is described herein with reference to FIG. 2. The filter is located inside the air pressuriser 16. In that regard, air that enters the air pressuriser 16 from the fresh airflow F will likely contain dirt and dust particles due to the ambient environment in which the vehicle, in which the system 1 is installed, is operated. On the other hand, air that enters the air pressuriser 16 from the recirculated airflow R will have passed through the filter previously. Air that is drawn into the air pressuriser 16 passes through the filter in the air pressuriser 16. The filter filters dirt and dust particles. The filter may possibly also filter other contaminants (e.g. such as undesirable gases) depending upon the type and grade of the filter. Filtered air then exits from the outlet 30 of the air pressuriser 16. The filtered air is then directed to the enclosed space S.

### Other Components of the System

Other components of the system 1 are described in the following sections.

### Filters

As herein before described, the air pressuriser 16 is not provided with a filter to filter dirt and dust particles. Consequently, the system 1 may further comprise one or more filters 31. Such filters 31 are separate filters from the air pressuriser 16. The filter/s 31 is/are provided upstream of the HVAC system of the vehicle in which the system 1 is installed. The filter/s 31 is/are provided upstream of the enclosed space S. In the system 1 (shown in FIG. 1), a filter 31 is provided downstream of the outlet 30 of the air pressuriser 16. In the system 1 (shown in FIG. 1), the filter 31 is provided upstream of the enclosed space S and the HVAC system of the vehicle in which the system 1 is installed. The filter 31 shown in FIG. 1 may comprise, for example, a fine particulates filter. The fine particulates filter is provided to filter dirt and dust particles. The dirt and dust particle that the filter 31 is able to filter may be particles may include particle sizes down to fine particulate particles. The fine particulates filter of the filter 31, for example, may comprise a HEPA filter, a ULPA filter, an EPA filter, or other filter that is capable of filtering fine particulates.

However, the filter/s 31 may comprise other types of filters. For example, to also filter out undesirable gases from the air, a fine particulates filter may be provided to filter the dirt and dust particles from the air, followed by an activated carbon filter to filter out the undesirable gases. Another fine particulates filter may also be provided after the activated carbon filter as an additional safety margin. FIG. 1B shows the inclusion of additional filters 31 and is further described herein. The type/s of filter/s selected for use as the one or more filters 31 will depend upon the type of contaminants in the working environment in which the vehicle (having the enclosed space S) is operated.

Air is directed through the filter/s 31 in one direction only. Hence, the filter/s may be directional filters.

### Air Precleaner

The system 1 may further comprise an air precleaner 32. An air precleaner 32 is desirable if the ambient environment outside the enclosed space S from which the fresh air is drawn, has an undesirable concentration of large and heavy dirt and dust particles. The air precleaner 32 is provided to remove the largest and heaviest dirt and dust particles from the ambient air (outside the enclosed space) prior to the air being directed to the other components of the system 1. The air precleaner 32 is best seen in FIG. 3. The air precleaner 32 comprises an inlet and an outlet. The outlet of the air precleaner 32 is connected to the first inlet 42 of the airflow distribution balancer 14. The first inlet 42 receives the fresh airflow F. Ambient air (from outside the enclosed space S) is drawn into the air precleaner 32 through the inlet of the air precleaner 32. The largest and heaviest dirt and dust particles in the ambient air drawn into the air precleaner 32 are expelled from one or more discharge ports of the air precleaner 32. The ambient air (cleaned of the heaviest dirt and dust particles) then flows in the air precleaner 32 to the outlet of the air precleaner 32. This airflow is the fresh airflow F, as shown in FIG. 3. This fresh airflow F flows from the outlet of the air precleaner 32 through the first inlet 42 into the chamber 52 of the airflow distribution balancer 14.

The air is drawn into the air precleaner 32 under action of the fan or impeller of the air pressuriser 16. In this way, the air pressuriser 16 generates the fresh airflow F.

The air precleaner may, for example, be an air intake cleaning apparatus of the type disclosed in U.S. Pat. No. 6,361,574.

If a precleaner 32 is not required, the external air may be drawn directly into the first inlet 42 of the airflow distribution balancer 14 as the fresh airflow F.

### Ducting

The system 1 further comprises ducts for passage of the various airflows through the system 1.

In the installation shown in FIG. 1A, and as best seen in FIGS. 2 and 3, a first duct 33a extends from the outlet 46 of the airflow distribution balancer 14 to the inlet 29 of the air pressuriser 16. A second duct 33b extends from the outlet 30 of the air pressuriser 16 to the air outlet unit U of the HVAC system. An opening is formed in the shell H of the cabin C for the duct 33b, indicated generally by reference numeral 35a in FIG. 2. A third duct 33c extends from the air return unit N to the second inlet 44 of the airflow distribution balancer 14. An opening 35b is formed in the shell H of the cabin C for the duct 33c, best seen in FIGS. 10 and 11.

The single airflow A is able to flow in second duct 33a from the airflow distribution balancer 14 to the air pressuriser 16 and, after filtering in the air pressuriser 16, flows in the second duct 33b from the air pressuriser 16 to the air outlet unit U of the HVAC system. The recirculated airflow R is able to flow in the third duct 33c from the air return unit N to the airflow distribution balancer 14.

### Interface

If required, the system 1 may further comprise one or more interfaces with the controller 11. By way of example, three different types of interfaces are described herein. A first interface may comprise a user interface with the controller 11. The first interface allows a user, e.g. an operator located in the enclosed space S, to interact with the controller 11. A second interface may comprise a web interface. The system 1 may have a built-in wi-fi network and the web interface allows a user to connect with the controller 11 via the built-in wi-fi network using a suitable device, e.g. a (laptop) computer or smartphone. The system may also be provided with LTE (Long Term Evolution) compatibility. As an alternative or in addition to the system 1 having a built-in wi-fi network, the controller 11 may be connectable to external networks via wi-fi, ethernet and/or USB interfaces. For example, the system may interface with a USB LTE adaptor to connect to an external network. A third type of interface may comprise an interface between the system 1 and an OEM system. This third type of interface may be required, for example, if the enclosed space S (or another device with which the enclosed space S is associated, for example, a vehicle) has an OEM system that it is desired to interface with the system 1.

In the drawings, the first type of interface, herein before described, is shown. This user interface 34 is connected to the controller 11. The user interface 34 may be physically separated from the controller 11. The user interface 34 may comprise a circuit board. The user interface 34 may comprise a microcontroller. The user interface 34 may further comprise an enclosure for a keypad and display. The display may be a backlit display. However, as an alternative (or addition) to the keyboard and display, a touchscreen may be used. The user interface 34 may be located, for example, at any suitable location in the enclosed space S. The user interface 34 may further comprise an alert, e.g. at least one of a buzzer and a warning light, to alert an operator to a situation requiring operator attention.

### Use and Operation: System—First Embodiment

In the following description of the use and operation of the system 1, the airflow distribution balancer is identified by the reference numeral “14 #” to signify that reference to the airflow distribution balancer 14 #may be any one of the first, second, third or fourth embodiments herein before described, unless stated otherwise.

In use, the airflow distribution balancer 14 #receives the fresh airflow F from the air precleaner 32 (if provided) or directly from the ambient air outside the cabin C (if an air precleaner is not provided) and the recirculated airflow R from the third duct 33c. The fresh airflow F and the recirculated airflow R enter the chamber 52 of the airflow distribution balancer 14 #via the first and second inlets 42/42a and 44/44a, respectively. The fresh airflow F and the recirculated airflow R are generated by the air pressuriser 16, as herein before described. The fresh air and recirculated air mix in the chamber 52. The mixed fresh and recirculated air exits the casing 40 via the outlet 46 as the single airflow A. The single airflow A flows in the duct 33a to the air pressuriser 16. The single airflow A then flows from the air pressuriser 16 into the duct 33b, flowing through the filter 31 (as herein before described, such as, for example, a fine particulates filter) in the duct 33b and then to the air outlet unit U of the HVAC system. The airflow A is filtered as it flows through the filter 31. The single airflow A (of filtered air) then passes through the air outlet unit U of the HVAC system. The HVAC system may apply the selected temperature adjustment to the air if required (i.e. heating or cooling). The air is then expelled from the air outlet unit U of the HVAC system into the enclosed space S. The air outlet unit U of the HVAC system is typically provided with a suitable blower (e.g. a fan or impeller) to expel the air into the enclosed space S. The expulsion of the air from the air outlet unit U into the enclosed space S is indicated by reference numeral 36a in FIG. 2. The expelled air 36a is the air in the single airflow A. Air from the enclosed space S is drawn into the air return unit N of the HVAC system by the blower B in the air return unit N. The air enters the air return unit N via an air intake I, as indicated by reference numeral 36b in FIG. 2. After entering via the air intake I, the air flows through the filter T. The air then flows past the blower B and flows to the duct 33c. The air flowing into the duct 33c is the recirculated airflow R. The recirculated airflow R flows in the duct 33c to the airflow distribution balancer 14 #and enters the chamber 52 of the airflow distribution balancer 14 via the second inlet 44/44a.

The filters in the system 1 (i.e. the filter in the air pressuriser 16 and any filter/s 31, such as fine particulates filter) are located in the system 1 such that air in both the fresh airflow F and the recirculated airflow R flows through the filters before entering the enclosed space S. In that regard, the air in the fresh airflow F and the air in the recirculated airflow R are combined in the airflow distribution balancer 14 #and exit the airflow distribution balancer 14 #from the outlet 46 as the single airflow A. Thus, the single airflow A comprises both the air from the fresh airflow F and the air from the recirculated airflow R. The single airflow A passes through the filter in the air pressuriser 16 and any additional filter before entering the enclosed space after passing through the outlet unit U of the HVAC system. The fresh airflow F is the airflow that will contain the greater amount of contaminants, such as dirt and dust particles, since it is drawn from ambient air in a typically dusty environment outside the enclosed space S and exterior of the cabin C. However, the recirculated airstream R that leaves the enclosed space S, via the third duct 33c, may also contain dirt and dust particles from the enclosed space S, although less than typically contained in the fresh airflow F. In that regard, it is possible that dirt and dust particles enter the enclosed space S; this may occur, for example, if a door or window of the cabin C is opened, through gaps in the sealing arrangements of the cabin C or shed from clothing of personnel entering the enclosed space S. Thus, it is advantageous that air in the recirculated airflow R that flows from the enclosed space S is filtered prior to that air being returned to the enclosed space S in the single airstream A so that any dirt and dust particles from the enclosed space in the recirculated airflow R are removed by the filter/s.

As herein before described, the system 1 is provided with one or more sensors 12 of the type herein before described. The controller 11 receives input signals from each of the sensors 12 in the system 1 that sense a particular environmental parameter indicative of air quality inside the enclosed space S, e.g. differential air pressure, dust level/concentration, etc. These input signals are indicative of the respective environmental parameters that the sensors are sensing. In response to an input signal from a sensor 12, the controller 11 generates an output signal. The output signal is sent to the motor of the air pressuriser 16 and/or the motor/s 70 of the airflow distribution balancer 14 #.

The output signals that are generated by the controller 11 and sent to the motor of the air pressuriser 16 cause the motor to adjust the speed of the motor if the input signal issued by a sensor 12 and received by the controller 11 indicates that the corresponding environmental parameter is not at a desired level, i.e. at a predetermined value (which may also include being above/below a predetermined value depending upon the environmental parameter being monitored) or within a predetermined value range. The adjustment to the speed will be to either increase or decrease the speed of the motor. This, in turn, increases or decreases the speed of rotation of the fan or impeller in the air pressuriser 16. Increasing the speed of rotation of the fan or impeller in the air pressuriser 16 results in a corresponding increase in the fresh airflow F and the recirculated airflow R that are drawn into the airflow distribution balancer 14 #and a consequent increase in the single airflow A that flows from the outlet 46 of the airflow distribution balancer 14 #into the air pressuriser 16. Conversely, decreasing the speed of rotation of the fan or impeller in the air pressuriser 16 results in a corresponding decrease in the fresh airflow F and the recirculated airflow R that are drawn into the airflow distribution balancer 14 #and a consequent decrease in the single airflow A that flows from the outlet 46 of the airflow distribution balancer 14 #into the air pressuriser 16.

If the input signal issued by a sensor 12 and received by the controller 11 indicates that the corresponding environmental parameter is at a predetermined value or within a predetermined value range, the output signals sent from the controller 11 to the motor of the air pressuriser 16 do not cause any adjustment in the speed of the motor, i.e. the speed of the motor remains unchanged (i.e. unadjusted). Consequently, the speed of rotation of the fan or impeller in the air pressuriser 16 is also unchanged (i.e. unadjusted).

The output signals that are generated by the controller 11 and sent to the motor/s 70 of the airflow distribution balancer 14 #cause the motor/s 70 to move the doors 48/48b of the airflow distribution balancer 14 #if the input signal issued by a sensor 12 and received by the controller 11 indicates that an adjustment is required in the amounts or volumes of fresh air and/or recirculated air that is received in the enclosed space S, i.e. if a re-balance is required of the amounts or volumes of fresh air and recirculated air that are supplied to the enclosed space S. This occurs if the input signal issued by a sensor 12 and received by the controller 11 indicates that the corresponding environmental parameter is not at a desired level, i.e. at a predetermined value (which may also include being above/below a predetermined value depending upon the environmental parameter being monitored) or within a predetermined value range.

If the input signal issued by a sensor 12 and received by the controller 11 indicates that the corresponding environmental parameter is at a predetermined value or within a predetermined value range, the output signals sent from the controller 11 to the motor/s 70 (that move the doors 48/48b) do not cause any change to the position/s of the doors 48/48b, i.e. the position/s of the doors 48/48b remain unchanged (i.e. unadjusted).

Upon receiving an output signal from the controller 11 to adjust the speed, the motor of the air pressuriser 16 and/or the motor/s 70 (that move the doors 48/48b) of the airflow distribution balancer 14 #alters the operating set point of the motor to a higher or lower speed, in accordance with the output signal received from the controller 11. However, if the output signal received by a motor from the controller 11 indicates that no adjustment to the speed of that motor is required, then the speed of that motor remains unaltered (i.e. unadjusted) in response to that output signal.

The normal condition of the system 1 (i.e. system steady state condition) is when all sensors 12 are sensing that the environmental parameters that are being monitored are at the respective predetermined value or within a predetermined value range.

The normal condition for a particular environmental parameter (i.e. parameter steady state condition) is when all sensors 12 monitoring that parameter are sensing that the particular environmental parameter is at the respective predetermined value or within a predetermined value range.

The predetermined value or predetermined value range may be preselected to provide a suitable value for the particular environmental parameter being monitored. For example, the preselection may be based on data obtained from an occupational health and safety authority.

Accordingly, the airflow distribution balancer 14 #allows an adjustable mixture of fresh air F and recirculated air R to be continuously supplied to enclosed space S. Adjustments to one or both of the airflow distribution balancer 14 #(as herein before described) and speed of at least one of the airflow generator 16 and the blower B enable continuous selective control of air quality and pressure in the enclosed space S. The ratio (or relative amounts) of fresh air and recirculated air delivered to the enclosed space S are controlled to allow adjustments to be made in direct response to the detected levels of the environmental parameters being monitored. These adjustments can be made in a continuous manner (i.e. continuously). Adjustments to the motor speed of the airflow generator 16 are used to adjust and to control pressure in the enclosed space S. Adjustments to the positions of the doors 48/48b of the airflow distribution balancer 14 #are used to adjust (desirably to reduce) the load on the motor of the airflow generator to generate the pressure, although changes in the position of the door/s 48/48b can impact pressure in the enclosed space S. Positive pressure is maintained in the enclosed space S by delivering sufficient fresh air F to the enclose space S to maintain the differential pressure setting in the enclosed space S.

### Pressure Monitoring

By way of an example of the operation of the system 1, a detailed description is provided with particular reference to the controller 11 receiving signals from one or more pressure sensor/s 18. As with other sensors 12, the pressure sensor 18 is in operative communication with the controller 11.

### Airflow Distribution Balancer—First Embodiment (1-Motor/1-Door)

In the following description of the operation of the system 1, the system 1 includes the airflow distribution balancer 14 of the first embodiment.

In the embodiments shown in the drawings, the pressure sensor 18 may be provided as at least one differential pressure sensor that senses the air pressure both in the enclosed space S inside the cabin C and the air pressure outside the enclosed space S, i.e. outside the cabin C. The pressure sensor 18 is provided at a suitable location. For example, as shown in FIG. 3B, the pressure sensor 18 may be mounted on the wall of the shell H inside the enclosed space S. A first tube 19a extends from the pressure sensor 18 into the enclosed space S inside the cabin C such that the pressure sensor 18 is exposed to the air in the enclosed space S whereby the pressure sensor 18 is able to sense the air pressure in the enclosed space S. A second tube 19b extends from the pressure sensor 18 to outside the enclosed space S, i.e. outside the cabin C, such that the pressure sensor 18 is exposed to air outside the enclosed space S, i.e. outside the cabin C, whereby the pressure sensor 18 is able to sense the air pressure outside the cabin C, i.e. outside the enclosed space S. In an alternative (not shown), two pressure sensors may be provided. The difference in the sensed air pressure in the enclosed space S inside the cabin C and the sensed air pressure outside the enclosed space S, i.e. outside the cabin C, provides a measurement of the differential air pressure. The system 1 operates to maintain the differential air pressure within a range such that positive pressure is maintained in the enclosed space S, i.e. such that the air pressure in the enclosed space S inside the cabin C is higher than the air pressure outside the enclosed space, i.e. outside the cabin C, by a predetermined value (i.e. a predetermined pressure value) or by an amount that is within a predetermined value range (i.e. predetermined value range). The differential pressure values are also referred to herein as the predetermined differential pressure value and the predetermined differential pressure range.

By way of example, the predetermined differential pressure value and the predetermined differential pressure range may be selected from the range of 5 Pa and 300 Pa. 5 Pa is typically the minimum useful pressure differential, whilst 300 Pa is typically the maximum pressure differential that should be used in an enclosed space having a human occupant. However, the system capability for the pressure differential may be up to 1,000 Pa.

The pressure sensor 18 provides input signals to the controller 11 in relation to the differential air pressure, i.e. signals that are indicative of the sensed differential air pressure. The controller 11 is in operative communication with the motor of the air pressuriser 16. Consequently, the controller 11 can generate output signals that are sent to the motor of the air pressuriser 16 to control the speed of the motor. In addition, the controller 11 is in operative communication with the motor 70 of the airflow distribution balancer 14. Consequently, the controller 11 can generate output signals that are sent to the motor 70 of the airflow distribution balancer 14 to control the operation of the motor 70. The motor 70 is operated to move the door 48 to the required position.

If the controller 11 receives an input signal from the pressure sensor 18 that indicates that the differential air pressure has fallen below a predetermined value (i.e. a predetermined pressure value) or by an amount that is within a predetermined value range (i.e. predetermined value range), the controller 11 generates and sends an output signal: (i) to the motor of the air pressuriser 16 to increase the speed of the motor, and/or (ii) to the motor 70 of the air distribution balancer to move the door 48 to increase the amount or volume of fresh air that is able to enter the airflow distribution balancer 14. Each of these actions, i.e. (i) and (ii), will increase the volume of fresh air flowing to the enclosed space S and the pressure in the enclosed space S and thereby the differential pressure, as is further described herein.

Increasing the speed of the motor of the air pressuriser 16 increases the speed of the fan or impeller of the air pressuriser 18 which increases the volume of air that is drawn into the airflow distribution balancer 14 via the fresh airflow F and the recirculated airflow R. The air then exits the airflow distribution balancer 14 as the single airflow A which is delivered to enclosed space S. This increase in the volume of air in the fresh airflow F flowing into the enclosed space S increases the pressure in the enclosed space S. This increase in pressure in the enclosed space S increases the differential pressure.

Since the air in the fresh airflow F is air that is drawn in from outside the enclosed space S (as opposed to the recirculated airflow R, which is already circulating through the system 1 and enclosed space S), the fresh airflow F comprises newly introduced air so its effect is to increase the volume of fresh air flowing into the enclosed space S.

Moving the door 48 to increase the amount or volume of fresh air that is able to enter the airflow distribution balancer 14 results in the door 48 moving in the direction away from the first position and toward the second position. This increases the size of the opening at the first inlet 42 and reduces the size of the opening at the second inlet 44, as herein before described. This increases the volume of fresh air and reduces the volume of recirculated air that is able to enter the airflow distribution balancer 14. The air then exits the airflow distribution balancer 14 as the single airflow A which is delivered to enclosed space S. This increases the amount or volume of fresh air that is delivered to the enclosed space S relative to the amount or volume of recirculated air R. Since more air is being introduced into the system 1 (via the increased fresh airflow F) and less recirculated air is able to enter the airflow distribution balancer 14 (from the enclosed space S), the pressure in the enclosed space S increases. This increase in pressure in the enclosed space S increases the differential pressure.

The determination of which motor is operated in response to the output signal from the controller 11 (i.e. the motor of the air pressuriser 16 and/or the motor 70), is made by the logic in the controller 11. The logic of the controller 11 can be programmed and updated such that the motors operate as desired in response to an output signal from the controller 11. The logic in the controller 11 is programmed to balance competing factors in a desired manner.

By way of example, if the output signal from the controller 11 directs the motor 70 to move the door 48, but does not direct the motor of the air pressuriser to alter its speed, the door 48 is moved in the direction toward the second position. This increases the size of the opening at the first inlet 42 (i.e. the fresh air inlet), which results in an increase in the amount or volume of fresh air that is able to enter the chamber 52 in the airflow distribution balancer 14 and then flow into the enclosed space S. This increase in the fresh air flow into the enclosed space S increases the air pressure in the enclosed space S. In this way, the pressure in the enclosed space S is increased without changing the speed of the motor of the air pressuriser 16. This is desirable for maximising the efficiency and longevity of the motor of the air pressuriser 16; in addition, it is desirable for noise reduction since the motor of the air pressuriser will typically emit less noise when it is operated at a lower speed. However, moving the door 48 to increase the size of the opening at the first inlet 42 (to increase the amount or the volume of fresh air flowing into the enclosed space S) simultaneously reduces the size of the opening of the second inlet 44 (i.e. the recirculated air inlet). Reducing the size of the opening of the second inlet 44 reduces the amount or volume of recirculated air (relative to fresh air) that flows into the chamber 52 and into the enclosed space S; in addition, the amount or volume of recirculated air that is filtered by the filters in the system 1 (i.e. the filter in the air pressuriser 16 and any filter/s 31, such as a fine particulates filter) is reduced. Flow of recirculated air through the system 1 is desirable as it mitigates the build-up of dirt and dust particles that enter the enclosed space S through open doors, gaps or carried on the clothing of personnel entering the enclosed space. Such build-up of dirt and dust particles is mitigated by flow of recirculated air through the system 1 because the recirculated air is filtered when it flows through the system 1 (i.e. filtered by the filter in the air pressuriser 16 and any filter/s 31, such as a fine particulates filter). In addition, if the enclosed space S has an existing air-conditioning system (e.g. in the HVAC system), maintaining a relatively higher level of recirculated airflow, or maximising recirculated airflow, through the system may be beneficial for reducing air-conditioner load, since it reduces the proportion of potentially hot or cold fresh air that must be cooled or heated by the air-conditioner . . .

An under-pressure condition is indicated when the controller 11 determines that the pressure sensor 18 senses that the differential air pressure has fallen to, or below, the predetermined value or fallen below the predetermined value range (i.e. the steady state condition for the pressure parameter). Once the controller 11 receives a signal from the pressure sensor 18 that the differential air pressure has fallen to, or below, the predetermined value or fallen below the predetermined value range, the controller 11 sends a signal to the motor of the air pressuriser 16 and/or the motor/s 70 associated with the doors 48/48b to adjust their operation.

In an under-pressure condition, if the controller 11 sends a signal to the motor of the air pressuriser 16, the signal directs the motor to increase the speed of the motor. This increases the speed of the motor to thereby increase the speed of the fan or impeller of the air pressuriser 16. This results in an increase in the amount or volume of air flowing (i.e. rate of airflow) through the air distribution balancer 14 and the air pressuriser 16 into the enclosed space S. This results in the air pressure rising (i.e. increasing) in the enclosed space S, thereby increasing the differential air pressure.

In an under-pressure condition, if the controller 11 sends a signal to the motor/s 70 associated with the door/s 48/48b, the signal directs the motor/s 70 to increase the size of the opening at the first inlet 42 (i.e. the fresh air inlet). This results in an increase in the amount or volume of fresh air that is able to enter the chamber 52 and flow through the airflow distribution balancer 14 and air pressuriser 16 and then flow into the enclosed space S. This increase in the fresh air flow into the enclosed space S results in an increase in the air pressure in the enclosed space S, thereby increasing the differential air pressure.

Conversely, an over-pressure condition is indicated when the controller 11 determines that the pressure sensor 18 senses that the differential air pressure has risen to, or above, the predetermined value or risen above the predetermined value range (i.e. the steady state condition for the pressure parameter). When the controller 11 receives a signal from the pressure sensor 18 that indicates that the differential air pressure has risen to, or above, the predetermined value or above the predetermined value range, the controller 11 sends a signal to the motor of the air pressuriser 16 and/or the motor/s 70 associated with the door/s 48/48b to adjust their operation.

In an over-pressure condition, if the controller 11 sends a signal to the motor of the air pressuriser 16, the signal directs the motor to reduce the speed of the motor of the air pressuriser 16. This decreases the speed of the motor to thereby decrease the speed of the fan or impeller of the air pressuriser 16. This results in a decrease in the amount or volume of air flowing (i.e. rate of airflow) through the air distribution balancer 14 and air pressuriser 16 into the enclosed space S. This results in the air pressure falling (i.e. decreasing) in the enclosed space S, thereby decreasing the differential air pressure.

In an over-pressure condition, if the controller 11 sends a signal to the motor/s 70 associated with the door/s 48/48b, the signal directs the motor/s 70 to decrease the size of the opening at the first inlet 42 (i.e. the fresh air inlet). This results in a decrease in the amount or volume of fresh air that is able to enter the chamber 52 and flow through the airflow distribution balancer 14 and air pressuriser 16 and then flow into the enclosed space S. This decrease in the fresh air flow into the enclosed space S results in a decrease in the air pressure in the enclosed space S, thereby decreasing the differential air pressure.

Thus, the controller 11 issues a signal to the motor of the air pressuriser 16 and/or the motor/s 70 associated with the door/s 48/48b in response to a signal received from the pressure sensor 18, that indicates an over-pressure condition or an under-pressure condition, to adjust the speed of the motor of the air pressuriser 16 (either by increase or decrease) and/or move a door 48/48b to maintain the differential air pressure at the predetermined value or within the predetermined value range.

If the signal that the controller 11 receives from the pressure sensor 18 indicates that the differential air pressure is in accordance with the predetermined value or is within the predetermined value range, the output signal issued by the controller 11 directs the motor of the air pressuriser to maintain the current motor speed, i.e. the speed of the motor remains unchanged, and directs the motor/s 70 to maintain the doors/48/48b at their current position/s, i.e. the position/s of the doors 48/48b remain unchanged.

In an alternative embodiment (not shown), at least two pressure sensors (that are not differential pressure sensors) may be provided. In this alternative embodiment of two pressure sensors being provided, one pressure sensor senses the air pressure in the enclosed space S inside the cabin C and the second pressure sensor senses the air pressure outside the cabin C (i.e. outside the enclosed space S). Each of these pressure sensors sends signals to the controller 11 in relation to the air pressure sensed by the respective pressure sensor, i.e. signals that are indicative of the respective sensed air pressure in the enclosed space S inside the cabin C and outside the cabin C. The controller 11 receives the signals from the two pressure sensors and calculates the differential air pressure. The controller 11 then functions and the system 1 operates in the manner herein before described with reference to the embodiment in which the pressure sensor 18 is a differential pressure sensor.

In an alternative embodiment (not shown), the pressure that is monitored is the air pressure in the enclosed space S. A pressure sensor is provided to sense the air pressure inside the enclosed space S. The pressure sensor sends signals to the controller 11 in relation to the air pressure sensed by the pressure sensor, i.e. signals that are indicative of the sensed air pressure in the enclosed space S inside the cabin C. The controller 11 receives the signals from the pressure sensor. In this embodiment, the system operates to maintain the sensed air pressure inside the enclosed space S within a range such that the sensed air pressure is above a selected value to maintain positive pressure inside the enclosed space S. The selected value is a value that is selected to be greater than the anticipated air pressure outside the enclosed space S by a desired amount. The controller 11 functions and the system of this embodiment operates in a manner similar to that herein before described with reference to the embodiment in which the pressure sensor 18 is a differential pressure sensor. The difference being that in this embodiment, the controller 11 responds to signals from the pressure sensor that are indicative of the air pressure in the enclosed space (rather than signals that are indicative of the differential air pressure).

In most applications, it would be advantageous to use differential pressure as the parameter for the controller 11 to control the operation of components of the system as herein before described. Using the differential pressure allows the desired differential pressure to be set and the system will operate to maintain the differential pressure setting regardless of changes in air pressure outside, or inside, the enclosed space S.

### Airflow Distribution Balancer—Second Embodiment (Different Size Inlets)

In the following description of the operation of the system 1, the system 1 includes the airflow distribution balancer 14a of the second embodiment.

When an airflow distribution balancer 14a of the second embodiment is used in the system 1, the system 1 operates in a manner substantially similar to that herein before described with reference to the operation when an airflow distribution balancer 14 of the first embodiment is used. The difference is that, since the cross sectional areas of the first inlet 42a and the second inlet 44a are different, moving the door 48 will disproportionally alter the amount, or volume, of fresh air and recirculated air that enter the airflow distribution balancer 14a into the chamber 52 of the airflow distribution balancer 14a.

### Airflow Distribution Balancer—Third Embodiment (2-Motors/2-Doors)

In the following description of the operation of the system 1, the system 1 includes the airflow distribution balancer 14b of the third embodiment.

When an airflow distribution balancer 14b of the third embodiment is used in the system 1, the system 1 operates in a manner substantially similar to that herein before described with reference to the operation when an airflow distribution balancer 14 of the first embodiment is used. The difference is that, since the first and second inlets 42 and 44 have a respective door 48b and the two doors 48b are movable independently, each door 48b may be moved to adjust the size of the opening of its inlet 42 or 44 without altering the size of the opening of the other inlet 44 or 42. This provides greater control over the respective amounts or volumes of fresh air and recirculated air that are able to flow into the chamber 52 in the airflow distribution balancer 14b than is possible with the airflow distribution balancers that use only a single door 48. In addition, the controller 11 is in operative communication with each motor 70 of the airflow distribution balancer 14b. Consequently, the controller 11 can generate respective output signals that are sent to each motor 70 of the airflow distribution balancer 14b to control the operation of a respective motor 70. The motors 70 are operated to move a respective door 48b to the required position.

### Airflow Distribution Balancer—Fourth Embodiment (Combination of 2^{nd} & 3^{rd})

In the following description of the operation of the system 1, the system 1 includes the airflow distribution balancer of the fourth embodiment.

When an airflow distribution balancer of the fourth embodiment is used in the system 1, the system 1 operates in a manner substantially similar to that herein before described with reference to the operation when an airflow distribution balancer 14, 14a and 14b of the first, second and third embodiments. The difference in the cross sectional areas of the first and second inlets 42 and 44 results in the amount, or volume, of fresh air and recirculated air that are able to flow into chamber 52 of the airflow distribution balancer being disproportionally altered and the two independently movable doors 48b provide greater control over the amount or volume of fresh air and recirculated air that are able to flow into the chamber 52 of the airflow distribution balancer.

### CO₂ Monitoring

Regarding operation of the system 1 when the controller 11 receives signals from a CO₂ sensor 22 in the system 1, the system 1 operates in a manner similar to that herein before described with reference to the operation when the controller 11 receives signals from a pressure sensor 18 in the system 1. In that regard, increasing fresh airflow will simultaneously increase pressure and also reduce CO₂ concentrations in the enclosed space S.

Each CO₂ sensor 22 is in operative communication with the controller 11. Each CO₂ sensor 22 provides input signals to the controller 11 in relation to the CO₂ level in the enclosed space S. The system 1 operates to maintain the CO₂ level in the enclosed space S below a predetermined value (i.e. predetermined CO₂ value).

### Other Gases Monitoring

If the vehicle, in which the system 1 is installed is operating in an environment in which one or more undesirable gases (e.g. H₂S, SO₂ and/or refrigerant gas, e.g. R-1234YF) may be present, the filter/s 31 comprise an activated carbon filter, as herein before described. FIG. 1B shows a system 1b that includes an activated carbon filter as one of the filters 31. In FIG. 1B, the activated carbon filter is identified by reference numeral 31a. In FIG. 1B, the activated carbon filter 31a is shown as provided in the fresh airflow F. The activated carbon filter 31a is provided upstream of the first inlet 42 of the airflow distribution balancer 14. The activated carbon filter 31a is provided downstream of the air precleaner 32. The activated carbon filter 31a is provided upstream of an airflow sensor 24 that is provided in the fresh airflow F. A fine particulates filter (identified by reference numeral 31b in FIG. 1B) is provided upstream of the activated carbon filter 31a (i.e. the activated carbon filter 31a is provided downstream of the filter 31b). The fine particulates filter 31b is provided downstream of the air precleaner 32.

When an activated carbon filter 31a is included in an embodiment of the system described herein, at least one fine particulates filter is also included. If two (or more) such fine particulates filters are included, at least one fine particulates filter is provided upstream of the activated carbon filter and at least one fine particulates filter is provided downstream of the activated carbon filter 31a. This arrangement is exemplified in FIG. 1B. FIG. 1B shows a fine particulates filter 31b provided upstream of the activated carbon filter 31a. In FIG. 1B, the filter 31, which is located between the air pressuriser 16 and the air outlet unit U (as is also the case in FIG. 1A), is provided downstream of the activated carbon filter 31a.

Regarding operation of the system 1b, shown in FIG. 1B, when the controller 11 receives signals from a gas sensor 26 (that monitors for other undesirable gases in the enclosed space S) in the system 1, the system 1 operates in a manner similar to that herein before described with reference to the operation when the controller 11 receives signals from a pressure sensor 16 or CO₂ sensor 22 in the system 1. In that regard, increasing fresh airflow will simultaneously increase pressure and also reduce concentrations of other undesirable gases in the enclosed space S that are monitored.

In an alternative embodiment (not shown in the drawings), an activated carbon filter 31a is provided in the single airflow A, downstream of the airflow distribution balancer (instead of, or in addition to, an activated carbon filter 31a in the fresh airflow F, as shown in FIG. 1B). However, since an activated carbon filter 31a in the single airflow A filters air from both the fresh airflow F and the recirculated airflow R, there is generally no need to also have an activated carbon filter 31a in the fresh airflow F. A fine particulates filter 31 is provided upstream of the activated carbon filter 31a in the single airflow A. For example, in the implementation of the system 1b shown in FIG. 1B, this may be a fine particulates filter 31b in the fresh airflow F; however, if the fine particulates filter 31b was not present in the fresh airflow F, the fine particulates filter 31 in the single airflow A would be positioned upstream of the activated carbon filter 31a positioned in the single airflow A. Thus, the activated carbon filter 31a would be positioned in the single airflow A such that it is positioned between the fine particulates filter 31 and the enclosed space S (in particular, the air outlet unit U). As herein before described, an activated carbon filter 31a in the single airflow A filters air from both the fresh airflow F and the recirculated airflow R. Accordingly, if undesirable gas/es is present in the recirculated airflow R (which may occur, for example, if the operator opens a door of the cabin C and undesirable gas enters the enclosed space S from outside the enclosed space S), an activated carbon filter 31a in the single airflow A will filter the undesirable gas after it flows in the recirculated airflow R through the airflow distribution balancer and becomes part of the single airflow A. (On the other hand, if an activated carbon filter 31a was positioned in the fresh air flow F (as shown in FIG. 1B), undesirable gas/es in the enclosed space S could be reduced by increasing filtered fresh air flow F to simply dilute the level of the undesirable gas/es in the enclosed space S.

In a further alternative embodiment (not shown in the drawings), an activated carbon filter 31a is provided in the recirculated airflow R (in addition to, an activated carbon filter 31a in the fresh airflow F, as shown in FIG. 1B). If an activated carbon filter 31a is provided in the recirculated airflow R, increasing the recirculated airflow R would result in a reduction in the levels of undesirable gases in the enclosed space S. This is because the increase in the recirculated airflow R would cause more air to flow in the recirculated airflow R and consequently through the activated carbon filter 31a. The volume or amount of air flowing in the recirculated airflow R can be increased by moving the door 48 of the airflow distribution balancer 14 to increase the size of the opening of the second inlet 44 (for the recirculated airflow R).

If only one fine particulates filter 31 is provided in a system having an activated carbon filter 31a, it is advantageous that the fine particulates filter 31 is provided upstream of the activated carbon filter 31. This is because the fine particulates filter 31 removes particulates from the air, while the activated carbon filter 31a removes undesirable gases from the air but is ineffective at removing most particulates from the air. Consequently, positioning a fine particulates filter 31 upstream of the activated carbon filter 31a means that the air passing through the activated carbon filter 31a (after having passed through the fine particulates filter 31) is relatively free of debris which might otherwise damage or reduce the efficiency of the carbon beds in the activated carbon filter 31a. If two fine particulates filters 31 are provided in a system having an activated carbon filter 31a, positioning one of these two fine particulates filters 31 downstream of the activated carbon filter 31a would capture carbon particulates that have broken down in the activated carbon filter 31a. The fine particulates filter 31 that is downstream of the activated carbon filter 31a is under very minor loading relative to the fine particulates filter 31 that is upstream of the activated carbon filter 31a. Consequently, the fine particulates filter 31 that is downstream of the activated carbon filter 31a may be a lesser grade filter than the fine particulates filter 31 that is upstream of the activated carbon filter 31a if the upstream fine particulates filter 31 is a suitably high grade filter, e.g. a HEPA or similar grade filter.

Each gas sensor 26 is in operative communication with the controller 11. Each gas sensor 26 provides input signals to the controller 11 in relation to the level of the undesirable gases in the enclosed space S. The system 1 operates to maintain the level of such undesirable gases in the enclosed space S below a predetermined value (i.e. predetermined undesirable gas value).

### Dust Monitoring

Each dust sensor 20 is in operative communication with the controller 11. Each dust sensor 20 provides input signals to the controller 11 in relation to dust level in the enclosed space S. The system 1 may operate to maintain the dust level in the enclosed space S below a predetermined value (i.e. predetermined dust value).

If the controller 11 receives a signal from a dust sensor 20 that indicates that the dust level in the enclosed space S has risen above the predetermined value, the system 1 operates to reduce the sensed dust level to below the predetermined value. This is done by increasing the filtering of the air in the enclosed space S to increase the removal of dirt and dust from the air in the enclosed space S. The filtering of the air in the enclosed space S is increased by taking more air from the enclosed space S, via the third duct 33c, which then flows in the recirculated airflow R and flows through the airflow distribution balancer 14 and the filter in the air pressuriser 16 and any further filter 31. This is achieved by the controller 11 generating and sending an output signal to the motor 70 associated with the door 48/48b to increase the size of the opening at the second inlet 44/44a of the airflow distribution balancer. In addition, the speed of the motor of the air pressuriser 16 is increased, which increases recirculated airflow R. Since the recirculated airflow R enters the airflow distribution balancer 14 via the second inlet 44/44a, an increased amount or volume of recirculated air will flow through the airflow distribution balancer 14 and flow thorough the filter in the air pressuriser 16 and any additional filter/s 31. This results in an increased amount or volume of recirculated air (from the enclosed space S) that is filtered. That is to say, the rate of filtration of the air (from the enclosed space S) by the filters in the system 1 is increased. Increasing the rate of filtration removes more dirt and dust particles from the air in the enclosed space S.

Once the controller 11 receives a signal from the dust sensor 20 that the dust level has fallen below the predetermined value (i.e. the steady state condition for the dust parameter), the controller 11 sends a signal to the motor/s 70 associated with the door 48/48b to decrease the size of the opening at the second inlet 44/44a of the airflow distribution balancer 14. The door 48/48b then returns to its former position and the amount or volume of recirculated air flowing through the airflow distribution balancer 14 and through the filter in the air pressuriser 16 and any additional filter/s 31 returns to its former level.

If the signals that the controller 11 receives from the dust sensor/s 20 indicates that the dust level is in accordance with the predetermined value or is within the predetermined value range, the output signal issued by the controller 11 directs the motor/s 70 to maintain the doors 48/48b at their current position/s.

Thus, to control dust levels the system 1 increases the amount or volume of recirculated airflow R to the enclosed space S, whilst in the case of maintaining pressure or maintaining CO₂ and undesirable gases to predetermined values, the system increases the amount or volume of fresh airflow F to the enclosed space S.

### Airflow Monitoring

Regarding operation of the system 1 when the controller 11 receives signals from an airflow sensor 24 in the system 1, the controller may issue output signals to the motor of the air pressuriser and/or the motors 70 of the doors 48/48b.

Each airflow sensor 24 is in operative communication with the controller 11. Each airflow sensor 24 provides input signals to the controller 11 in relation to the airflow at the location of the airflow sensor 24. The system 1 operates to maintain the airflows in the system 1 above respective predetermined values (i.e. predetermined airflow values). This ensures that the desired levels of fresh filtered air from the air pressuriser 16 and recirculated filtered air are delivered to the enclosed space S. Providing a respective airflow sensor 24 in the fresh airflow F, the recirculated airflow R and the single airflow A, as herein before described, provides the controller 11 with input signals from respective locations in each of these airflows.

The signals that the airflow sensors 24 provide to the controller 11 also serve to verify that the positioning of the doors 48/48b of the airflow distribution balancer is proportionally distributing the fresh air and recirculated air at the correct ratio.

The controller 11 responds to the signals received from the airflow sensors 24 by generating and sending output signals to the motor of the air pressuriser 16 (to increase or decrease the speed of the motor) and/or the motor/s 70 of the doors 48/48b (to move the doors 48/48b), in the manner herein before described, mutatis mutandis, to maintain the airflows at the respective predetermined airflow values and/or ensure the appropriate ratio of fresh air to recirculated air into the airflow distribution balancer is maintained.

### System—Second Embodiment

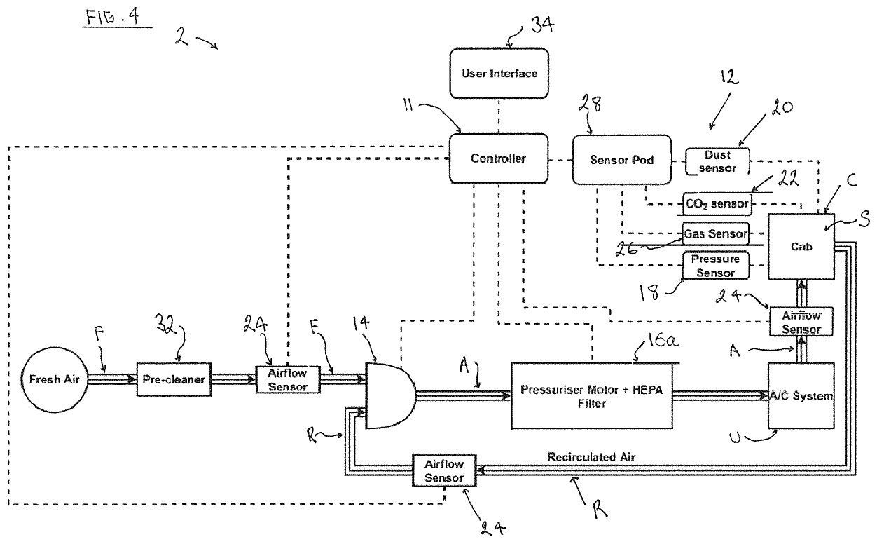

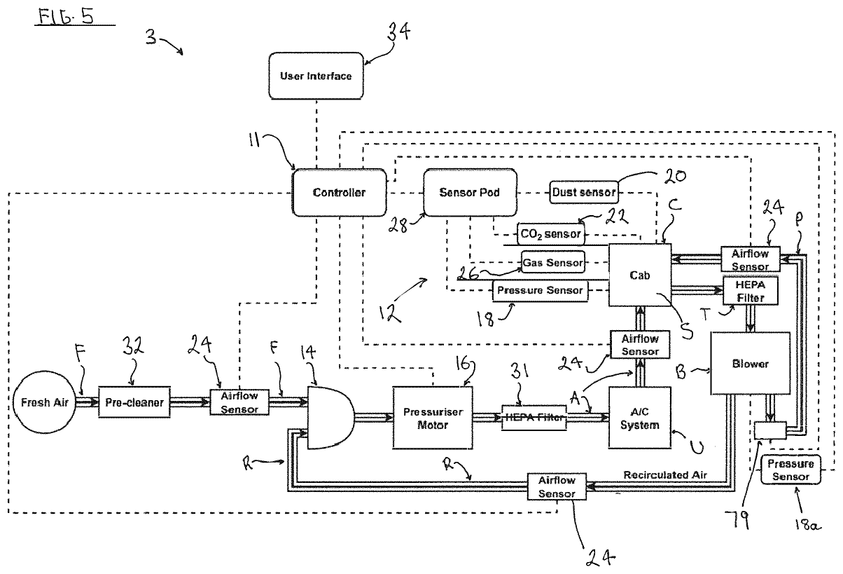

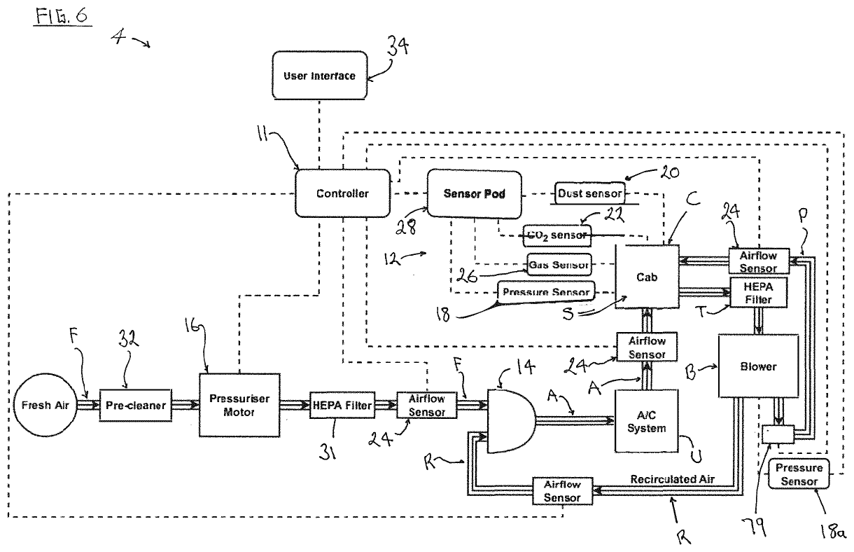

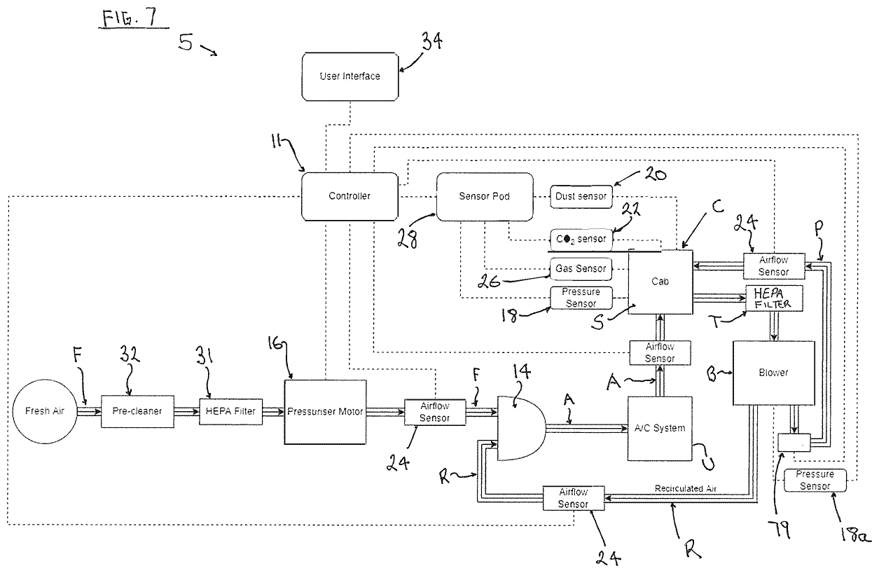

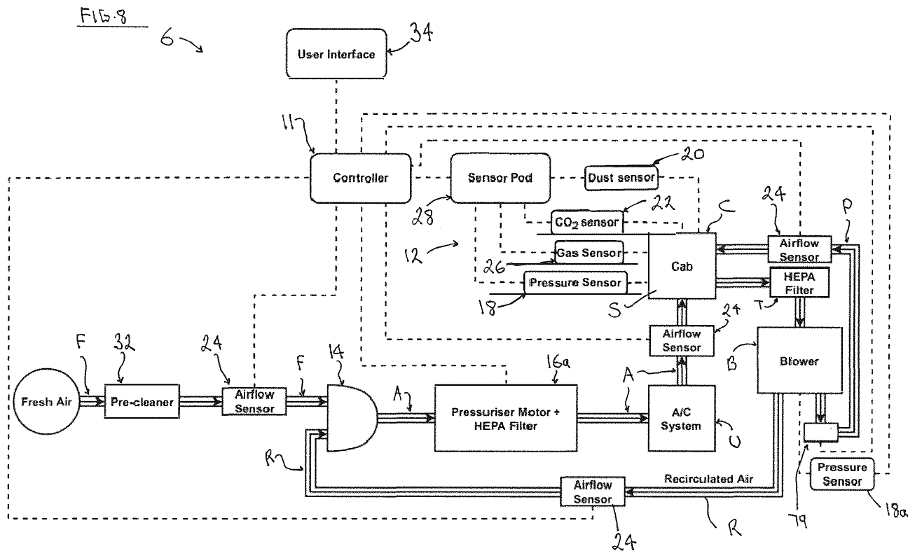

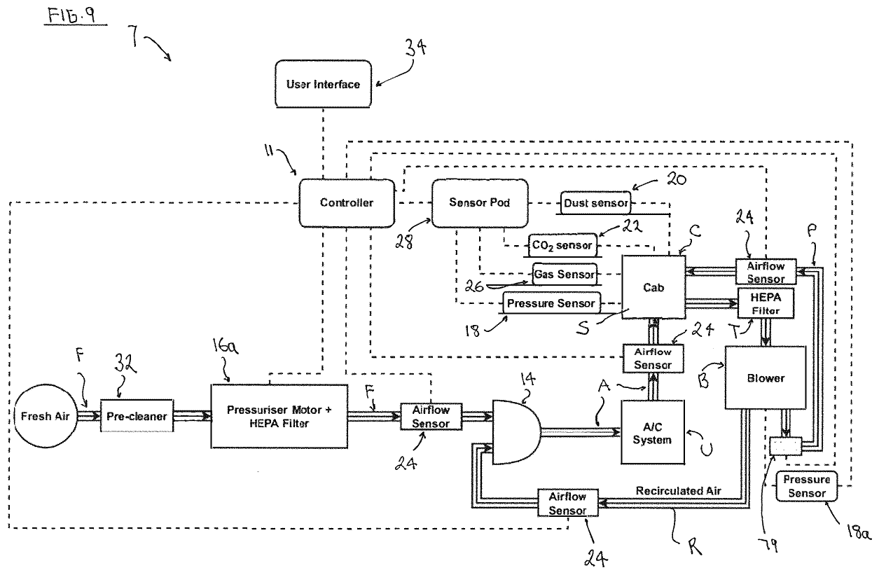

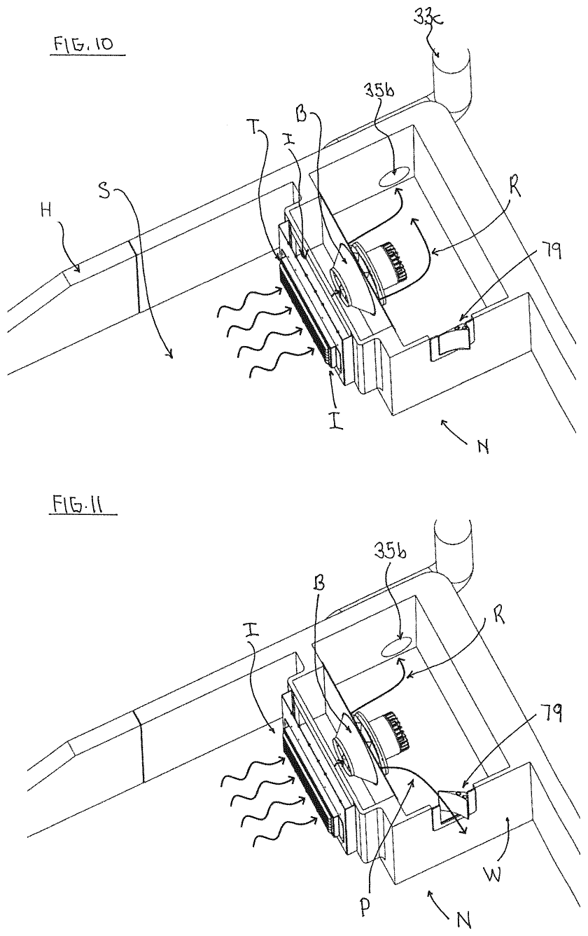

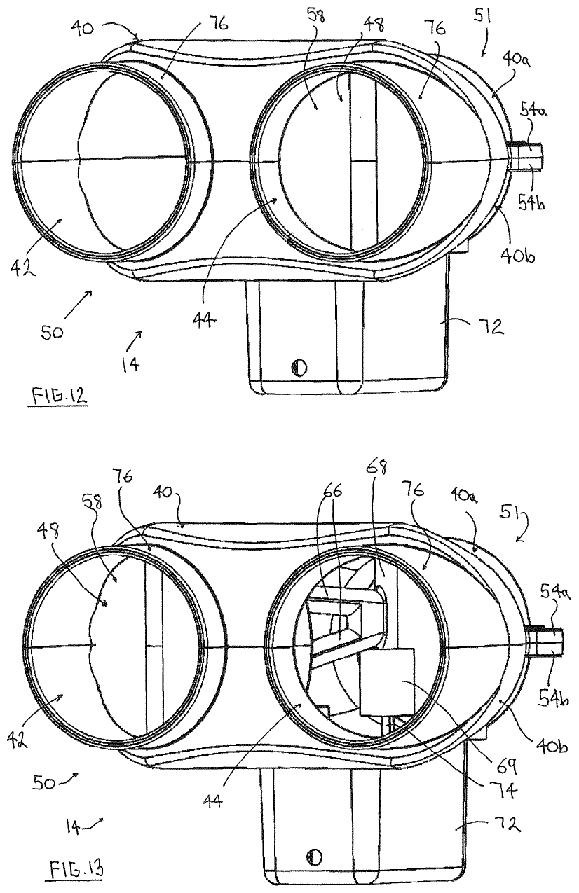

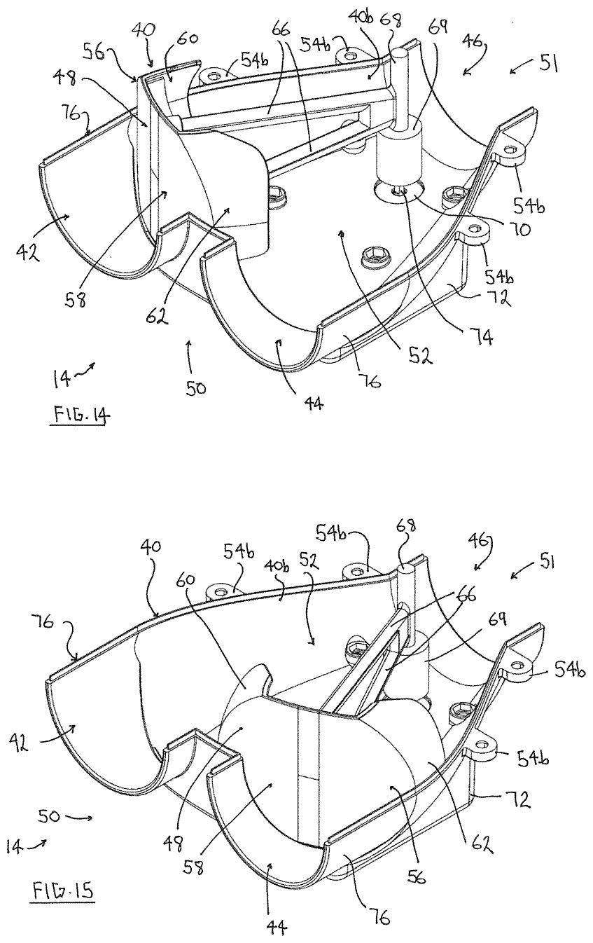

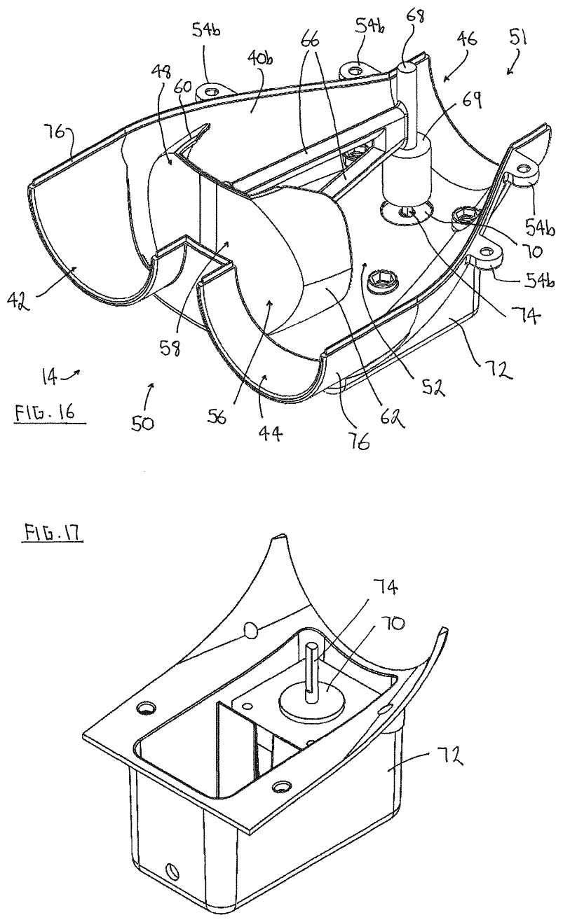

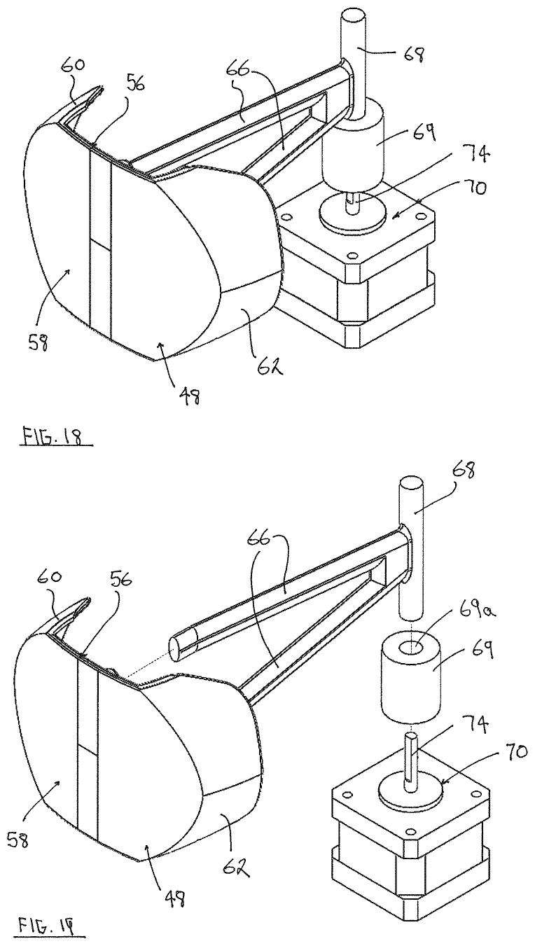

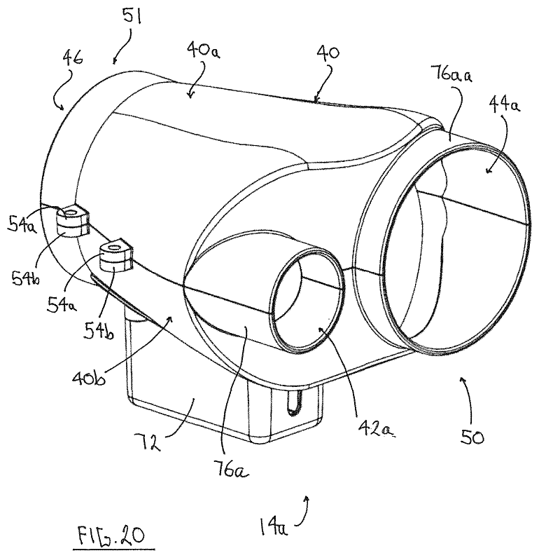

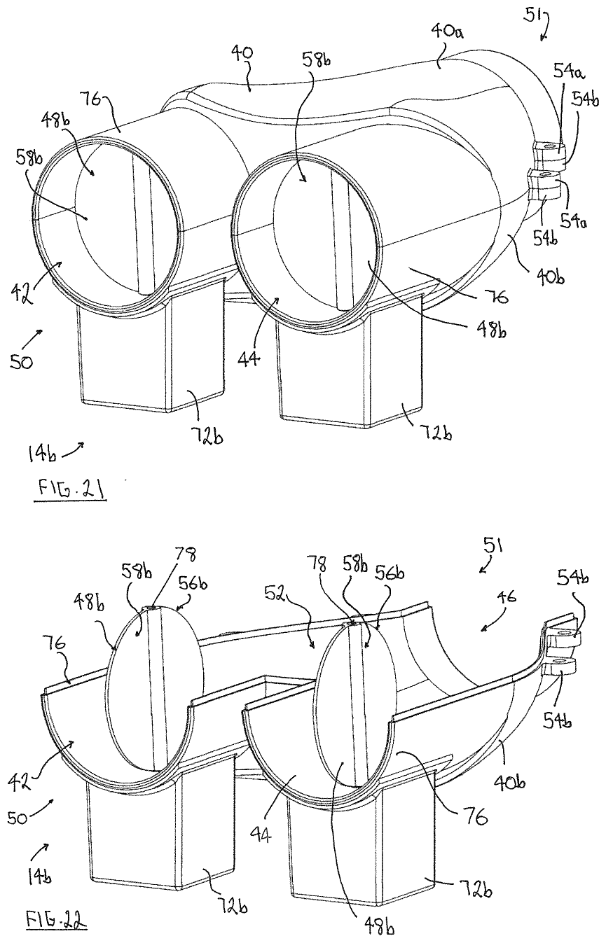

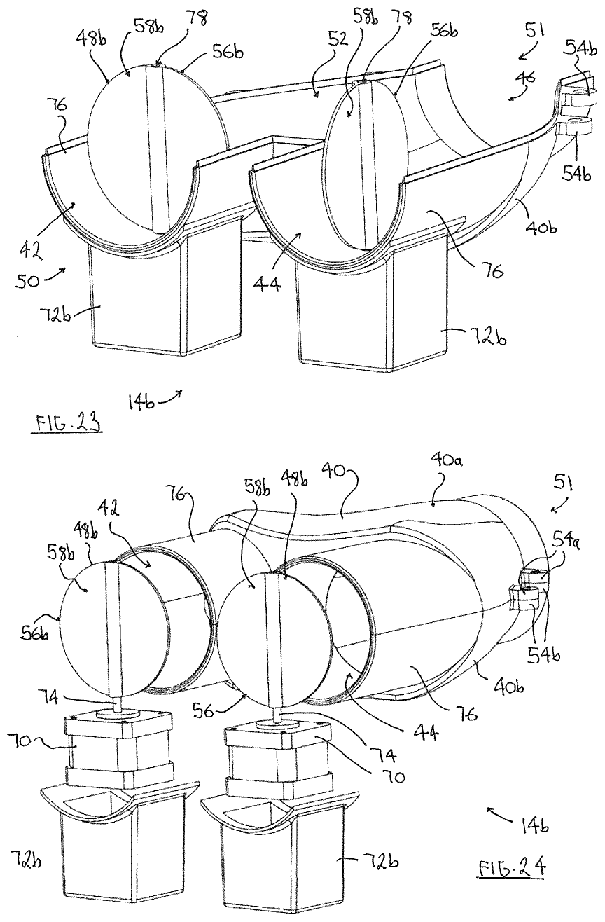

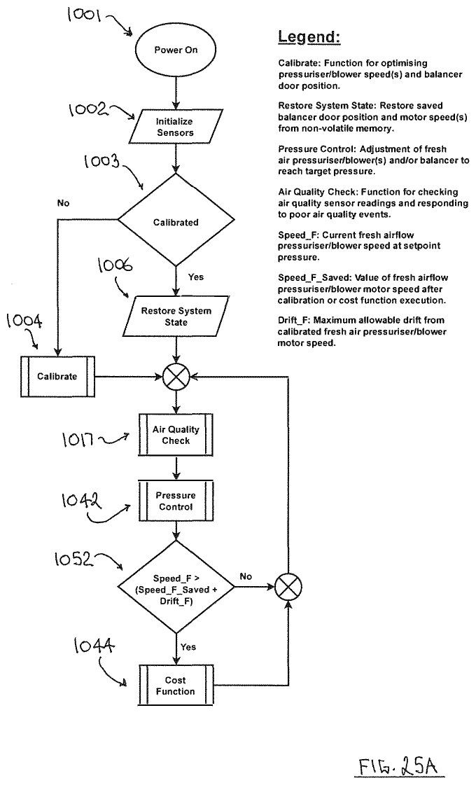

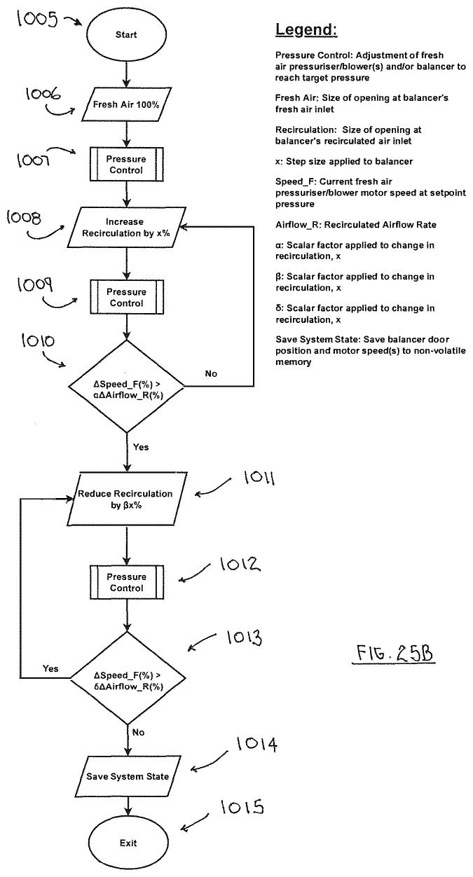

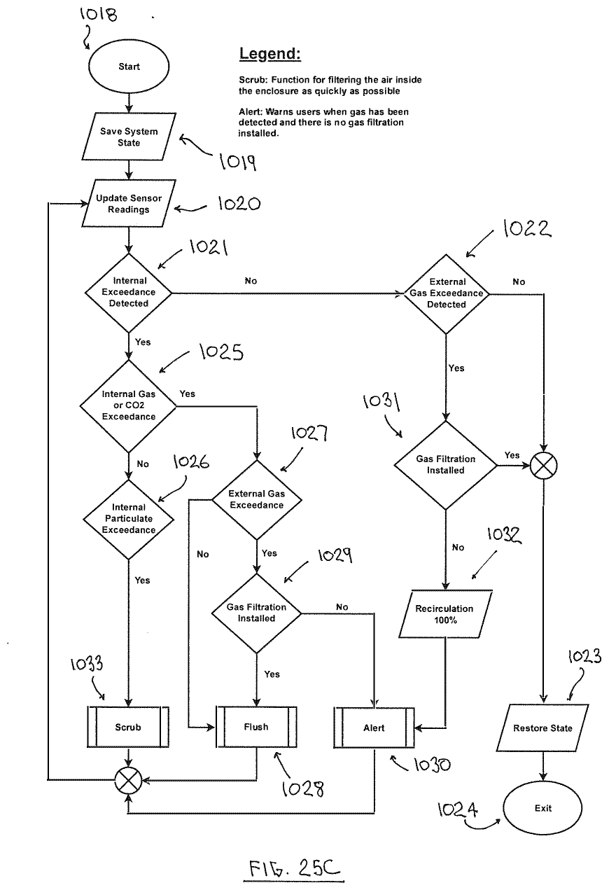

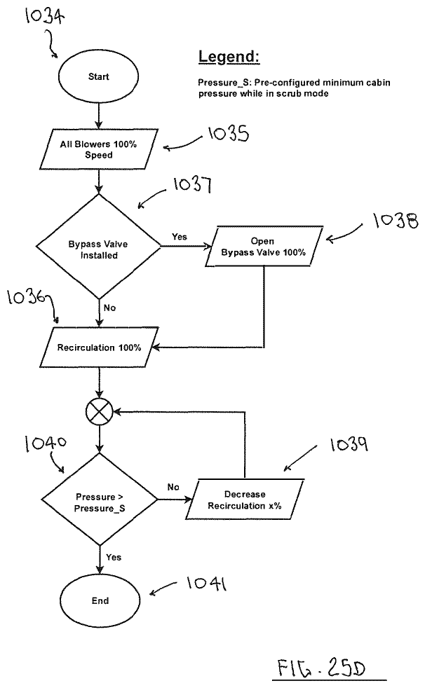

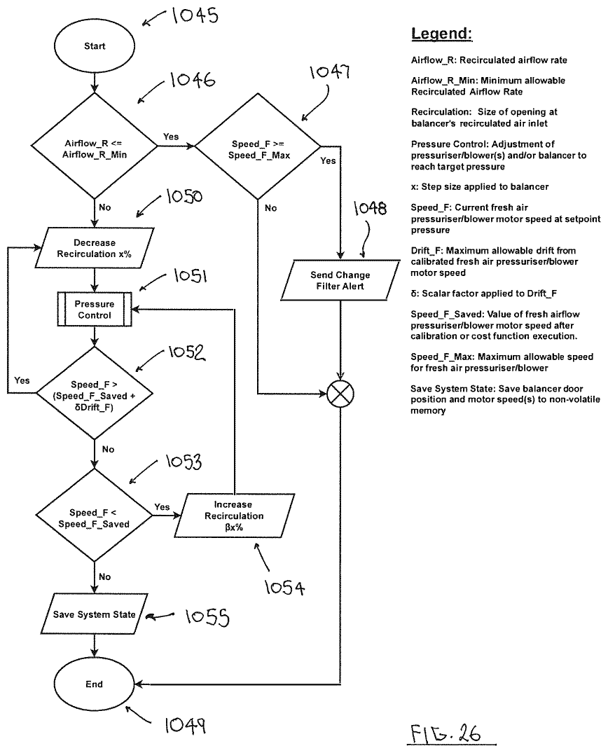

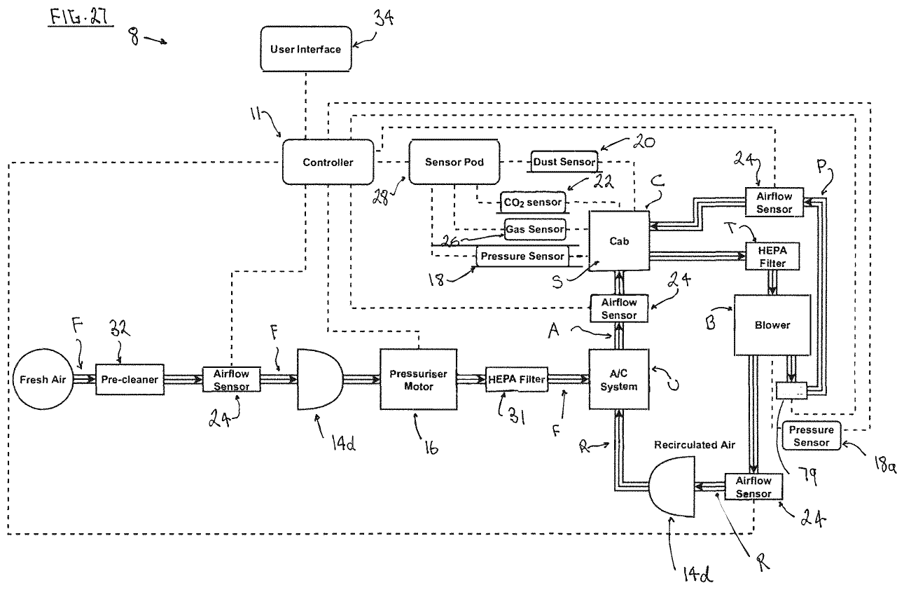

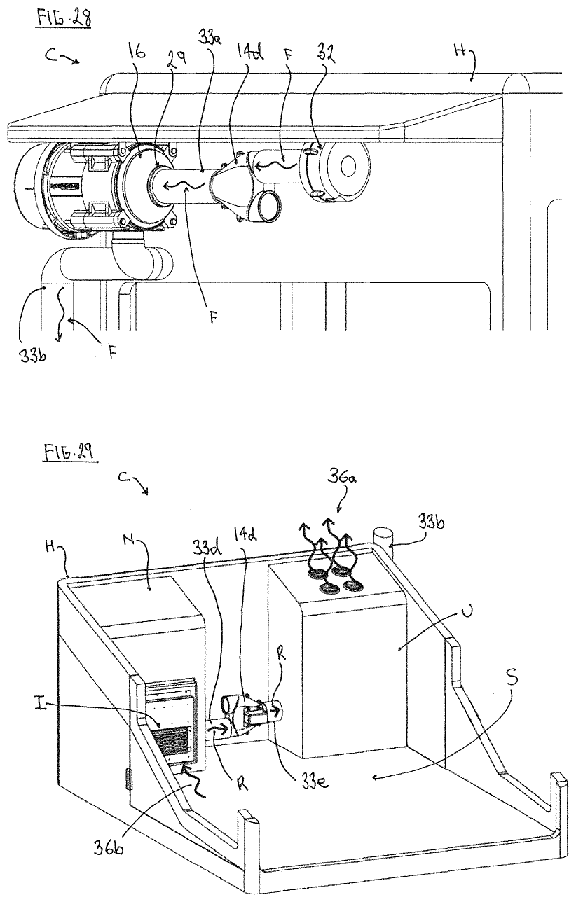

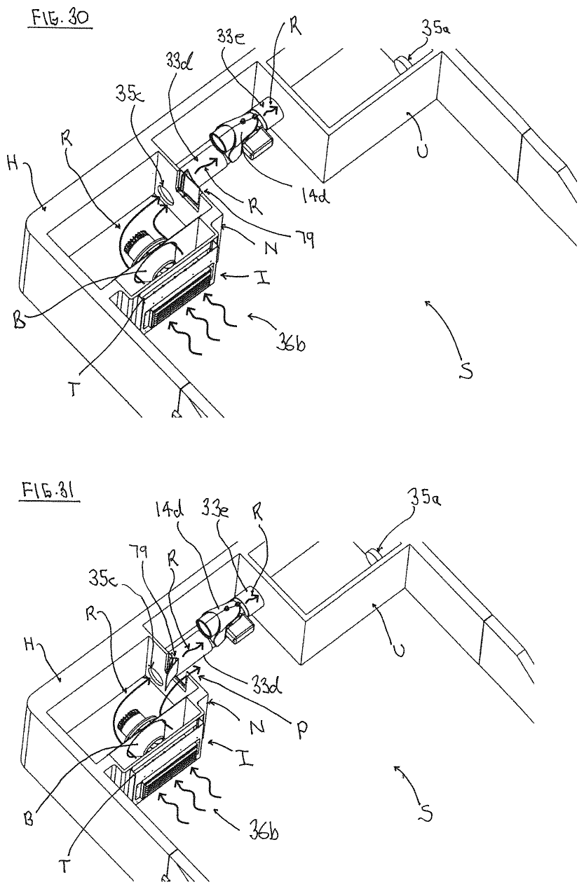

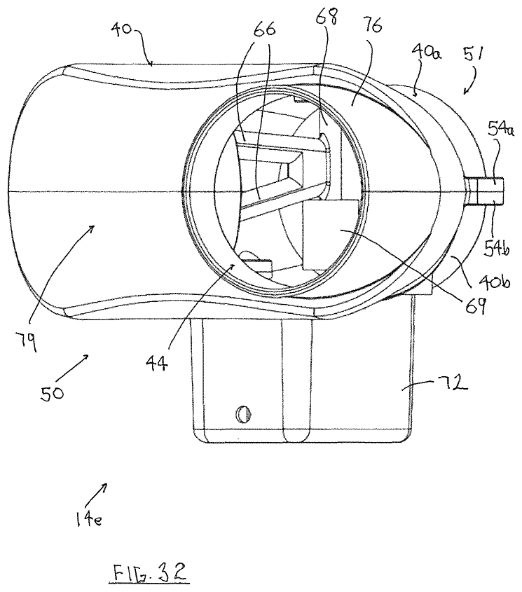

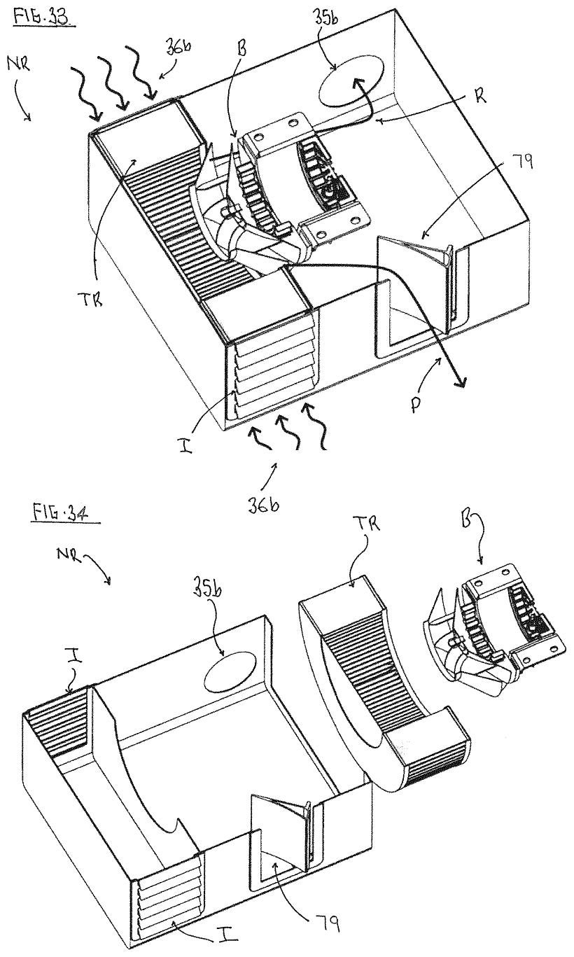

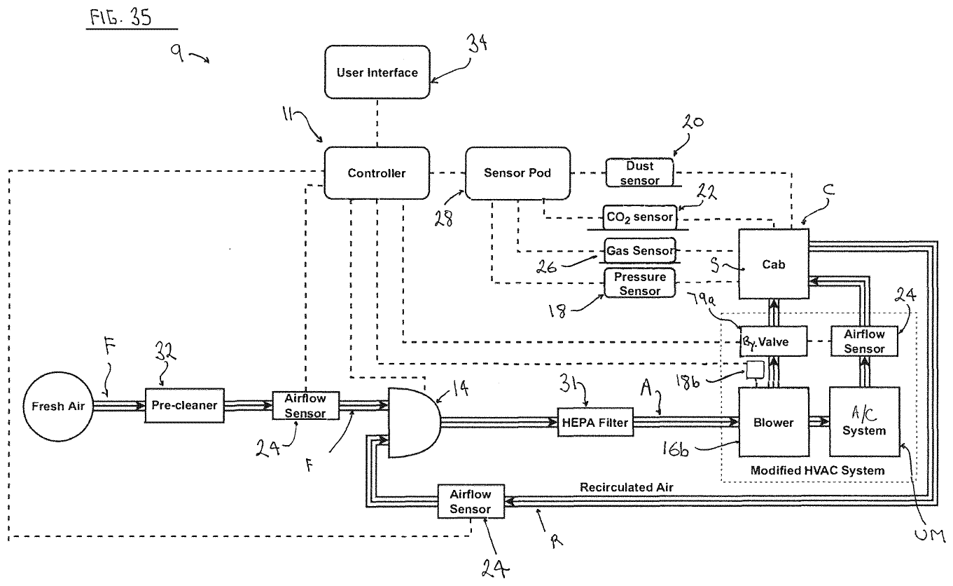

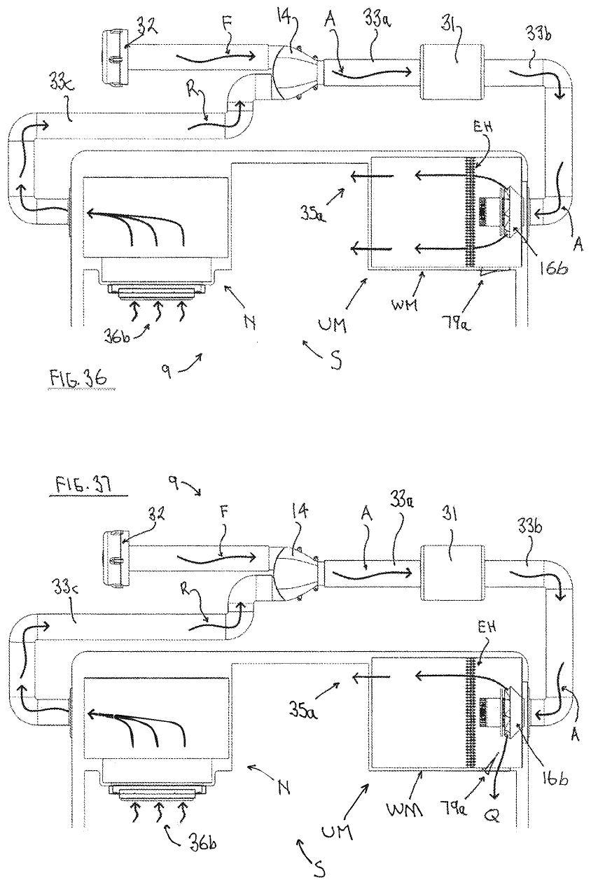

FIG. 4 is a schematic diagram showing second embodiment of a system 2 for monitoring and controlling air quality in an enclosed space S installed in a vehicle having a cabin C.

The components and features of the system 2 of the second embodiment are similar to those of the system 1 of the first embodiment except that, whereas the system 1 employs an air pressuriser 16 without a filter and a separate filter 31 in the single airflow A between the air pressuriser 16 and the air outlet unit U, the system 2 has a filter in the air pressuriser 16a of the system 2. The filter in the air pressuriser 16a is typically a higher grade filter and provides the filtering capabilities of the filter 31, in the system 1 of the first embodiment, to filter dirt and dust particles. Thus, the filter in the air pressuriser 16a, for example, may comprise a HEPA filter, a ULPA filter, an EPA filter, or other filter that is capable of filtering fine particulates. However, if the filter in the air pressuriser 16a did not provide the level of filtering required for a particular environment, one or more separate filter/s 31 (as herein before described with reference to the system 1 of the first embodiment) may be provided in the system 2.

In other respects, the system 2 of the second embodiment and its use and operation are similar to the system 1 of the first embodiment herein before described.

### System—Third to Seventh Embodiments

FIGS. 5 to 9 are schematic diagrams showing third to seventh embodiments of systems 3, 4, 5, 6 and 7, respectively, for monitoring and controlling air quality in an enclosed space S installed in a vehicle having a cabin C. Each of the systems 3, 4, 5, 6 and 7 is able to provide an increased recirculated airflow R, when required, when compared with the system 1 of the first embodiment or the system 2 of the second embodiment.

### System—Third Embodiment

The components and features of the system 3 of the third embodiment, shown schematically in FIG. 5, are similar to those of the system 1 of the first embodiment except that in the system 3, the recirculated airflow R is provided with a blower B and a bypass valve 79 (also referred to herein as a “first bypass valve”). In particular, the air return unit N is provided with a blower B and a bypass valve 79, as best seen in FIGS. 10 and 11. The blower B comprises a motor and a fan or impeller. The motor drives the fan or impeller of the blower B. The bypass valve 79 is able to open and close to allow or prevent airflow therethrough.

The blower B and the controller 11 are in operative communication such that the controller 11 is able to generate and send output signals to the blower B to adjust and control the operation of the blower B, i.e. the speed of the fan or impeller of the blower B. The blower B is provided adjacent to the air intake I of the air return unit N, inside the air return unit N. The blower B operates to draw air into the air return unit N from the enclosed space S.

The bypass valve 79 and the controller 11 are in operative communication such that the controller 11 is able to generate and send output signals to the bypass valve 79 to open and close the bypass valve 79. The bypass valve 79 is provided in a wall W of the air return unit N. The bypass valve 79 operates to allow air to flow from the air return unit N back into the enclosed space S when the bypass valve 79 is open. The bypass valve 79 allows a portion of the air from the enclosed space S (via the air return unit N), (on its way) to enter the recirculated airflow R, to (instead) return to the enclosed space S. Expressed alternatively, a portion of the air is returned to the enclosed space S via the bypass valve 79 instead of entering the recirculated airflow R. Filter T filters the air prior to the air passing through the blower B into the air return unit N. Consequently, any air passing through the bypass valve 79 (when it is open) into the enclosed space S is filtered air. The filter T is provided at the air intake I of the air return N. The bypass valve 79 can be placed in a closed position (in which air cannot flow through the bypass valve 79), an open position (in which the bypass valve 79 is fully open, allowing maximum airflow through the bypass valve 79), or an intermediate position in which the bypass valve 79 is partly open (allowing less than the maximum airflow through the bypass valve 79).

In addition to the blower B and the bypass valve 79, the system 3 is further provided with a pressure sensor 18a. The pressure sensor 18a is located at the downstream side of the blower B. This pressure sensor 18a is positioned inside the air return unit N.

The system 3 of the third embodiment is also suitable to employ to address some ISO standards. For example, the standard ISO 23875 for enclosed spaces requires a 120 second decay time. Decay time is defined by the standard as the time it takes for cabin particulates concentration to decrease from 2,000-5,000 μg/m³ to less than or equal to 25 μg/m³. Many systems, including the system 1 of the first embodiment and the system 2 of the second embodiment herein before described, may struggle to provide sufficient recirculated airflow to comply with the standard; this can particularly be the case in an enclosed space having a relatively larger volume with an existing air-conditioning system. This is because the air pressurisers and blowers may not be able to overcome the restrictions of the existing air-conditioner ducting and the particulates filter required by the standard. In contrast, the system 3 of the third embodiment, which is able to provide an increased recirculated airflow R when required, is able to perform in a manner to address the ISO standard.

### Use and Operation: System—Third Embodiment

The following description of the use and operation of the system 3 is limited to the use and operation arising from the inclusion of the blower B, bypass valve 79 and pressure sensor 18a in the system 3. However, it is to be understood that the use and operation of the system 1 of the first embodiment, as herein before described, also applies to the system 3 of the third embodiment.

In standard operation, the speed of the fan or impeller of the blower B matches the demand of the air pressuriser 16 to provide sufficient air to the recirculated airflow R. This maintains the pressure inside the compartment housing the blower B (in the air return unit N) at the same pressure as the pressure in the enclosed space S. In that regard, the pressure in the enclosed space S serves as a reference pressure for the pressure sensor 18a. It can be expected that the pressure sensor 18a detects ambient pressure levels inside the blower B. Under standard, or normal, operating conditions, the blower B provides sufficient air to the air pressuriser 16. Under standard, or normal, operating conditions, the bypass valve 79 is in the closed position. The closed position of the bypass valve 79 is shown in FIG. 10.

If the pressure sensor 18a senses a negative pressure reading (indicating negative pressure in the third duct 33c) this suggests that the air pressuriser 16 is drawing more air than the blower B is supplying. Upon the controller 11 receiving an input signal from the pressure sensor 18a indicating a negative pressure reading, the output signal generated and sent by the controller 11 to the blower B directs the blower B to increase the speed of the fan or impeller until the pressure sensed by the pressure sensor 18a is equal to or greater than the ambient pressure. The bypass valve 79 remains in the closed position (as shown in FIG. 10)

In contrast, if the pressure sensor 18a senses a positive pressure reading (indicating positive pressure in the third duct 33c), this suggests that the ducting and/or filters in the system 3 are limiting the amount or volume of air that can flow in the recirculated airflow R. Upon the controller 11 receiving an input signal from the pressure sensor 18a indicating a positive pressure reading, the controller 11 generates and sends an output signal to the blower B to decrease the speed of the fan or impeller until the pressure sensed by the pressure sensor 18a is within a predetermined range of the ambient pressure or the motor of the blower B reaches a minimum predetermined speed. The minimum predetermined speed may correspond to the stall speed of the motor. In this standard operation, the bypass valve 79 is opened only when the motor of the blower B has reached its minimum speed and positive pressure is still being sensed by the pressure sensor 18a. When the bypass valve 79 is open, some air is able to bypass the third duct 33c and instead flows from inside the air return unit N back into the enclosed space S. This provides sufficient recirculated air to the enclosed space S. The open position of the bypass valve 79 is shown in FIG. 11. FIG. 11 shows that some air passes from inside the return air unit N through the opening 35b into the third duct 33c (i.e. the recirculated airflow R) and some air bypasses the third duct 33c and flows through the open bypass valve 79 back into the enclosed space (as shown by arrow P). In contrast, in FIG. 10, since the bypass valve 79 is closed, air from the air return unit N is able to flow only into the duct 33c.

The system 3 also provides a rapid scrubbing or cleaning facility (also referred to herein as a scrub mode). In that regard, the controller 11 can generate and send output signals to the bypass valve 79 and the blower B to fully open the bypass valve 79 and maximise the speed of the fan or impeller of the blower B. This rapidly increases airflow through the enclosed space S to scrub or clean the air in the enclosed space S. The other embodiments of the systems 1, 2 and 4 to 10 described herein also provide a scrub mode. In the scrub mode, recirculated airflow R is maximised. This can be achieved by the doors 48/48b of the airflow distribution balancer being adjusted to allow maximum recirculated airflow R (and minimum fresh airflow F) therethrough. However, embodiments of the system that have a blower B and bypass valve 79 are able to achieve greater recirculated airflow R than the embodiments that do not have a blower B and bypass valve 79. The scrub mode is further described herein with reference to FIGS. 25C and 25D.

The input signals received by the controller 11 from the pressure sensor 18a (which are indicative of the pressure in the air return unit N) may be used to detect blockages in the recirculated airflow R, e.g. blockages caused by obstructions in front of (i.e. on the upstream side of) the filter T. By way of example, if the pressure sensor 18a senses a negative pressure reading and the sensed pressure does not change (i.e. increase) significantly (e.g. by a predetermined amount) with increasing speed of the fan or impeller of the blower B, the logic in the controller 11 can conclude that the filter T is blocked. The controller 11 can then issue an alert. The alert indicates to an operator that maintenance is required and the appropriate corrective action can be taken.

### System—Fourth Embodiment

The components and features of the system 4 of the fourth embodiment, shown schematically in FIG. 6, are similar to those of the system 3 of the third embodiment except that in the system 4 the air pressuriser 16 and the filter 31 are provided in the fresh airflow F, which flows to the fresh air inlet 42. Thus, the air pressuriser 16 and the filter 31 are provided on the upstream side of the airflow distribution balancer 14. As can be seen in FIG. 5, the air pressuriser 16 and filter 31 are provided between the precleaner 32 and an airflow sensor 24.

In contrast, in the system 3 of the third embodiment, the air pressuriser 16 and the filter 31 are provided in the single airflow A, which exits the airflow distribution balancer 14, on the downstream side of the airflow distribution balancer 14.

In other respects, the system 4 of the fourth embodiment and its use and operation are similar to the system 3 of the third embodiment herein before described.

### System—Fifth Embodiment

The components and features of the system 5 of the fifth embodiment, shown schematically in FIG. 7, are similar to those of the system 4 of the fourth embodiment except that in the system 5 the sequence of the air pressuriser 16 and the filter 31 are reversed. That is, in the system 5, the fresh air flows from the precleaner 32 through the filter 31 and then through the air pressuriser 16. In contrast, in the system 4 of the fourth embodiment, the fresh air flows from the precleaner 32 through the air pressuriser 16 and then through the filter 31.

In other respects, the system 5 of the fifth embodiment and its use and operation are similar to the system 4 of the fourth embodiment herein before described.

### System—Sixth Embodiment

The components and features of the system 6 of the sixth embodiment, shown schematically in FIG. 8, are similar to those of the system 3 of the third embodiment (shown in FIG. 5) except that, whereas the system 3 employs an air pressuriser 16 (without a filter) and a separate filter 31 in the single airflow A between the air pressuriser 16 and the air outlet unit U, the system 6 uses a filter in the air pressuriser 16a of the system 6. The filter in the air pressuriser 16a of the system 6 is similar to the filter in the air pressuriser 16a of the system 2 of the second embodiment herein before described.

In other respects, the system 6 of the sixth embodiment and its use and operation are similar to the system 3 of the third embodiment herein before described.

### System—Seventh Embodiment

The components and features of the system 7 of the seventh embodiment, shown schematically in FIG. 9, are similar to those of the system 6 of the sixth embodiment except that in the system 7 the air pressuriser 16a is provided in the fresh airflow F, which flows to the fresh air inlet 42. Thus, the air pressuriser 16a is provided on the upstream side of the airflow distribution balancer 14. As can be seen in FIG. 9, the air pressuriser 16a is provided between the precleaner 32 and an airflow sensor 24.

In contrast, in the system 6 of the sixth embodiment, the air pressuriser 16a is provided in the single airflow A, which exits the airflow distribution balancer 14, on the downstream side of the airflow distribution balancer 14.

In other respects, the system 7 of the seventh embodiment and its use and operation are similar to the system 6 of the sixth embodiment herein before described.

### System—Eighth Embodiment

FIG. 27 is a schematic diagram showing an eighth embodiment of a system 8 for monitoring and controlling air quality in an enclosed space S installed in a vehicle having a cabin C.

Whilst the embodiments of the system herein before described include a single airflow distribution balancer, the system 8 of the eighth embodiment includes two airflow distribution balancers. One airflow distribution balancer is used to control the fresh airflow F and the second airflow balancer is used to control the recirculated airflow R.

The components and features of the system 8 of the eighth embodiment are similar to the components and features of the system 3 of the third embodiment except that, whereas the system 3 has a single airflow distribution balancer 14, the system 8 has two airflow distribution balancers, identified by reference numeral 14d. The airflow distribution balancers 14d may be any one of the airflow distribution balancers 14 #of the first, second, third and fourth embodiments herein before described, except that one of the inlets (i.e. either the first inlet 42/42a or the second inlet 44/44a) is permanently closed or blocked off. In the case of the airflow distribution balancer 14b of the third embodiment, one of the doors 48b is permanently closed to prevent airflow through the corresponding inlet, whether it be the inlet 42 or the inlet 44. In the case of one of the other embodiments of the airflow distribution balancer being used as the airflow distribution balancer 14d, one of the inlets is blocked off such that only one of the inlets of the airflow distribution balancer 14d receives an airflow. Thus, movement of the door 48 acts to open and close only one of the inlets, i.e. the one that is able to receive an airflow. One airflow distribution balancer 14d receives the fresh airflow F and the other airflow distribution balancer 14d receives the recirculated airflow R.

With particular reference to FIG. 27, a first airflow distribution balancer 14d is located in the fresh airflow F. This first airflow distribution balancer 14d is provided at a location similar to the location of the airflow distribution balancer 14 in the system 3. This first airflow distribution balancer 14d receives only the fresh airflow F. FIG. 28 shows the first airflow distribution balancer 14d, with the fresh air inlet 42 connected to the outlet of the air precleaner 32. Thereby, the first airflow distribution balancer 14d receives the fresh airflow F. The outlet 46 of the first airflow distribution balancer 14d is connected to the inlet 29 of the air pressuriser 16.

A second airflow distribution balancer 14d is located in the recirculated airflow R. This second airflow distribution balancer 14d is located in the recirculated airflow R between the air return unit N and the air outlet unit U. This second airflow distribution balancer 14d receives only recirculated airflow R. FIGS. 29, 30 and 31 show the second airflow distribution balancer 14d connected to the air return unit N and the air outlet unit U. A duct 33d extends from an opening 35c, formed in the casing of the air return unit N, to the second inlet 44 of the second airflow distribution balancer 14d. The second airflow distribution balancer 14d receives the recirculated airflow via the second inlet 44 from the air return unit N. A duct 33e extends from the outlet 46 of the second airflow distribution balancer 14d to an opening formed in the casing of the air outlet unit U. The recirculated airflow R flows from the second airflow balancer 14d to the air outlet unit U via the duct 33e.

Two separate airflow distribution balancers 14d to respectively control the fresh airflow F and the recirculated airflow R allows the fresh airflow F and the recirculated airflow R to be independently controlled.

This independent control of the fresh airflow F and the recirculated airflow R is also achieved in the embodiments of the system that use the airflow distribution balancer 14b of the third embodiment, which has a separate door 48b for each inlet 42/44. However, in the system 8, the control of the fresh airflow F and the recirculated airflow R occurs at the two separate locations of the first and second airflow distribution balancers 14d.

In the system 8, both the fresh airflow F and the recirculated airflow R flow through their respective first and second airflow distribution balancers 14d. The fresh airflow F and the recirculated airflow R separately enter the air outlet unit via their respective ducts 33b (fresh airflow F) and 33e (recirculated airflow R). The fresh air and the recirculated air (in the fresh airflow F and recirculated airflow R) mix in the air outlet unit U in a single airflow and are expelled from the air outlet unit U as indicated by reference numeral 36a in FIG. 29.

Using two separate airflow distribution balancers 14d, as used in system 8, may be desirable in situations in which the fresh airflow F and the recirculated airflow R are not able to be ducted into the same airflow distribution balancer.

Whilst the embodiments of the systems 1 to 7, herein before described, include a duct 33c that extends from the air return unit N to the airflow distribution balancer 14, such a duct 33c is not required in the system 8 since recirculated air is not conveyed to the first airflow distribution balancer 14d that is located at the rear of the cabin C.

In other respects, the system 8 of the eighth embodiment and its use and operation are similar to the system 3 of the third embodiment herein before described.

### Airflow Distribution Balancer—Fifth Embodiment (One Inlet)

FIG. 32 shows a fifth embodiment of an airflow distribution balancer 14e. The airflow distribution balancer 14e may be used as the airflow distribution balancer in the eighth embodiment of the system 8 shown in FIGS. 27 to 31.

The airflow distribution balancer 14e comprises only a single inlet. The single inlet receives either the fresh airflow F or the recirculated airflow R.

The airflow distribution balancer 14e is similar to the airflow distribution balancer 14 of the first embodiment, except that the airflow distribution balancer 14e has only one inlet, whereas the airflow distribution balancer 14 has two inlets 42 and 44. In the airflow distribution balancer 14e, in place of a second inlet, the casing 40 is formed continuously without an inlet.

Comparing FIGS. 12 and 32, it can be seen that in the airflow distribution balancer 14e, the first inlet 42 has been omitted and the airflow distribution balancer 14e has only the second inlet 44. In an alternative embodiment (not shown), the airflow distribution balancer 14e may omit the second inlet 44 and have only the first inlet 42 as the single inlet.

The airflow distribution balancer 14e may be used and functions in the same manner as the airflow distribution balancer 14d as herein before described.

### Alternative Air Return Unit

FIGS. 33 and 34 show a cut-away view and an exploded view, respectively, of an alternative embodiment of an air return unit NR for the third to eighth embodiments of system, variously shown in FIGS. 5 to 32. The air return unit NR is similar to the air return unit N, herein before described with reference to the other embodiments of the system, except that the air return unit NR has a filter TR that is radial. In contrast, the filter T herein before described with reference to other embodiments of the system, is a panel filter. The filter TR is positioned around the fan or impeller of the blower B. The air return unit NR may be provided with two air intakes I to draw in air, as shown at reference numeral 36b. Air that is drawn into the air return unit NR, via the air intakes, passes through the filter TR and then past the blower.

In other respects, the air return unit NR and its use and operation are similar to the air return unit N herein before described.

### System-Ninth Embodiment (Modified HVAC System-One Filter)

FIG. 35 is a schematic diagram showing a ninth embodiment of a system 9 for monitoring and controlling air quality in an enclosed space S installed in a vehicle having a cabin C.

As an alternative to the embodiments of the system herein before described, the system 9 includes modifications to the existing (or intended conventional) HVAC system for the enclosed space S. In particular, the air outlet unit UM, shown in FIGS. 36 and 37, is modified to include a high capacity blower 16b. The air outlet unit UM may also be provided with a bypass valve 79a (also referred to herein as a “second bypass valve”). The bypass valve 79a is able to open and close to allow or prevent airflow therethrough.

In conventional HVAC systems, fresh and recirculated air are drawn into a compartment containing an evaporator and heater for air-conditioning and a blower for moving the air. Air that is pushed by the blower is then directed into the ducting of the HVAC system to be distributed into the cabin or other enclosed space. In the configuration of system 9, the incoming fresh airflow F and recirculated airflow R are combined (i.e. mixed) and controlled by the airflow distribution balancer 14, as in the other embodiments of the system herein before described. However, the high capacity blower 16b is included in the system 9 (instead of a conventional blower that would be present in a conventional HVAC system) to provide the function of an airflow generator.

### Airflow Generator—Second Embodiment

In the embodiments of the system herein before described (namely embodiments of the system 1 to 8), the airflow generator is provided in the form of an air pressuriser 16. However, in the system 9 the airflow generator is provided in the form of a blower 16b. The blower 16b comprises a motor and a fan or impeller. The motor drives the fan or impeller of the blower 16b. The blower 16b is provided as a high capacity blower. The existing (or intended conventional) HVAC system for the enclosed space S is modified to replace the conventional blower (in the HVAC system) with the high capacity blower 16b. Regarding blower capacity, for example, whilst a conventional blower may have a capacity in the range up approximately 150 to 250 CMH (cubic metres per hour) a high capacity blower 16b typically has a capacity in the range of 200 to 700 CMH.

In the system 9, the high capacity blower 16b generates the fresh airflow F and the recirculated airflow R. Consequently, an air pressuriser 16/16a, which is used in the other embodiments of the system herein before described, is not required in the system 9. Since the system 9 does not include an air pressuriser 16/16a, the filter (if present) in the air pressuriser 16a is also not included in the system 9. However, the system 9 includes one or more filters 31, as herein before described with reference to the other embodiments. At least one of these filters 31 is a fine particulates filter. The filter 31 is provided upstream of the enclosed space S. As shown in FIG. 35, the filter 31 may be provided downstream of the airflow distribution balancer 14. The filter 31 is provided in the ducting extending from the airflow distribution balancer 14 to the cabin C. This ducting is identified as the ducts 33a and 33b in FIGS. 36 and 37. The location of the filter 31 can be seen in FIGS. 35, 36 and 37. The filter 31 may be a radial filter. Since the system 9 does not include an air pressuriser 16/16a, the first duct 33a extends from the outlet 46 of the airflow distribution balancer 14 to the filter 31. The second duct 33b extends from the filter 31 to the air outlet unit UM.

### Use and Operation

The high capacity blower 16b and the controller 11 are in operative communication such that the controller 11 is able to generate and send output signals to the high capacity blower 16b to adjust and to control the operation of the high capacity blower 16b. The bypass valve 79a and the controller 11 are in operative communication such that the controller 11 is able to generate and send output signals to the bypass valve 79a to open and close the bypass valve 79a. The bypass valve 79a is provided in a wall WM of the air outlet unit UM. The bypass valve 79a can be placed in a closed position (in which air cannot flow through the bypass valve 79a), an open position (in which the bypass valve 79a is fully open, allowing maximum airflow through the bypass valve 79a), or an intermediate position in which the bypass valve 79a is partly open (allowing less than the maximum airflow through the bypass valve 79a). The closed position of the bypass valve 79a is shown in FIG. 36. The fully open position of the bypass valve 79a is shown in FIG. 37. The bypass valve 79a operates to allow air to flow from the air outlet unit UM into the enclosed space S when the bypass valve 79a is open (i.e. fully open or partly open). The bypass valve 79a allows a portion of the air in the outlet airflow A (in the air outlet unit UM), (on its way into the enclosed space S) to be directed to enter the enclosed space S via the bypass valve 79a (instead of via the air outlet unit UM).

The bypass valve 79a may be included to maximise filtration of recirculated air and achieve the required decay time (as herein before described). As with the bypass valve 79 in the third embodiment of the system 3, the position of the bypass valve 79a of the system 9 is controlled by the pressure inside the HVAC system. The system 9 is provided with a pressure sensor 18b. The pressure sensor 18b is located at the downstream side of the high capacity blower 16b. The pressure sensor 18b is positioned inside the air outlet unit UM. The pressure sensor 18b may be a differential pressure sensor.

If the pressure sensor 18b senses that there is a significant build-up of air pressure (e.g. a configurable predetermined increase in air pressure) within the system (i.e. inside the air outlet unit UM), the controller 11 generates and sends an output signal to the blower 16b to decrease the speed of the fan or impeller until the pressure sensed by the pressure sensor 18b is within a predetermined range of the ambient pressure or the motor of the blower 16b reaches a minimum predetermined speed. The minimum predetermined speed may correspond to the stall speed of the motor. In this standard operation, the bypass valve 79a is opened only when the motor of the blower 16b has reached its minimum speed and positive pressure is still being sensed by the pressure sensor 18b. When the bypass valve 79a is open some air, i.e. airflow Q (as shown in FIG. 37), is able to flow therethrough into the enclosed space S. The airflow Q results in a decrease in the pressure in the air outlet unit UM that is sensed by the pressure sensor 18b; correspondingly, the sensed air pressure increases in the enclosed space S. The airflow Q bypasses the downstream evaporator, heater and ducting. The evaporator and heater in the air outlet unit UM are indicated by reference letters EH. The bypass valve 79a is located upstream of the evaporator and heater EH. Having the bypass valve 79a located upstream of the evaporator and heater EH avoids the airflow Q through the bypass valve 79a being restricted by the evaporator and heater EH. Conversely, if the pressure sensor 18b senses that there is a drop in the air pressure (e.g. a configurable predetermined decrease in air pressure) inside the air outlet unit UM, the controller 11 sends a signal to the bypass valve 79a to close the bypass valve 79a (if it is open) to prevent airflow Q therethrough. In addition, or alternatively, the controller 11 sends a signal to the motor of the blower 16b to increase the speed of the motor. This increases the speed of rotation of the fan or impeller of the motor. Increasing the speed of rotation of the fan or impeller increases the amount or volume of air that is drawn though the air outlet unit UM by the blower 16b. This results in an increase in the air pressure inside the air outlet unit UM.

### System—Tenth Embodiment (Modified Hvac System—Two Filters)

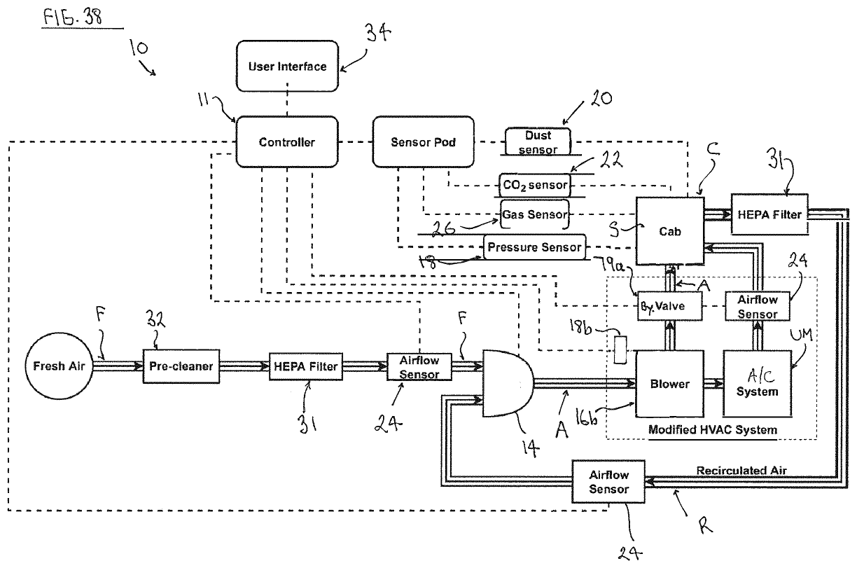

FIG. 38 is a schematic diagram showing a tenth embodiment of a system 10 for monitoring and controlling air quality in an enclosed space S installed in a vehicle having a cabin C.

The components and features of the system 10 of the tenth embodiment, shown schematically in FIG. 38, are similar to those of the system 9 of the ninth embodiment except that in the system 10, there are two filters 31.

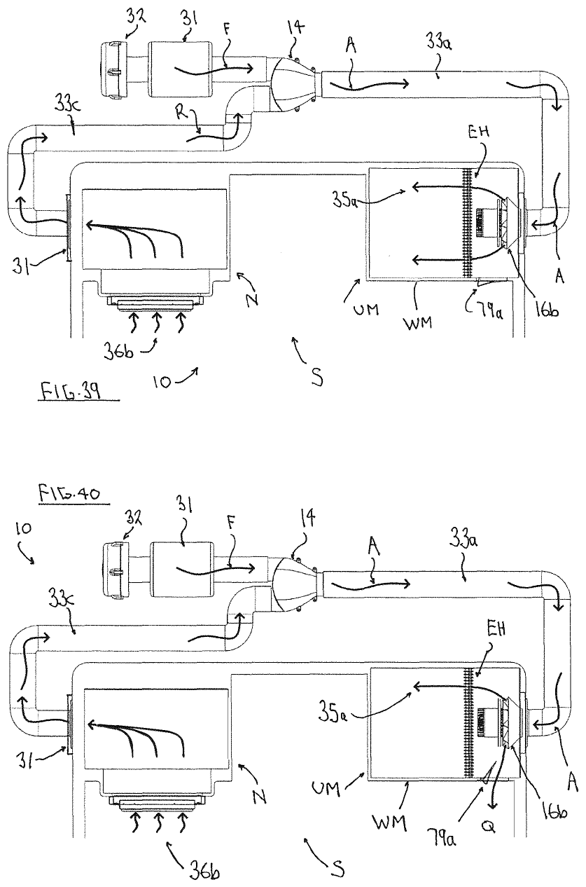

A first filter 31 is provided upstream of the airflow distribution balancer 14. The first filter 31 is provided upstream of the first inlet 42 (for the fresh air flow F) of the airflow distribution balancer 14. Thus, the first filter 31 filters only the air in the fresh airflow F. The first filter 31 is provided upstream of the enclosed space S. The location of the first filter 31 can be seen in FIGS. 38, 39 and 40. The first filter 31 may be radial filter. The first duct 33a extends from the outlet 46 of the airflow distribution balancer 14 to the air outlet unit UM.

A second filter 31 is provided upstream of the airflow distribution balancer 14. The second filter 31 is provided upstream of the second inlet 44 (for the recirculated airflow R) of the airflow distribution balancer 14. Thus, the second filter 31 filters only the air in the recirculated airflow R. The second filter 31 is provided downstream of the enclosed space S. The location of the second filter 31 can be seen in FIGS. 38, 39 and 40. The second filter 31 may be a panel filter. The second filter 31 may be located on shell H of the cabin C at the opening 35b.

In other respects, the system 10 of the tenth embodiment and its use and operation are similar to the system 9 of the ninth embodiment herein before described.

### Use and Operation—Supplementary

As herein before described in the preceding sections of the use and operation of the systems 1-10 and the monitoring of various environmental parameters, the controller 11 generates and sends output signals to the motor of the air pressuriser 16/16a or blower 16b and/or the motors 70 of the doors 48/48b of the airflow distribution balancer/s in response to input signals that the controller 11 receives from the sensors 12. The output signals generated and sent by the controller 11 control the operation of the motors to adjust the speed of the fan or impeller of the air pressuriser 16/16a or blower 16b and/or the position/s of the doors 48/48b. Changes in the position/s of the doors 48/48b of the airflow distribution balancer/s are made after the setpoint pressure has been reached by adjusting the speed of the air pressuriser 16/16a or blower 16b. Furthermore, as herein before described in the preceding sections of the use and operation of the systems 3-8 and the monitoring of various environmental parameters, in the case of the systems 3-8, the controller 11 also generates and sends output signals to the blower B and the bypass valve 79 in response to input signals that the controller 11 receives from the sensors 12. The output signals generated and sent by the controller 11 control the operation of the blower B and the bypass valve 79. Similarly, in the case of the systems 9 and 10, the controller 11 also generates and sends output signals to the blower 16b and the bypass valve 79a in response to input signals that the controller 11 receives from the sensors 12. The output signals generated and sent by the controller 11 control the operation of the blower 16b and the bypass valve 79a.

The logic in the controller 11 determines whether to adjust the speed of the motor of the air pressuriser 16/16a or blower 16b or move the door/s 48/48b to a different position. For example, controller 11 may use a cost function to make the determination.

By way of example, in most environments in which a system 1-10 is employed, the main sensor is the pressure sensor 18. Thus, if only one type of sensor 12 is used, it would typically be one or more pressure sensors 18. However, one or more CO₂ sensors 22 may also be included in a typical implementation. In such an implementation, maintaining the pressure level at a predetermined value or within a predetermined value range and the CO₂ level below a predetermined value is a priority for a system 1-10. As elsewhere described herein, other system implementations may further include one or more particulate (or dust) sensors and/or gas sensors. Particulates and gas levels are also controlled to maintain them below a predetermined value.

### Flow Diagrams

By way of example, FIGS. 25A, 25B, 25C, 25D and 26 show flow diagrams of the control system operational processes that may be used to implement the systems 1-10 hereinbefore described. For ease of presentation and understanding, the main operational processes following system start-up have been split into three separate flow diagrams, identified herein as “normal system operation” (FIG. 25A), “calibrate function operation” (FIG. 25B) and “air quality check operation” (FIG. 25C); in addition, the operational processes for the “scrub mode operation” and the “cost function operation” are shown separately in FIGS. 25D and 26, respectively.

FIG. 25A (“normal system operation”) shows an example embodiment of the control process that the system follows upon power-on. FIG. 25B (“calibrate function operation”) shows an example embodiment of the control process for optimising the motor speed of the pressuriser 16/16a and/or blower B/16b and the positions of the door/s (48/48b) of the airflow distribution balancer 14 #; the calibration function would be run on first time start or when triggered by a user. FIG. 25C (“air quality check operation”) shows an example embodiment of the control process for using air quality sensors 12 to respond to internal particulates exceedance, internal CO₂ exceedance, internal gas exceedance or external gas exceedance; the air quality check is exited if all sensed values are within configured thresholds (i.e. the predetermined values or predetermined value ranges). FIG. 25D (“scrub mode operation”) shows an example embodiment of the control process for filtering the air inside the enclosed space S; the scrub mode is activated when a high particulates concentration is sensed within the enclosed space S and there is no internal CO₂ exceedance or internal gas exceedance. FIG. 26 (“cost function operation”) shows an example embodiment of the control process for adjusting the door/s 48/48b of the airflow distribution balancer 14 #when the motor speed of the pressuriser 16/16a and/or blower B/16b has drifted from the optimised value in calibration; the cost function is triggered if the motor speed of the pressuriser 16/16a and/or blower B/16b at setpoint pressure (Speed_F) has drifted by a predetermined amount above its calibrated value; a similar function may be used when the Speed_F has drifted a predetermined amount below its calibrated value.

Accordingly, with particular reference to FIG. 25A, on start-up, or power on, (1001), the sensors 12 are initialized (1002) and the system process then checks for calibration (1003) of the motor speeds of the pressuriser 16/16a and blower B/16b and the door (48/48b) positions of the airflow distribution balancer 14 #; calibration optimises the motor speeds and door positions. If calibration is required, the system process moves to the calibration function (1004).

### Calibrate Function

The calibrate function (1004) is shown separately in FIG. 25B. Upon start (1005) of the calibrate function (1004), the output signals from the controller 11 in the system 1-10 will direct the motors 70 to move the doors 48/48b to fully open the fresh air inlet 42/42a (and close the recirculation air inlet 44/44a) (1006). This pressurises the enclosed space S (i.e. increase the pressure in the enclosed space S) and disrupts any dirt and dust that may be building up in the system 1-10 (e.g. in the enclosed space S, in the ducting, in the air return unit N or NR, or in the air outlet unit U or UM). A predetermined period of time may be allowed for this process. The predetermined period of time may be configurable. The pressure control function (1007) is run whereby the controller 11 directs the motor of the air pressuriser 16/16a and/or blower 16b to adjust the speed of the motor of the air pressuriser 16/16a and/or blower 16b to reach and then maintain the setpoint pressure (i.e. the predetermined differential pressure value) while incrementally moving the doors 48/48b to open the recirculated air inlet (1008); this increases the size of the opening of the recirculated air inlet 44/44a (and decreases the size of the opening of the fresh air inlet 42/42a). As these actions include a decrease in the size of the fresh air inlet 42/42a, an increase in the speed of the motor of the air pressuriser 16/16a and/or blower 16b is required. This continues until the increase in motor speed that is required to maintain the setpoint pressure is disproportionate to the increase in recirculated airflow R. When a change in the position/s of the doors 48/48b causes a disproportional increase in the speed of the motor of the air pressuriser 16/16a and/or blower 16b, the controller 11 stops making adjustments and maintains the optimised settings for the speed of the motor of the air pressuriser 16/16a and/or blower 16b and position/s of the doors 48/48b. This relationship may be defined, for example, as when an x % change in the recirculation airflow requires a disproportional increase in the speed of the motor of the air pressuriser 16/16a and/or blower to maintain the pressure at a predetermined value or within a predetermined value range, where x is a predetermined adjustment step size. The predetermined adjustment step size x is determined experimentally. It is desirable that the predetermined adjustment step size x is large enough that the system can quickly converge on a balanced air flow ratio of fresh air and recirculated air, but small enough that it does not risk skipping over the optimal operating solutions. Experimental determinations indicate that the predetermined adjustment step size x is approximately a 1.5 degree change in the position of the door/s 48/48b of the airflow distribution balancer 14 #. The cost function relationship that controls how the motor of the air pressuriser 16/16a or blower 16b and airflow distribution balancer 14 #vary are denoted by the more general terms α, β and δ. Accordingly, FIG. 25B shows that a change in the speed of the motor of the air pressuriser 16/16a and/or blower 16b (step 1010) greater than an a % change in the recirculated airflow rate (Airflow_R) results in a Bx % reduction in the area size of the opening of the recirculated air inlet 42/42a of the airflow distribution balancer 14 #(1011). The reduction in the area size of the opening of the recirculated air inlet 42/42a of the airflow distribution balancer 14 #(1011) continues until the operation of the motor of the air pressuriser 16/16a and/or blower 16b (1012) requires a change in the speed of the motor of the air pressuriser 16/16a and/or blower 16b less than a 0% change in the recirculated airflow rate (Airflow_R) (1013).

This operation is represented in FIG. 25B by the two loops, the first loop comprising 1008, 1009 and 1010 and the second loop comprising 1011, 1012 and 1013.

By way of further explanation of the first and second loops in FIG. 25B, the recirculated airflow rate (Airflow_R) is checked, represented by 1010 (in the first loop) and 1013 (in the second loop). The change in recirculated airflow R restriction is different for every step due to the shape of the airflow distribution balancer 14 #. The change in airflow is physically checked and compared to the change in motor speed (which is performed to maintain the setpoint pressure). In the first loop (comprising 1008, 1009 and 1010), the airflow distribution balancer 14 #takes relatively large steps to increase recirculated airflow R until it overshoots the steady state operation. In the second loop (comprising 1011, 1012 and 1013), the airflow distribution balancer 14 #takes relatively small steps, moving the door/s 48/48b in the opposite direction to decrease recirculated airflow R. The process carried out by the first and second loops thereby hones in on the desired steady state operation. The objective is to find the point where the motor/s must make large (er) adjustments for the same change in recirculated airflow R.

At the end of the calibration process, the system state is saved to memory, e.g. non-volatile memory, (1014) for use in the cost function (for comparing the current pressuriser speed to the saved speed, Speed_F_Saved) and to return to the system state after power cycles. The calibration function is then exited (1015).

Once calibrated, the system will enter a loop of checking sensor readings, responding to air quality values outside of their configured thresholds, adjusting the motor speeds of the air pressuriser 16/16a/blower 16b to maintain setpoint pressure and finally adjusting the position of airflow distribution balancer 14 #door/s 48/48b to compensate (by reducing or adding restriction to the fresh airflow F path) for any significant changes made by the pressure control loop to the motor speeds of the air pressuriser 16/16a/blower 16b.

Returning to FIG. 25A, if the check for calibration (1003) indicates that calibration is not required, the system process bypasses the calibration function and instead restores the system state (1016) from memory using a previously stored system state. Irrespective of whether the system process undergoes calibration or bypasses the calibration function, it then moves to the air quality check (1017).

### Air Quality Check (Including Flush Mode and Scrub Mode)

The air quality check (1017) is shown separately in FIG. 25C. Upon start of the air quality check (1018), the first actions are to save the current system state to memory (1019) and to receive air quality data (e.g. CO₂, other undesirable gases, particulates, however not pressure) from the sensors 12 (1020). The data from the sensors 12 is used to check if there is an exceedance, e.g. if a reading is outside of its configured threshold. This is represented by 1021 for internal exceedance (i.e. exceedance inside the enclosed space S) and 1022 for external exceedance (i.e. exceedance outside the enclosed space S). If an exceedance is detected, the current state of the system (i.e. motor speeds of the air pressuriser 16/16a/blower 16b and the positions of the doors 48/48b of the airflow distribution balancer 14 #) are saved to memory, the system process remains in the air quality check function and responds to the detected exceedance (and any other exceedances that are detected) before restoring the system to its original state (represented by 1023). The air quality check is then exited (represented by 1024) and the system process returns to the normal system operation (shown in FIG. 25A).

### Air Quality Check—Detailed Description

By way of a more detailed description of the air quality check process shown in FIG. 25C, 1021 represents the controller 11 receiving input signals from the sensors 12 that monitor for an internal exceedance. If none of the sensors 12 senses that any of the internal environmental parameters being monitored has exceeded its predetermined value or predetermined value range, the operational process proceeds along the “No” track shown in FIGS. 25C. This process track may also monitor environmental parameters external of the enclosed space S, represented by 1022 in FIG. 25C. In that regard, suitable sensors 12 may be provided to monitor environmental parameters outside the enclosed space S. Such sensors 12 would typically include one or more CO₂ sensors 22, and/or gas sensors 26; however, one or more dust sensors 20 may be included. If none of the sensors 12 senses that any of the external environmental parameters being monitored has exceeded its predetermined value or predetermined value range, the operational process proceeds along the “No” track to restore the system to its original state (1023) and then exits the air quality check (1024), as herein before described.

If any of the sensors 12 senses that one of the environmental parameters being monitored has exceeded its predetermined value or predetermined value range, the operational process proceeds along the relevant “Yes” track shown in FIGS. 25C, as further herein described. This process track includes actions taken in response to whether or not any of the sensors 12 senses that an internal exceedance has occurred (1021) or an external gas exceedance has occurred (1022, 1027). An internal exceedance may be an excessive level of undesirable gas/es (e.g. CO₂ or other undesirable gases), in the enclosed space S (internal gas or CO₂ exceedance 1025) or an excessive level of particulates in the enclosed space S (internal particulates exceedance 1026). An external gas exceedance may be an excessive level of undesirable gas/es outside the enclosed space S (1022, 1027).

FIG. 25C includes the operational processes of the system response if undesirable (e.g. hazardous) gas/es are detected. The system response can vary depending upon whether or not the system has an activated carbon filter in the fresh air path. For example, if the system has an activated carbon filter and external (i.e. outside the enclosed space S) undesirable gas/es levels are sensed to be excessive, the system can operate as usual. The following table summarises the system responses for the various scenarios of internal and/or external exceedance and whether or not the system has a suitable filter.

| | | 1 | 2 |
|---|---|---|---|
| | | Filter - YES | Filter - NO |
| A | Internal Exceedance - YES | FLUSH | ALERT |
| | External Exceedance - YES | | |
| B | Internal Exceedance - YES | FLUSH | FLUSH |
| | External Exceedance - NO | | |
| C | Internal Exceedance - NO | RESTORE | RESTORE |
| | External Exceedance - NO | STATE | STATE |
| D | Internal Exceedance - NO | RESTORE | RECIRCULATION |
| | External Exceedance - YES | STATE | 100% |

Key responses of the system, shown in FIGS. 25C, include the following described responses, which are described with reference to the eight cells A1 to D2 shown in the table.

In the event of an internal gas or CO₂ exceedance (1025), the system will check if there is external gas exceedance (1027). If the data received by the controller 11 from the relevant sensors 12 indicates that there is no external gas exceedance, the system will activate a flush mode (1028). In this circumstance, the flush mode will be activated whether or not the system has gas filtration installed (i.e. whether or not the system has an activated carbon filter in the fresh air flow path) [cell B1—filter and cell B2—no filter, in the table]. This is because if there is no external gas exceedance, the external air does not contain undesirable gases at excessive levels; consequently, the flush mode can be activated to draw fresh air into the enclose space S irrespective of whether or not the system has a suitable filter for gas filtration. This is represented in FIG. 25C by the “No” process track that leads to the “Flush” mode 1028.

In the event of an internal gas or CO₂ exceedance (1025) and the data received by the controller 11 from the relevant sensors 12 indicates that there is also external gas exceedance, the system will activate a flush mode (1028) [cell A1 in the table]. This is represented in FIG. 25C by the “Yes” process track leading from the check for gas filtration being installed (1029) to the flush mode 1028. Since the system has a suitable filter installed, air drawn in form outside the enclosed space will be filtered to remove the undesirable gases before being delivered to the enclosed space S.

In the flush mode 1028, the system maximises fresh air flow to thereby dilute the undesirable gas/es with filtered fresh air. The flush mode replaces the air inside the enclosed space S with air from outside the enclosed space S as quickly as possible. The presence of an accessory blower and/or bypass valve 79/79a in the system does not affect the operation of the flush mode. The flush mode is used to respond to all instances of high CO₂ and other undesirable gases inside the enclosure. The flush mode also responds to gas exceedances inside the enclosure if gas filtration is installed on the fresh air intake. The controller 11 will increase the speed of the motor/s of the fresh air pressuriser/blower 16/16a speed to 100% and fully open the fresh air intake using the doors 48/48b of the airflow distribution balancer 14 #.

If the system does not have an activated carbon filter and both internal and external undesirable gas/es levels are sensed to be excessive, the system will issue an alert (step 1030). This is represented in FIG. 25C by the “No” process track leading from the check for gas filtration being installed (1029) to the alert 1030. The alert 1030 notifies personnel of the hazard and the personnel can take appropriate action. In such circumstances, for example, the appropriate action may include relocating the enclosed space S (if the enclosed space is the cabin of a vehicle) to a location without external gas exceedance so that the flush mode may be activated. However, it should be noted that if there is any likelihood that the enclosed space will be operating in a location that may encounter an external gas exceedance, a suitable filter should be installed in the system, as herein before described.

If there is no internal gas or CO₂ exceedance (1025) and the data received by the controller 11 from the sensors 12 indicates that there is an external gas exceedance (1022), FIG. 25C shows the two process tracks, leading from the check for gas filtration 1031, for a filter being installed and a filter not being installed. In the case of a suitable filter being installed in the system, the process follows the “Yes” track to the restore state 1023 [cell D1 in the table] and then to the exit 1024. In the case of a suitable filter not being installed in the system, the process follows the “No” track to recirculation 100% (1032) in FIG. 25C [cell D2 in the table]. In 100% the recirculated airflow R (1032), no fresh airflow F will be drawn into the airflow distribution balancer 14 #. This occurs so that the external air (with gas exceedance) is not drawn into the enclosed space S by the pressuriser 16/16a. When the system operates in 100% recirculated airflow R, the CO₂ level in the enclosed space S will rise relatively quickly. Accordingly, an alert 1030 is issued. The alert 1030 is to alert the operator to the potential risk of remaining in the enclosed space S with a rising CO₂ level.

When operating using 100% recirculated airflow R (hereinbefore described), the door/s 48/48b also provide a physical boundary to the fresh air inlet 42/42a allowing fresh airflow F (to the airflow distribution balancer 14 #) to be cut-off, e.g. in the event that the air quality outside the enclosed space S does not meet the predetermined quality level. For example, if an implementation of the system does not include an activated carbon filter 31a to filter undesirable gases (e.g. H₂S, SO₂ and/or refrigerant gas, e.g. R-1234YF) and if the sensed concentration of such a gas exceeds a predetermined value, the door/s 48/48b can be moved such that the fresh airflow F is reduced or cut-off to thereby reduce the health risk to personnel in the enclosed space S.

FIG. 25C also includes the operational processes of the system response if an excessive level of particulates in the enclosed space S (internal particulates exceedance 1026) is detected. This is identified as “Scrub” mode 1033 in FIG. 25C. In the scrub mode 1033, the excessive dirt and dust (i.e. particulates) levels in the enclosed space S are reduced.

The scrub mode 1033 is shown separately in FIG. 25D. Upon start (1034) of the scrub mode (1033), the controller 11 will increase the recirculated airflow rate as much as possible by directing all motors in the recirculated airflow R to run at 100% speed (1035) and opening the recirculation air inlet 100% (1036). If there is an accessory blower available with a bypass valve (embodiments 3 to 8), the bypass is fully opened (1037, 1038). However, it may be necessary to still maintain some pressure inside the enclosed space S during this process. Therefore, a pressure check 1039 is included in the scrub mode such that the controller 11 will move the door/s 48/48b of the airflow distribution balancer 14 #to increase the opening of the fresh air intake (i.e. decrease the opening of the recirculated air inlet-1039) until the pressure in the enclosed space S is above a configurable ‘scrub pressure’ threshold (“Pressure_S”), as shown at 1040. For example, the value of Pressure_S may be set to 20 Pa. The scrub mode is then exited (1041).

The scrub mode 1033 removes dirt and dust particles (i.e. particulates) from the enclosed space S to thereby perform a cleaning of the enclosed space S. Undertaking actions as herein before described can be used to increase the recirculation airflow R; for example, one or more of the following: increasing the speed of the motor of the blower B (to thereby increase the speed of rotation of the associated fan or impeller), increasing the speed of the motor of the air pressuriser 16/16a (to thereby increase the speed of rotation of the associated fan or impeller), opening the bypass valves 79/79a in the systems 3 to 10 that have a bypass valve 79/79a, adjusting the openings of the doors 48/48b to increase the recirculated airflow through the airflow distribution balancer/s 14 #. The actions implemented to increase the recirculation airflow R may be selected to achieve the desired operation of a particular system.

### Pressure Control

Returning to FIG. 25A, the next step shown in FIG. 25A is pressure control 1042. Pressure control operates to adjust the motor speed of the fresh air pressuriser/blower to maintain the setpoint pressure. As the filters become loaded with particulates, they become more restrictive to airflow and require more work to push air through them (e.g. increased motor speed for the same airflow). As the seals of the enclosed Space S (that seal the enclosed space S from the exterior) deteriorate over time, the leakage from the enclosed space S increases. Both will result in a pressure drop in the enclosed space S such that the system will need to adjust to maintain pressure. If a filter is changed or seals are repaired/replaced, pressure in the enclosed space S will increase (for the same motor speeds) and the system will again need to adjust to maintain setpoint pressure.

Pressure control may be a PID (proportional integral derivative) control process that is used to adjust the fresh air pressuriser/blower motor speed to achieve setpoint pressure. A PID controller may also be used to adjust the position/s of the doors 48/48b of the air distribution balancer 14 #to achieve the setpoint pressure. This would also happen within the pressure control loop. The pressure control loop will also recognise zero (0 Pa) pressure in the enclosed space S as a door/window opening and enter a fault state until some pressure returns to the enclosed space (i.e. the door/window has been closed again). This is because it is not possible to pressurise an enclosed space with leakage as significant as an open door or window so the system ‘waits’ until it can operate normally again.

### Cost Function

The cost function 1044 is the last process action shown in FIG. 25A. The cost function 1044 is shown separately in FIG. 26 and starts at 1045. The purpose of the cost function is to check if the operation of the pressure control function over time has caused the motor speed of the air pressuriser/blower to move (referred to as drift) significantly from its optimised value found in the calibration process. Using the pressuriser/blower motor to maintain setpoint pressure after calibration means that the motor speed will increase with loading or poor sealing while the door/s 48/48b of the airflow distribution balancer 14 #stays fixed. The cost function allows a comparison to be made of the current motor speed and the motor speed the last time the door/s 48/48b of the airflow distribution balancer 14 #was/were adjusted. (The door/s 48/48b is/are first adjusted during calibration). If the motor speed has drifted significantly, the system will move the door/s 48/48b door to reduce the restriction on the fresh air inlet 42/42a until the motor speed (adjusted to maintain setpoint pressure) is somewhere between the two compared speeds. (Experimentally, the value has been halfway between the two values). This ensures that both the doors 48/48b and air pressuriser motor are used to compensate for filter loading. Reducing restriction on the fresh air inlet 42/42a will increase restriction in the recirculated air inlet 44/44a, reducing the recirculated airflow rate. The effect of the cost function is that the door/s 48/48b will not be moved if the recirculated airflow rate (Airflow_R) is already at or close to its configured minimum value (1046). Further, it will check if the motor speed is already at or close to its configured maximum value (1047). If both cases are true, it will issue an alert to check the filter and seals (1048) and proceed to the end 1049. If the recirculated airflow rate is not at or close to its configured minimum value, the process track proceeds to 1050 to decrease the recirculated airflow rate with pressure control (1051).

Before exiting at 1049, the cost function will save the new motor speed and door location to non-volatile memory (as represented at 1055) so that the system can return to this state, instead of the calibrated state, after being power cycled. In FIG. 26, the check is to calculate if the current speed of the motor (Speed_F) is greater than the saved value from calibration (Speed_F_saved) plus a configured drift value (Drift_F), as represented at 1052. If it is, the system enters the cost function process where it adjusts the doors 48/48b of the airflow distribution balancer 14 #until the motor speed required to maintain pressure is reduced to a level that is still greater than the saved value (Speed_F_saved) but less than the configured drift value. The level represented as ‘Speed_F>(Speed_F_Saved+δDrift_F)’. If it is not (i.e. Speed_F<Speed_F-Saved (1053), the recirculation air is increased (1054) and the process track returns to the pressure control (1051).

In the example above, the position of the door/s 48/48b is fixed after calibration and only adjusted when the cost function is triggered. The system may alternatively be used in an inverse manner, where the motor speed of the fresh air pressuriser/blower(s) is fixed and the airflow distribution balancer 14 #is used to maintain pressure levels inside the enclosure until the cost function is triggered and the motor speeds are adjusted to compensate for significant movement of the door/s. However, changing the air pressuriser 16/16a motor speed first is typically preferred, as changes to the air pressuriser 16/16a motor speed are usually faster and more continuous.

### Airflows

In the systems 1, 1b, 2, 3, 6 of the first, second, third and sixth embodiments, the airflow generator, in the form of the air pressuriser 16 (systems 1, 1b and 3) or 16a (systems 2 and 6), is located downstream of the airflow distribution balancer (and upstream of the enclosed space S); the air pressuriser 16 or 16a generates the fresh airflow F and the recirculated airflow R; in the systems 3 and 6, the blower B also generates the recirculated airflow R.

In the systems 9 and 10 of the ninth and tenth embodiments, the airflow generator, in the form of the high capacity blower 16b, is located downstream of the airflow distribution balancer (and upstream of the enclosed space S); the high capacity blower 16b generates the fresh airflow F and the recirculated airflow R.

In the systems 4, 5 and 7 of the fourth, fifth and seventh embodiments, the airflow generator, in the form of the air pressuriser 16 (systems 4 and 5) or 16a (system 7), is located upstream of the airflow distribution balancer (and upstream of the enclosed space S); the air pressuriser 16 or 16a generates the fresh airflow F; the blower B generates the recirculated airflow R.

In the system 8 of the eighth embodiment, the airflow generator, in the form of the air pressuriser 16, is located downstream of the first airflow distribution balancer that controls the fresh airflow F (and upstream of the enclosed space S); the air pressuriser 16 generates the fresh airflow F; the blower B generates the recirculated airflow R.

### Features

Various features and combinations of features disclosed herein are set out in the following paragraphs:

A system for monitoring and controlling air quality in an enclosed space.

An airflow distribution balancer. This airflow distribution balancer may be a component of the system for monitoring and controlling air quality in an enclosed space.

A system for monitoring and controlling air quality in an enclosed space comprising
a controller
one or more sensors to monitor one or more environmental parameters inside the enclosed space,
at least one airflow distribution balancer to receive a first airflow of external air from outside the enclosed space and to receive a second airflow of internal air from inside the enclosed space,
an airflow generator to generate at least the first airflow of external air,
wherein the controller and the one or more sensors are in operative communication such that, in use, the controller is able to receive one or more input signals from one or more sensors and in response to the one or more input signals the controller is able to generate one or more output signals that are sent to the airflow distribution balancer and/or the airflow generator to control the operation of the airflow distribution balancer and/or the airflow generator by adjusting the volume of external air and/or the volume of internal air that is delivered to the enclosed space to thereby control one or more environmental parameters relating to air quality inside the enclosed space.

The airflow distribution balancer comprises at least one inlet, for air to enter the airflow distribution balancer as inlet airflow, and an outlet for air to exit the airflow distribution balancer as outlet airflow.

The airflow distribution balancer comprises a chamber to receive air that enters the airflow distribution balancer via the at least one inlet.

The airflow distribution balancer comprises at least one door movable to a selected position such that the at least one inlet is fully closed when the at least one door is at a first position, fully open when the at least one door is at a second position, and partly open and partly closed when the at least one door is at an intermediate position between the first position and the second position.

In use, air is not able to flow through the at least one inlet when the at least one door is at the first position such that the at least one inlet is fully closed, and air is able to flow through the at least one inlet into the chamber and exit from the outlet when the at least one door is at the second position or at an intermediate position such that the at least one inlet is fully open or at least partly open, respectively.

The airflow distribution balancer comprises at least one motor, wherein the at least one door and the at least one motor are operatively connected such that the at least one motor is operatable to move the at least one door.

The at least one motor is operable to move the at least one door in response to signals received from the controller.

The airflow distribution balancer comprises a first inlet, a second inlet and an outlet. The first inlet and the second inlet each receive inlet airflow.

The first inlet receives the first airflow of external air from outside the enclosed space and the second inlet receives the second airflow of internal air from within the enclosed space.

The outlet airflow exits the airflow distribution balancer from the outlet.

The first inlet and the second inlet are provided with a respective said door movable to a selected position as herein before described.

The airflow distribution balancer comprises first and second motors, wherein the respective doors and the first and second motors are operatively connected such that the first and second motors are operatable to move a respective door.

The system comprises a first airflow distribution balancer to receive the first airflow of external air and a second airflow distribution balancer to receive the second airflow of internal air.

A first bypass valve allows a portion of air, from the enclosed space, to return to the enclosed space instead of entering the second airflow.

A first filter to filter the air before the portion of air is returned to the enclosed space via the first bypass valve.

A second bypass valve directs a portion of the air in the outlet airflow into the enclosed space.

A second filter to filter the air before directing the portion of air into the enclosed space via the second bypass valve.

The airflow generator is located such that it is able to draw air from at least outside the enclosed space and direct the air into the enclosed space.

The airflow generator is located outside the enclosed space. In one or more other embodiments, the airflow generator is located inside the enclosed space.

Air that passes through the airflow generator is directed into the enclosed space.

The system comprises ducts for passage of the airflows through the system. The airflow generator comprises an air pressuriser.

The airflow generator comprises a blower.

Depending upon the particular implementation of the system, the airflow generator may be in the form of an air pressuriser or a blower.

The blower is provided as a high capacity blower.

The one or more sensors may include one or more of the following sensors: at least one pressure sensor to sense the pressure inside and outside the enclosed space (i.e. differential pressure sensing) or inside the enclosed space; at least one dust sensor to sense the presence of dirt or dust particles in the enclosed space; at least one CO₂ sensor to sense the presence of CO₂ in the enclosed space; at least one airflow sensor to sense the flow of air; and/or at least one gas sensor.

The one or more sensors include at least one pressure sensor.

The at least one gas sensor comprises one or more gas sensors to sense the presence of gases such as, for example, hydrogen sulfide (H₂S), sulphur dioxide (SO₂) and/or refrigerant gas, e.g. R-1234YF.

The system comprises an air precleaner to preclean the air received from outside the enclosed space prior to the air entering the at least one inlet of the airflow distribution balancer.

The system comprises at least one particulates filter to filter particulate material from at least the first airflow of external air.

The at least one particulates filter is provided as a separate filter.

The at least one particulates filter is provided in the air pressuriser.

The system further comprises at least one activated carbon filter to filter undesirable gases from at least the first airflow and/or the outlet airflow.

At least one particulates filter is provided upstream of the activated carbon filter.

An airflow distribution balancer comprising
a casing having at least a first inlet and an outlet,
a chamber inside the casing,
at least one door movable to a selected position such that the at least one inlet is fully closed when the at least one door is at a first position, fully open when the at least one door is at a second position, and partly open and partly closed when the at least one door is at an intermediate position between the first position and the second position,
wherein, in use, air is not able to flow through the at least one inlet when the at least one door is at the first position such that the at least one inlet is fully closed, and air is able to flow through the at least one inlet into the chamber and exit from the outlet when the at least one door is at the second position or at an intermediate position such that the at least one inlet is fully open or at least partly open, respectively.

The airflow distribution balancer further comprises at least one motor, wherein the at least one door and the at least one motor are operatively connected such that the at least one motor is operatable to move the at least one door.

The airflow distribution balancer comprises a first inlet, a second inlet and an outlet.

The first inlet and the second inlet are provided with a respective said door movable to a selected position as herein before described.

The airflow distribution balancer comprises first and second motors, wherein the respective doors and the first and second motors are operatively connected such that the first and second motors are operatable to move a respective door.

A method for monitoring and controlling air quality in an enclosed space comprising
monitoring one or more environmental parameters inside the enclosed space,
generating at least a first airflow of external air, from outside the enclosed space, by an airflow generator,
receiving the first airflow of external air and a second airflow of internal air, from inside the enclosed space, at at least one airflow distribution balancer,
delivering air from the at least one airflow distribution balancer in an outlet airflow to the enclosed space,
generating one or more input signals indicative of the one or more environmental parameters inside the enclosed space,
generating one or more output signals in response to the one or more input signals,
sending the one or more output signals to the airflow distribution balancer and/or the airflow generator to control the operation of the airflow distribution balancer and/or the airflow generator by adjusting the volume of external air and/or the volume of internal air that is delivered to the enclosed space to thereby control one or more environmental parameters relating to air quality inside the enclosed space.

In the method, receiving the first airflow of external air and a second airflow of internal air, from inside the enclosed space, at at least one airflow distribution balancer comprises receiving the first airflow of external air and the second airflow of internal air at a single airflow distribution balancer.

In the method, receiving the first airflow of external air and a second airflow of internal air, from inside the enclosed space, at at least one airflow distribution balancer comprises receiving the first airflow of external air at a first airflow distribution balancer and receiving the second airflow of internal air at a second airflow distribution balancer.

The method further comprises returning a portion of air, from the enclosed space, to the enclosed space via a first bypass valve instead of allowing the portion of air to enter the second airflow.

The method further comprises filtering the air before returning the portion of air to the enclosed space via the first bypass valve.

The method further comprises directing a portion of the air in the outlet airflow into the enclosed space via a second bypass valve.

The method further comprises filtering the air before directing the portion of air into the enclosed space via the second bypass valve.

Whilst one or more preferred embodiments of the present invention have been herein before described, the scope of the present invention is not limited to those specific embodiments, and may be embodied in other ways, as will be apparent to a person skilled in the art.

The individual features, structures or characteristics of each aspect or embodiment disclosed herein may each be combined with any or all features, structures or characteristics of the other aspects or embodiments. Furthermore, the particular features, structures or characteristics may be combined as suitable in one or more aspects or embodiments of the disclosure.

Modifications and variations such as would be apparent to a person skilled in the art are deemed to be within the scope of the present invention.

1. A system for monitoring and controlling air quality in an enclosed space comprising
a controller
one or more sensors to monitor one or more environmental parameters inside the enclosed space,
at least one airflow distribution balancer to receive a first airflow of external air from outside the enclosed space and to receive a second airflow of internal air from inside the enclosed space,
an airflow generator to generate at least the first airflow of external air,
wherein the controller and the one or more sensors are in operative communication such that, in use, the controller is configured to receive one or more input signals from one or more sensors and the controller is configured to generate one or more output signals, in response to the one or more input signals, that are sent to at least one of the airflow distribution balancer and the airflow generator to control the operation of at least one of the airflow distribution balancer and the airflow generator, respectively, by adjusting at least one of the volume of external air and the volume of internal air that is delivered to the enclosed space to thereby control one or more environmental parameters relating to air quality inside the enclosed space.

2. A system according to claim 1, wherein the airflow distribution balancer comprises at least one inlet, for air to enter the airflow distribution balancer as inlet airflow, and an outlet for air to exit the airflow distribution balancer as outlet airflow.

3. A system according to claim 1 or 2, wherein the airflow distribution balancer comprises a chamber to receive air that enters the airflow distribution balancer via the at least one inlet.

4. A system according to any one of the preceding claims, wherein the airflow distribution balancer comprises at least one door movable to a selected position such that the at least one inlet is fully closed when the at least one door is at a first position, fully open when the at least one door is at a second position, and partly open and partly closed when the at least one door is at an intermediate position between the first position and the second position.

5. A system according to claim 4, wherein, in use, air is not able to flow through the at least one inlet when the at least one door is at the first position such that the at least one inlet is fully closed, and air is able to flow through the at least one inlet into the chamber and exit from the outlet when the at least one door is at the second position or at an intermediate position such that the at least one inlet is fully open or at least partly open, respectively.

6. A system according to claim 4 or 5, wherein the airflow distribution balancer comprises at least one motor, and wherein the at least one door and the at least one motor are operatively connected such that the at least one motor is operatable to move the at least one door.

7. A system according to claim 6, wherein the at least one motor is operable to move the at least one door in response to signals received from the controller.

8. A system according to any one of the preceding claims, wherein the airflow distribution balancer comprises a first inlet to receive the first airflow, a second inlet to receive the second airflow and an outlet for outlet airflow.

9. A system according to any one of the claims 4 to 8, wherein the first inlet and the second inlet are provided with a respective said door movable to a selected position.

10. A system according to any one of the claims 6 to 9, wherein the airflow distribution balancer comprises first and second motors, and wherein the respective doors and the first and second motors are operatively connected such that the first and second motors are operatable to move a respective door.

11. A system according to any one of the preceding claims, wherein the system comprises a first airflow distribution balancer to receive the first airflow of external air and a second airflow distribution balancer to receive the second airflow of internal air.

12. A system according to any one of the preceding claims, further comprising a first bypass valve to allow a portion of air, from the enclosed space, to return to the enclosed space instead of entering the second airflow.

13. A system according to claim 12, further comprising a first filter to filter the air before the portion of air is returned to the enclosed space via the first bypass valve.

14. A system according to any one of claims 2 to 13, further comprising a second bypass valve to direct a portion of the air in the outlet airflow into the enclosed space.

15. A system according to claim 14, further comprising a second filter to filter the air before the portion of air is directed into the enclosed space via the second bypass valve.

16. A system according to any one of the preceding claims, wherein the airflow generator is located such that it is able to draw air from at least outside the enclosed space and direct the air into the enclosed space.

17. A system according to any one of the preceding claims, wherein the airflow generator is located outside the enclosed space.

18. A system according to any one of the preceding claims, wherein the airflow generator is located inside the enclosed space.

19. A system according to any one of the preceding claims, wherein the airflow generator comprises an air pressuriser.

20. A system according to any one of the preceding claims, wherein the airflow generator comprises a blower.

21. A system according to any one of the preceding claims, wherein the one or more sensors include one or more of the following sensors: at least one pressure sensor to sense the pressure inside and outside the enclosed space (i.e. differential pressure sensing) or inside the enclosed space; at least one dust sensor to sense the presence of dirt or dust particles in the enclosed space; at least one CO₂ sensor to sense the presence of CO₂ in the enclosed space; at least one airflow sensor to sense the flow of air; and/or at least one gas sensor.

22. A system according to claim 21, wherein at least one gas sensor comprises one or more gas sensors to sense the presence of one or more gases.

23. A system according to claim 22, wherein the one or more gases comprise hydrogen sulfide (H₂S), sulphur dioxide (SO₂) and/or refrigerant gas.

24. A system according to claim 23, wherein the refrigerant gas comprises R-1234YF.

25. A system according to any one of the preceding claims, further comprising an air precleaner to preclean the air received from outside the enclosed space prior to the air entering the at least one inlet of the airflow distribution balancer.

26. A system according to any one of the preceding claims, further comprising at least one particulates filter to filter particulate material from at least the first airflow of external air.

27. A system according to claim 26, wherein the at least one particulates filter is provided as a separate filter.

28. A system according to claim 26 or 27, wherein the at least one particulates filter is provided in the air pressuriser.

29. A system according to any one of the preceding claims, further comprising at least one activated carbon filter to filter undesirable gases from at least the first airflow and/or the outlet airflow.

30. A system according to claim 29, wherein at least one particulates filter is provided upstream of the activated carbon filter.

31. An airflow distribution balancer comprising
a casing having at least a first inlet and an outlet,
a chamber inside the casing,
at least one door movable to a selected position such that the at least one inlet is fully closed when the at least one door is at a first position, fully open when the at least one door is at a second position, and partly open and partly closed when the at least one door is at an intermediate position between the first position and the second position,
wherein, in use, air is not able to flow through the at least one inlet when the at least one door is at the first position such that the at least one inlet is fully closed, and air is able to flow through the at least one inlet into the chamber and exit from the outlet when the at least one door is at the second position or at an intermediate position such that the at least one inlet is fully open or at least partly open, respectively.

32. An airflow distribution balancer according to claim 31, further comprising at least one motor, wherein the at least one door and the at least one motor are operatively connected such that the at least one motor is operatable to move the at least one door.

33. An airflow distribution balancer according to claim 31 or 32, wherein the airflow distribution balancer further comprises a second inlet.

34. An airflow distribution balancer according to claim 33, wherein the first inlet and the second inlet are provided with a respective said door movable to a selected position.

35. An airflow distribution balancer according to any one of claims 31 to 34, wherein the airflow distribution balancer comprises first and second motors, and wherein the respective doors and the first and second motors are operatively connected such that the first and second motors are operatable to move a respective door.

36. A method for monitoring and controlling air quality in an enclosed space comprising
monitoring one or more environmental parameters inside the enclosed space,
generating at least a first airflow of external air, from outside the enclosed space, by an airflow generator,
receiving the first airflow of external air and a second airflow of internal air, from inside the enclosed space, at at least one airflow distribution balancer,
delivering air from the at least one airflow distribution balancer in an outlet airflow to the enclosed space,
generating one or more input signals indicative of the one or more environmental parameters inside the enclosed space,
generating one or more output signals in response to the one or more input signals,
sending the one or more output signals to at least one of the airflow distribution balancer and the airflow generator to control the operation of at least one of the airflow distribution balancer and the airflow generator by adjusting at least one of the volume of external air and the volume of internal air that is delivered to the enclosed space to thereby control one or more environmental parameters relating to air quality inside the enclosed space.

37. A method according to claim 36, wherein receiving the first airflow of external air and a second airflow of internal air, from inside the enclosed space, at at least one airflow distribution balancer comprises
receiving the first airflow of external air and the second airflow of internal air at a single airflow distribution balancer.

38. A method according to claim 36, wherein receiving the first airflow of external air and a second airflow of internal air, from inside the enclosed space, at at least one airflow distribution balancer comprises
receiving the first airflow of external air at a first airflow distribution balancer and receiving the second airflow of internal air at a second airflow distribution balancer.

39. A method according to any one of claims 36 to 38, further comprising returning a portion of air, from the enclosed space, to the enclosed space via a first bypass valve instead of allowing the portion of air to enter the second airflow.

40. A method according to claim 39, further comprising filtering the air before returning the portion of air to the enclosed space via the first bypass valve.

41. A method according to any one of claims 29 to 37, further comprising directing a portion of the air in the outlet airflow into the enclosed space via a second bypass valve.

42. A method according to claim 41, further comprising filtering the air before directing the portion of air into the enclosed space via the second bypass valve.
